(19) United States
(12) Patent Application Publication
(10) Pub. No.: US 2025/0182186 A1
(43) Pub. Date: Jun. 5, 2025

(54) WIRELESS DEVICE POSITIONING SYSTEMS AND METHODS FOR USE THEREWITH

(71) Applicant: Tabletop Media, LLC, Dallas, TX (US)

(72) Inventors: Sandro Natale, Southlake, TX (US); David Cabrera Perez, Mesquite, TX (US)

(73) Assignee: Tabletop Media, LLC, Dallas, TX (US)

(21) Appl. No.: 19/047,815

(22) Filed: Feb. 7, 2025

Related U.S. Application Data
(63) Continuation-in-part of application No. 18/476,772, filed on Sep. 28, 2023.
(60) Provisional application No. 63/564,226, filed on Mar. 12, 2024.
(60) Provisional application No. 63/557,112, filed on Feb. 23, 2024.
(60) Provisional application No. 63/579,212, filed on Aug. 28, 2023.
(60) Provisional application No. 63/516,611, filed on Jul. 31, 2023.
(60) Provisional application No. 63/476,763, filed on Dec. 22, 2022.
(60) Provisional application No. 63/379,786, filed on Oct. 17, 2022.

(51) Int. Cl. G06Q 30/0601; G06Q 20/32; G06Q 30/0251; G06Q 50/12

(52) U.S. Cl. CPC G06Q 30/0639; G06Q 20/3278; G06Q 30/0259; G06Q 50/12

(57) ABSTRACT

A device positioning system operates by: transmitting, via a plurality of beacon transmitters associated with a structure, a plurality of wireless beacons; receiving beacon data from a plurality of client devices associated with a corresponding plurality of users in response to the wireless beacons; generating, in response to the beacon data, location data that indicates a position of the plurality of users in association with the structure; and generating mapping data that tracks the positions of the plurality of users in association with the structure over time.

The present U.S. Utility patent application claims priority pursuant to 35 U.S.C. § 119(e) to U.S. Provisional Application No. 63/557,112, entitled “INTELLIGENT VENUE APPLICATIONS BASED ON CLIENT DEVICE POSITION AND METHODS FOR USE THEREWITH”, filed Feb. 23, 2024; and U.S. Provisional Application No. 63/564,226, entitled “INTELLIGENT VENUE SYSTEMS AND METHODS FOR USE THEREWITH”, filed Mar. 12, 2024, both of which are hereby incorporated herein by reference in their entirety and made part of the present U.S. Utility patent application for all purposes.

The present U.S. Utility patent application also claims priority pursuant to 35 U.S.C. § 120 as a continuation-in-part of U.S. Utility application Ser. No. 18/476,772, entitled “INTELLIGENT VENUE APPLICATIONS FOR USE WITH A CLIENT DEVICE AND METHODS FOR USE THEREWITH”, filed Sep. 28, 2023, which claims priority pursuant to 35 U.S.C. § 119(e) to U.S. Provisional Application No. 63/579,212, entitled “INTELLIGENT VENUE APPLICATIONS FOR USE WITH A CLIENT DEVICE AND METHODS FOR USE THEREWITH”, filed Aug. 28, 2023; U.S. Provisional Application No. 63/516,611, entitled “INTELLIGENT VENUE APPLICATIONS FOR USE WITH A CLIENT DEVICE AND METHODS FOR USE THEREWITH”, filed Jul. 31, 2023; U.S. Provisional Application No. 63/476,763, entitled “INTELLIGENT VENUE APPLICATIONS AND METHODS FOR USE THEREWITH”, filed Dec. 22, 2022; and U.S. Provisional Application No. 63/379,786, entitled “INTELLIGENT VENUE AND METHODS FOR USE THEREWITH”, filed Oct. 17, 2022, all of which are hereby incorporated herein by reference in their entirety and made part of the present U.S. Utility patent application for all purposes.

### TECHNICAL FIELD

The present disclosure relates to wireless systems used to determine client device positions associated with a building or other structure.

### BRIEF DESCRIPTION OF THE SEVERAL VIEWS OF THE DRAWINGS

Reference will now be made to the accompanying drawings, which are not necessarily drawn to scale, and wherein:

FIG. 1A presents a pictorial/block diagram representation of an example system.

FIG. 1B presents a block diagram representation of an example system.

FIG. 1C presents a block diagram representation of an example beacon transmitter.

FIG. 1D presents a block diagram representation of an example beacon receiver.

FIG. 1E presents a pictorial diagram representation of an example screen display.

FIGS. 1F-1K present pictorial block diagrams of example table configurations.

FIG. 1L presents a flowchart representation of an example method.

FIG. 2A presents a pictorial/block diagram representation of an example system.

FIG. 2B presents a block diagram representation of an example system.

FIG. 2C presents a block diagram representation of an example staff ID tag.

FIG. 2D presents a pictorial diagram representation of an example staff ID tag.

FIG. 2E presents a pictorial diagram representation of an example staff ID tag.

FIGS. 2F-2I present a pictorial diagram representations of example screen displays.

FIG. 2J presents a flowchart representation of an example method.

FIG. 3A presents a pictorial/block diagram representation of an example system.

FIG. 3B presents a block diagram representation of an example system.

FIGS. 3C-3E present pictorial diagram representations of example screen displays.

FIG. 3F presents a flowchart representation of an example method.

FIG. 4A presents a pictorial/block diagram representation of an example system.

FIG. 4B presents a block diagram representation of an example system.

FIGS. 4C-4E present pictorial diagram representations of example screen displays.

FIG. 4F presents a flowchart representation of an example method.

FIG. 5A presents a pictorial/block diagram representation of an example system.

FIG. 5B presents a block diagram representation of an example system.

FIGS. 5C-5E present pictorial diagram representations of example screen displays.

FIG. 5F presents a flowchart representation of an example method.

FIG. 6A presents a pictorial/block diagram representation of an example system.

FIG. 6B presents a process/flow diagram representation of an example database.

FIG. 6C presents a process/flow diagram representation of an example database.

FIG. 6D presents a flowchart representation of an example method.

FIG. 6E presents a flowchart representation of an example method.

FIG. 7A presents a pictorial/block diagram representation of an example system.

FIG. 7B presents a block diagram representation of an example system.

FIGS. 7C-7E present pictorial diagram representations of example screen displays.

FIG. 7F presents a flowchart representation of an example method.

FIG. 8A presents a pictorial/block diagram representation of an example system.

FIGS. 8B-8E present pictorial diagram representations of example screen displays.

FIG. 8F presents a flowchart representation of an example method.

FIG. 9A presents a pictorial/block diagram representation of an example system.

FIGS. 9B-9K present pictorial diagram representations of example screen displays.

FIG. 9L presents a flowchart representation of an example method.

FIG. 10A presents a pictorial/block diagram representation of an example system.

FIGS. 10B-10E present pictorial diagram representations of example screen displays.

FIG. 10F presents a flowchart representation of an example method.

FIG. 11A presents a pictorial/block diagram representation of an example system.

FIGS. 11B-11D present pictorial diagram representations of example screen displays.

FIG. 11E presents a flowchart representation of an example method.

FIG. 12A presents a pictorial/block diagram representation of an example system.

FIGS. 12B-12L present pictorial diagram representations of example screen displays.

FIG. 12M presents a flowchart representation of an example method.

FIG. 12N presents a pictorial representation of an example of orders placed by a plurality of users.

FIG. 12O presents a tabular representation of an example of scheduling of orders placed by a plurality of users.

FIG. 12P presents a flowchart representation of an example method.

FIG. 12Q presents a pictorial/block diagram representation of an example system.

FIGS. 12R-12S present pictorial diagram representations of example screen displays.

FIG. 12T presents a flowchart representation of an example method.

FIG. 12U presents a flowchart representation of an example method.

FIG. 13A presents a pictorial/block diagram representation of an example system.

FIGS. 13B-13I present pictorial diagram representations of example screen displays.

FIG. 13J presents a flowchart representation of an example method.

FIG. 14A presents a pictorial/block diagram representation of an example system.

FIGS. 14B-14D present pictorial diagram representations of example screen displays.

FIG. 14E presents a flowchart representation of an example method.

FIG. 15A presents a pictorial/block diagram representation of an example system.

FIG. 15B presents a pictorial/block diagram representation of an example system.

FIG. 15C presents a pictorial/block diagram representation of an example system.

FIG. 15D presents a pictorial/block diagram representation of an example system.

FIG. 15E presents a pictorial/block diagram representation of an example system.

FIGS. 15F-15J present pictorial diagram representations of example screen displays.

FIG. 15K presents a flowchart representation of an example method.

FIG. 16A presents a pictorial/block diagram representation of an example system.

FIG. 16B presents a pictorial/block diagram representation of an example system of client device position tracking over time.

FIG. 16C presents a tabular representation of an example system of client device position tracking over time.

FIG. 16D presents a pictorial diagram representation of an example of client device tracking at a drive-thru location.

FIG. 16E presents a pictorial diagram representation of an example of client device tracking at a gas pump.

FIG. 16F presents a pictorial diagram representation of an example of a mobile checkout location.

FIGS. 16G-16I present pictorial diagram representations of example screen displays.

FIG. 16J presents a flowchart representation of an example method.

FIG. 16K presents a flowchart representation of an example method.

FIG. 16L presents a flowchart representation of an example method.

FIG. 16M presents a flowchart representation of an example method.

FIG. 16N presents a flowchart representation of an example method.

FIG. 16O presents a pictorial/block diagram representation of an example electronic shelf label.

FIG. 16P presents a pictorial diagram representation of an example screen display.

FIG. 16Q presents a flowchart representation of an example method.

FIG. 16R presents a flowchart representation of an example method.

FIG. 17A presents a flow diagram representation of an example method.

FIGS. 17B-17T present pictorial diagram representations of example screen displays.

FIG. 17U presents a flow diagram representation of an example method.

### DETAILED DESCRIPTION

One or more examples are now described with reference to the drawings, wherein like reference numerals are used to refer to like elements throughout. In the following description, for purposes of explanation, numerous details are set forth in order to provide a thorough understanding of the various examples that can be used in combinations that include some features but not others as will be evident to one skilled in the art. It is evident, however, that the various examples can be practiced without these details (and without applying to any particular networked environment or standard).

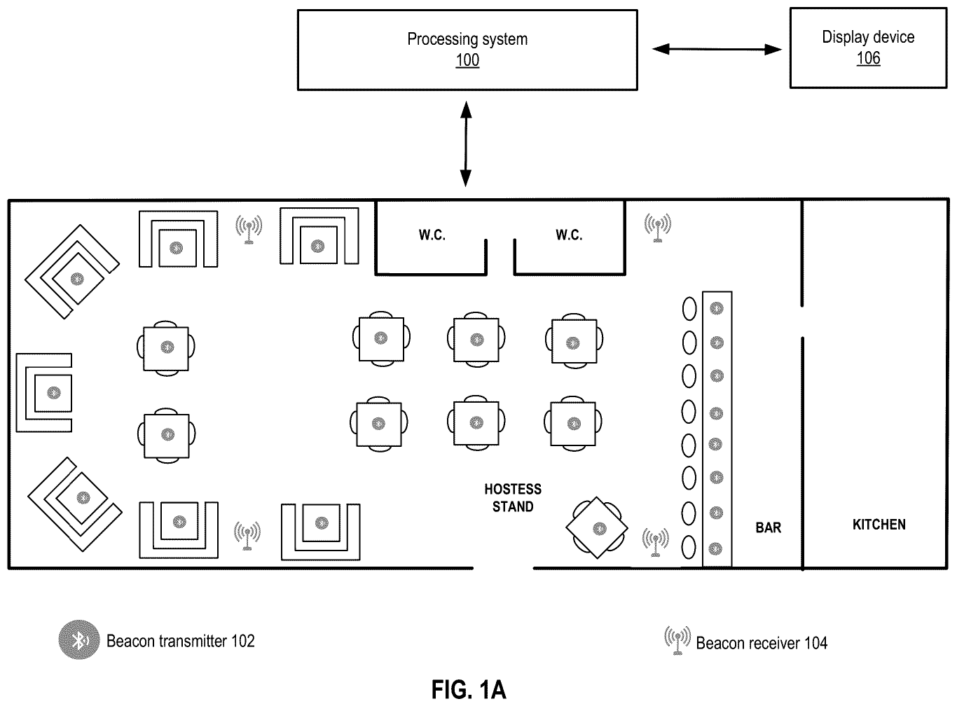

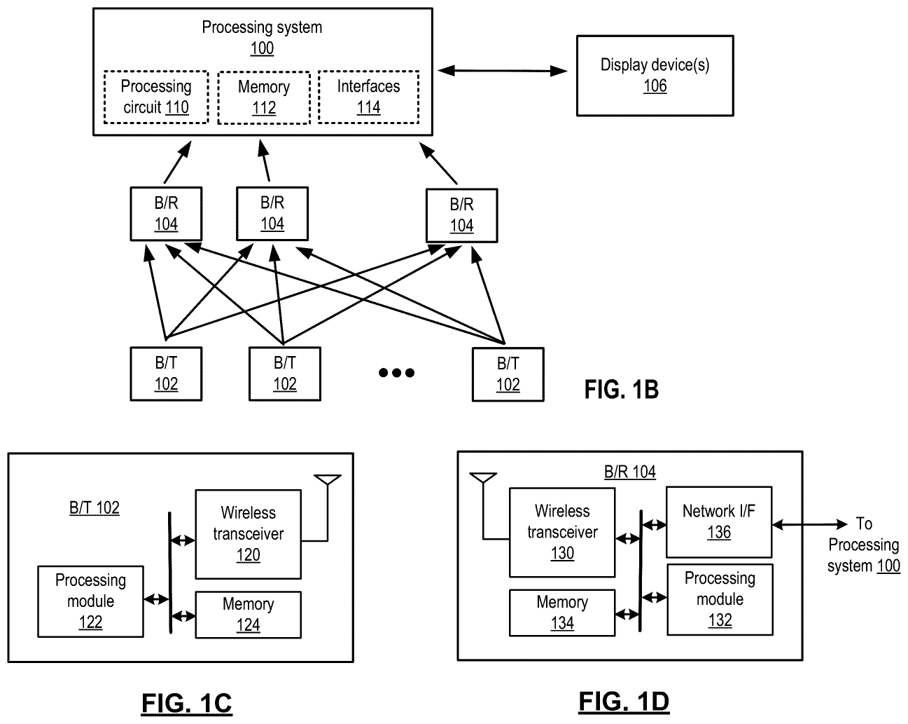

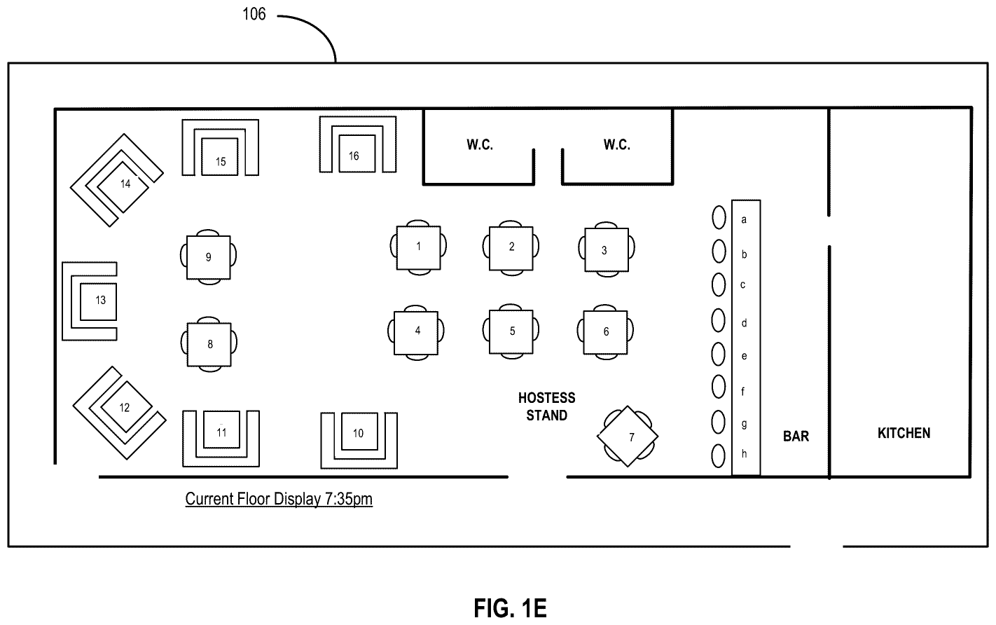

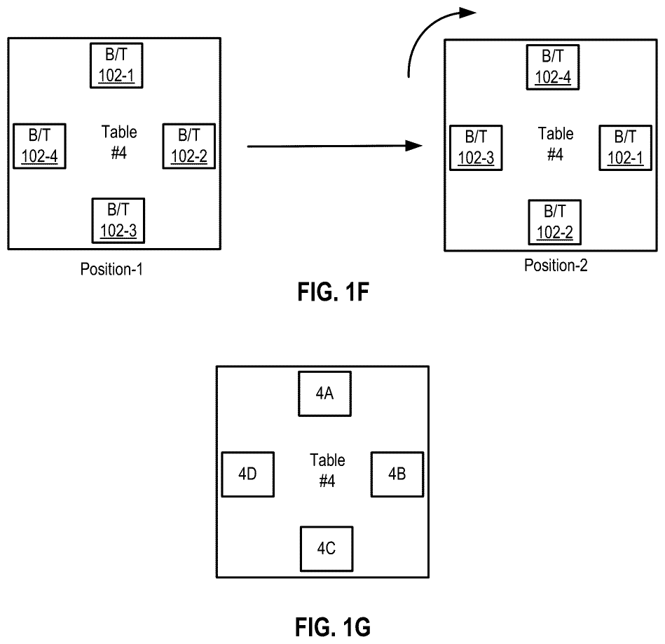

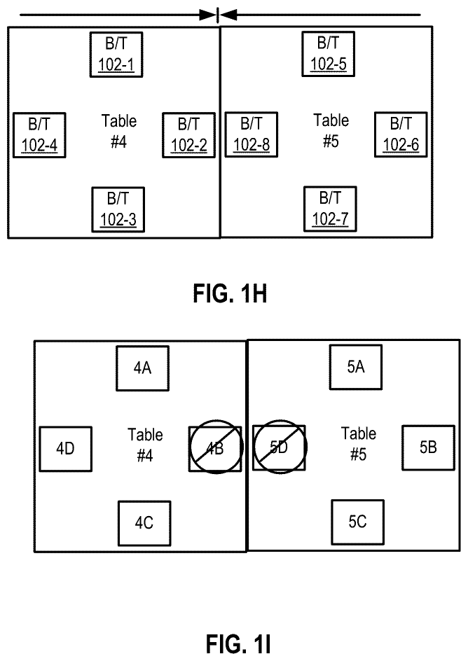

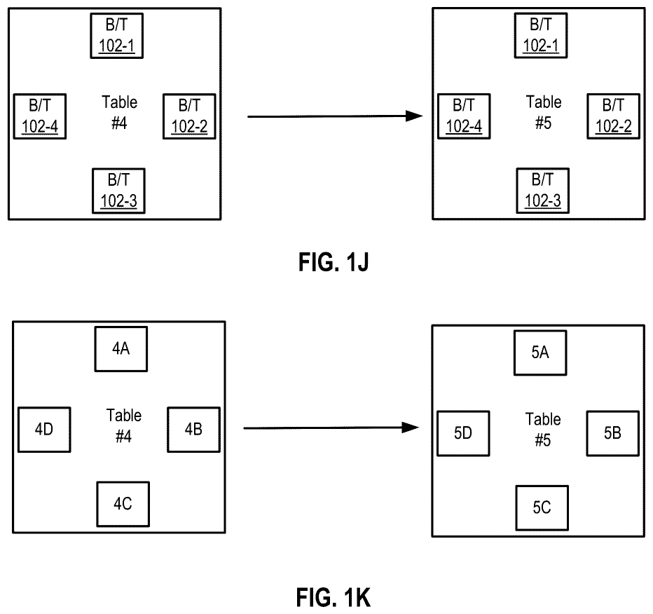

FIG. 1A presents a pictorial/block diagram representation of an example system. In particular, system is presented that deploys a plurality of beacon transmitters 102 and beacon receivers 104 that interact with a processing system 100 that is coupled to one or more display devices 106 in order to implement an intelligent venue. Consider that many venues have tables that can be rearranged to accommodate differing groups of guests (e.g., party sizes). In the example shown, the beacon transmitters 102 are affixed to various tables of the venue. A current positioning of the tables can be determined by the processing system 100 based on the reception, via the beacon receivers 104, of beacons (i.e., wireless beacons) generated by the beacon transmitters 102. This current position can be used to display a current mapping of table positions that can aid the staff of the venue in servicing these tables.

It should be noted that, while the Bluetooth system symbol is used in FIG. 1A (and some other figures of this disclosure) to represent the beacon transmitters 102, as will be discussed in greater detail in FIG. 1C, other wireless technologies and/or protocols could likewise be employed. Furthermore, in the example shown, an intelligent restaurant is presented, however, the techniques presented herein could likewise be implemented in conjunction with the hospitality segment, a sports venue, a theatre or other entertainment venue, a shopping venue, a transportation lounge, lodging and/or including any other building or structure—whether fully enclosed or partially enclosed. Furthermore, while an indoor venue is presented, the techniques presented herein could likewise be applied to outdoor venues and/or venues that are partially indoor and partially outdoor.

It should also be noted that the beacon transmitters 102 and/or beacon receivers 104 can also be used in addition to, or in the alternative, to support other intelligent mobile applications that may or may not rely on positioning and/or in in-building real-time positioning systems, autonomous vehicle applications such as automated server and/or delivery robots, automated in-building mail delivery, intelligent venue applications, mapping systems that track the position of client devices and/or other transceivers and/or other applications. Several such applications will be discussed in conjunction with the figures that follow.

FIG. 1B presents a block diagram representation of an example system. In particular, a system is shown that includes a plurality of beacon transmitters 102, a plurality of beacon receivers 104, a processing system 100 and one or more display devices 106. In various examples, the display devices 106 can include an operator's display for use by venue management, a hostess display to be used in conjunction with a hostess stand, a kitchen display that can be reviewed by other venue staff such as servers and busboys and/or one or more other displays.

The processing system 100 includes a processing circuit 110 and a memory 112 and a plurality of interfaces 114. The processing system 100 can further include one or more additional elements that are not specifically shown. The processing circuit 110 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 112.

The memory 112 can include a hard disc drive or other disc drive, solid state drive, read-only memory, random access memory, volatile memory, non-volatile memory, static memory, dynamic memory, flash memory, cache memory, and/or any device that stores digital information. Note that when the processing circuit implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

In various examples, the memory 112 stores data such as an operating system, table position system (TPS) application and associated table data, a staff position application (SPA) and associated staff data, an order processing application and associated order data, menu data, inventory data, a reservations system application, a server/table allocation application, a staff management application, a security application for providing secure and/or authenticated access to the system and/or other applications. The data stored by the memory 112 can further include audio, text, images, graphics, video and/or other media content, control data, security data, authentication data, metadata, guest/customer data, other application data and/or other data. In various examples, the operating system and the other applications listed above each include operational instructions that, when executed by the processing circuit 110, cooperate to configure the processing circuit into a special purpose device to perform the particular functions of the processing system 100 described herein.

The interfaces 114 of the processing system 100 can include a video and/or audio/video (AV) interface for supporting the display devices 106, a user interface that supports the operation of one or more user interface devices. The user interface can include a graphical user interface and furthermore the user interface devices can include, for example, a touch screen, key pad, touch pad, joy stick, thumb wheel, a mouse, one or more buttons, a speaker, a microphone, an accelerometer, gyroscope or other motion or position sensor, video camera and/or other interface devices that provide information to a user of the processing system 100 and that generate data in response to the user's interaction with the processing system 100 to control the various functions attributed to the processing system 100. In other examples, the processing system 100 may be a virtual machine without a graphical user interface.

The interfaces 114 can further include a network interface for communicating with the beacon receivers 104. Such a network interface can include a wireless local area network interface, a cellular data interface, or other wireless data interface. Such an interface can include a wired Ethernet, Ethernet over power and/or Ethernet over coax interface, a Firewire interface, a multimedia over Coaxial Alliance (MoCA) interface and/or other wired interface. In addition or in the alternative, the interfaces 114 can include a network interface for wirelessly communicating with one or more client devices of the venue and/or of the guests either directly via a wireless network or indirectly via another network that may be wired or wireless. In addition or in the alternative, the interfaces 114 can further include a network interface for communicating over the Internet and/or other wide area network, a network interface for communicating over a private network and/or local area network, and/or other network interface. It should be noted that the processing system 100 can be implemented as a single integrated system that is located with the venue, can be implemented on a distributed basis with portions of the processing system located at the venue and other portions located elsewhere and connected via a network and/or implemented via a cloud computing system.

Consider the following example where each of the plurality of beacon transmitters 102 is fixed to one of a plurality of tables of a venue, where each of the plurality of beacon transmitters 102 is configured to transmit one of a plurality of wireless beacons, and where each of the plurality of wireless beacons is associated with table identification (ID) data corresponding to one of the plurality of tables of the venue. The plurality of beacon receivers 104 are configured to receive the plurality of wireless beacons transmitted by the plurality of beacon transmitters 102 and to generate beacon data in response thereto.

Consider the following example where each wireless beacon conveys a unique identifier, such as MAC address, UUID, device identifier, or other digital sequence or other code, that serves to distinguish each of the wireless beacons from one another. The beacon data can be generated in order to extract this beacon ID from each wireless beacon that was received as well as to include other information regarding reception of the beacon signal that can be used, for example, in determining the position of the corresponding beacon transmitter 102 that sent the wireless beacon.

In accordance with this example, the memory 112 of the processing system 100 stores operational instructions corresponding to a table position system (TPS) application and the processing circuit 110 is configured to execute the operational instructions, wherein the operational instructions cause the processing circuit 110 to:
generate, in response to the beacon data, location data that indicates a position of each of the plurality of tables;
generate map display data that plots the position of each of the plurality of tables on a map of the venue; and
facilitate display of the map of the venue via a display device.

In various examples, each of the plurality of beacon receivers 104 is located at a fixed position at the venue. These fixed positions are stored in the memory 112 of the processing system 100 and used by the TPS application to determine the position of each of the beacon transmitters 102. The determination of the position of each of the beacon transmitters, based on the beacon data generated in response to the received wireless beacons, can be accomplished in many different ways, several of which are described in the examples below.

Furthermore, the beacon data extracted from the wireless beacons can be used to determine (based on the table ID associated with each beacon), corresponding tables to which the particular beacon transmitters 102 are affixed. This association between table ID and a particular beacon can also be accomplished in many different ways. As discussed above, the beacon data generated in response to a received wireless beacon can include a beacon's unique identifier. The processing system 100 can include a look-up table, index or other database structure that associates (e.g., that maps) each of the unique identifiers with a corresponding table ID. Placing this association functionality in the processing system 100 allows the system to know which beacons are coming from beacon transmitters 102 of the venue and ignore the rest. Furthermore, Major/Minor fields in the beacon can identify the “type” of beacon in order to find the beacon in the database more quickly. Once a particular beacon is located in the database and associated with a particular table ID, information regarding the table, such as the number of seats, the size, shape, dimensions (e.g., including height, and table top dimensions), composition, reconfigurability, whether or not it is movable, etc., can be retrieved as well. This improves the technology of location systems by using cloud logic, remappings and/or other mechanisms to make changes to the database that can “re-purpose” a beacon without needing to push new data into the beacon transmitter 102 itself. Furthermore, table IDs can be reassociated based on repositionings of the tables in the venue to indicate, for example, that Table 1 is now Table 3—all based merely on updates to the database record to reflect the current names/numerical assignments. While the foregoing has focused on B/Ts 102 affixed to tables, in addition or in the alternative, B/Ts 102 could be affixed to other items in a venue such as chairs, stools, other items of furniture, A/V equipment, and/or other items—with their positions determined in a similar fashion.

In addition or in the alternative to any of the foregoing, the beacon data generated by the each of the plurality of beacon receivers includes, for corresponding ones of the plurality wireless beacons, a unique identifier and at least one of a received signal strength, a signal phase, a signal magnitude, a time of flight, a distance and/or an angle of arrival.

In addition or in the alternative to any of the foregoing, each of the plurality of wireless beacons are further associated with data indicating whether or not the corresponding one of the plurality of tables is in a fixed position.

In addition or in the alternative to any of the foregoing, the system further includes: a plurality of other beacon transmitters, wherein each of the plurality of other beacon transmitters is fixed to one of a plurality of other tables of a venue, wherein each of the plurality of other beacon transmitters is configured to transmit one of a plurality of other wireless beacons, wherein each of the plurality of other wireless beacons is associated with table identification (ID) data corresponding to one of the plurality of other tables of the venue, and wherein each the plurality of other tables of the venue in an a fixed position in the venue; wherein the plurality of beacon receivers is further configured to receive the plurality of other wireless beacons transmitted by the plurality of beacon transmitters and to generate other beacon data in response thereto; and wherein the operational instructions cause the processing circuit to generate the map display data to plot the position of each of the plurality of other tables on the map of the venue.

In addition or in the alternative to any of the foregoing, the position of each of the plurality of tables is generated further in response to the other beacon data.

In addition or in the alternative to any of the foregoing, the operational instructions further cause the processing circuit to: generate, in response to the beacon data, orientation data that indicates an orientation of each of the plurality of tables; wherein the map display data is further generated to plot the orientation of each of the plurality of tables on the map of the venue.

In addition or in the alternative to any of the foregoing, the operational instructions further cause the processing circuit to: determine, in response to the beacon data, when two or more of the plurality of tables have been placed together; wherein the map display data is further generated to indicate that two or more of the plurality of tables have been placed together.

In addition or in the alternative to any of the foregoing, the plurality of beacon transmitters include two or more beacon transmitters affixed to one of the plurality of tables of the venue.

In addition or in the alternative to any of the foregoing, wherein the two or more beacon transmitters affixed to one of the plurality of tables of the venue represent two different table positions at the one of the plurality of tables and wherein the include two or more beacon transmitters each generate a corresponding one of the plurality of wireless beacons to further convey table position identification (ID) data.

### Example #1

In this first example, the beacon data generated by the each of the plurality of beacon receivers includes not only the unique identifier, but also an indication of received signal strength (e.g. a received signal strength indicator (RSSI)) from the corresponding beacon. The beacon receivers 104 can be grouped in pairs. Consider there to n beacons generated by n different beacon transmitters 102 that can be received by m beacon receivers 104. The number of combinations of beacon transceiver pairs is C(m, 2). Consider the RSSI received by the jth beacon receiver (B/R) 104 in response to the beacon from ith beacon transmitter (B/T) 102 to be RSSIᵢⱼ. RSSI can be considered to be a function of the distance, so the distance between the ith B/T 102 and the jth B/R 104 can be represented by dᵢⱼ where:

dᵢⱼ=10\hat{ }((MP−RSSIᵢⱼ)/10*N)

Where MP is the measured power (known RSSI measurement at 1m) and N is a constant based on environment, usually a number between 2 and 4.

Similarly, the distance between the ith B/T 102 and the kth B/R 104 can be represented by dᵢₖ where:

dᵢₖ=10\hat{ }((MP−RSSIᵢₖ)/10*N)

Given that the pair consisting of the kth B/R 104 and the jth B/R 104, are in fixed positions (in three dimensions), the distance between these two receivers can be easily calculated as a distance Dⱼₖ. This fixed distance, along with the calculated distances dᵢⱼ and dᵢₖ along with a known height of the beacon transmitter above the floor (e.g., an under-table height) can support a triangulation (trigonometric) calculation or other calculation for this pair that solves for a possible position of the ith B/T 102.

This process can be repeated for some or all of the other C(m, 2) pairs of B/Rs 104 to generate candidate positions that can be combined, by spatial averaging for example, to determine a more accurate position of the ith B/T 102. In addition or in the alternative, similar position calculations could be performed by considering combinations of C(m, 3) of B/Rs 104 to generate candidate positions via trilateration, for example. In addition, a clustering algorithm could be applied, in a preprocessing stage prior to the spatial averaging, to eliminate candidate positions that are statistical outliers and/or that deviate from the other candidate positions (or their mean or median) by more than some error threshold. This this process can be repeated for all of the B/Ts 102 (i=1, . . . n) to yield their respective positions in a similar fashion.

In addition or in the alternative, combinations of 4, 5 or greater B/Rs 104 could be employed to improve the accuracy of these measurements. In various examples, the value N or other RSSI calculations can be determined statically for a particular environment based on measurements of the environment in a representative condition and/or dynamically via analytical modeling/simulation that is based on a set of parameters (including measurements, predictions and/or other determinations) of the environment in a plurality of different representative conditions. In other examples, the value of N or other RSSI calculations can be determined based on an AI model that is trained on established distances and RSSI measurements corresponding to a set of parameters (including measurements, predictions and/or other determinations) of the environment in a plurality of different representative conditions. In either case, these parameters can include differing values of temperatures, relative humidity levels, times of day, occupancy levels, table compositions, etc., and the AI model can be trained on combinations of one or more of these parameters. Once trained, the AI model can then estimate the value of the N based on then-current parameters of the environment. Examples of such AI models include machines that operate via artificial neural networks, convolutional neural networks, support vector machines (SVMs), deep learning and other machine learning techniques that are trained using training data via unsupervised, semi-supervised, supervised and/or reinforcement learning, and/or other AI. Similar techniques could be used to train and use an AI model that generates distances and/or positions in a similar fashion.

### Example #2

In this second example, consider that situation where the B/Rs 104 are capable of determining the angle of arrival (e.g. signal direction) for of each of the beacons and including this in the beacon data. This can be accomplished, for example, by employing a B/Rs 104 with multi-antenna front-ends that support beamforming or otherwise operate via mixed signals including real and imaginary signal components, signal magnitude and phase, and/or signal delays between the different antennas in order to derive the incoming direction of each beacon. Consider that the angle of arrival of the beacon from ith B/T 102 at the jth B/R 104 is represented by θᵢⱼ and the angle of arrival of the beacon from ith B/T 102 at the kth B/R 104 is represented by θᵢₖ. The distance Dⱼₖ along with the calculated angles θᵢⱼ and θᵢₖ can support a triangulation (trigonometric) calculation that solves for the position of the ith B/T 102.

As in Example #1, this process can be repeated for some or all of the C(m, 2) pairs of B/Rs 104 and the results can be combined, by spatial averaging or clustering (optionally with the elimination of outliers) for example, to determine the position of the ith B/T 102. Furthermore, this process can be repeated for all of the B/Ts 102 to yield their positions in a similar fashion.

### Example #3

In this third example, the RSSI results from Example #1 and angle of arrival results from Example #2 can be combined, by spatial averaging, clustering and/or elimination of outliers, for example, to determine the position of the ith B/T 102. Furthermore, this process can be repeated for all of the B/Ts 102 to yield their positions in a similar fashion.

### Example #4

In this fourth example, B/Rs 104 and B/Ts 102 operate in accordance with Bluetooth 5.1, ultrawideband (UWB) or other protocol or standard that supports time-of-flight calculations. These time-of-flight calculations are used in addition to, or in place of, the RSSI-based distance calculations of Example #1 or Example #3 to provide greater accuracy in the calculation of distances.

### Example #5

In this fifth example, the TPS application includes an artificial intelligence (AI) model that is trained, via machine learning, based on a training set of beacon data (RSSI, angle of arrival and/or time-of-flight), corresponding to a set of possible rearrangements of the tables of the venue and generated on differing conditions such as temperatures, relative humidity levels, times of day, occupancy levels, table compositions, etc. Examples of such AI models include machines that operate via artificial neural networks, convolutional neural networks, support vector machines (SVMs), deep learning and other machine learning techniques that are trained using training data via unsupervised, semi-supervised, supervised and/or reinforcement learning, and/or other AI. Once trained, the collected beacon data is input to the AI model in order to generate AI output corresponding to or otherwise used to determine the positions for each of the tables.

It should be noted that, in some circumstances, the venue includes not only tables that can be rearranged, but also B/Ts 102 affixed to tables and/or other seating positions that are stationary—and remain in fixed positions. For example, referring back at FIG. 1A, the tables in booth seating and positions in bar seating are both fixed. In various examples, the table IDs associated with the beacons generated by the B/Ts 102 include an indication of whether or not each particular table is capable of being repositioned. As discussed above, the TPS application can maintain a data base of table IDs that indicates whether or not a particular table is capable of being repositioned.

Beacons and/or beacon data received from B/Ts 102 in fixed table positions can be used for various purposes. In one example, “positions” of fixed table positions can be calculated based on received beacon data from these corresponding B/Ts 102 and used to calculate position variations that, for example, indicate systemic drifts, current environmental conditions and/or variations in reception from one or more B/Rs 104. The beacon data from movable tables can be calibrated, and/or the position calculations can be adjusted, to reflect these variations. In addition or in the alternative, the calculated position variations can be compared to a minimum performance threshold. If the minimum performance threshold is exceeded, this can be used to trigger taking the automated table position system offline and/or to trigger the flagging of the AI model of Example #5 for retraining.

In addition or in the alternative, the table IDs associated with the beacons generated by the B/Ts 102 include an indication of the size of the table, the dimensions of the table (e.g., including height, and table top dimensions), the shape of the table, and/or a position at the table—particularly in cases where multiple B/Ts 102 are affixed to a single table. In addition or in the alternative, the TPS application maintains a data base of table IDs that indicates an indication of the size of the table, the dimensions of the table (e.g., including height, and table top dimensions), the shape of the table, and/or a position at the table.

FIG. 1C presents a block diagram representation of an example beacon transmitter. In particular, a beacon transmitter 102 is presented that includes a processing module 122, a memory 124 and a wireless transceiver 120 that includes one or more antennas. While not expressly shown, B/T 102 can include a replaceable battery for powering the components of the device. In the alternative, B/T 102 can include a battery that is rechargeable via an external charging port, for powering the components of the device.

The wireless transceiver 120 can be implemented via a transceiver that operates in conjunction with a communication standard such as an 802.11 protocol, Bluetooth protocol, Bluetooth Low Energy (BLE) protocol, ZigBee protocol, UWB protocol, Wimax protocol and/or other radio frequency protocol.

The processing module 122 can be implemented using a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in memory, such as memory 124. Note that when the processing module 122 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory 124 stores, and the processing module 122 executes, operational instructions corresponding to at least some of the steps and/or functions illustrated herein.

The memory 124 may be a single memory device or a plurality of memory devices. Such a memory device may be a read-only memory, random access memory, volatile memory, non-volatile memory, static memory, dynamic memory, flash memory, cache memory, and/or any device that stores digital information. While the components of B/T 102 are shown as being coupled by a particular bus structure, other architectures are likewise possible that include additional data busses and/or direct connectivity between components. B/T 102 can include additional components that are not expressly shown.

As previously discussed, the B/T 102 generates a beacon having a unique identifier that is associated with a table ID, other data associated with the table to which it is affixed, a position at the table and/or other data for use by the processing system 100. While styled as a beacon “transmitter”, the receiver portion wireless transceiver 120 can be used to facilitate time-of-flight calculations (when implemented), updates, resets and/or other control functions of the system, as may be required.

FIG. 1D presents a block diagram representation of an example beacon receiver. In particular, a beacon receiver 104 is presented that includes a processing module 132, a memory 134, a network interface 136, such as a wired or wireless interface, and a wireless transceiver 130 that includes one or more antennas. While not expressly shown, B/R 104 can include a replaceable battery for powering the components of the device. In the alternative, B/R 104 can include a battery that is rechargeable via an external charging port, for powering the components of the device or be powered by a dedicated power supply connected to line voltage.

The wireless transceiver 130 can be implemented via a transceiver that operates in conjunction with a communication standard such as an 802.11 protocol, Bluetooth protocol, Bluetooth Low Energy (BLE) protocol, ZigBee protocol, UWB protocol, Wimax protocol and/or other radio frequency protocol.

The processing module 132 can be implemented using a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in memory, such as memory 134. Note that when the processing module 132 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory 134 stores, and the processing module 132 executes, operational instructions corresponding to at least some of the steps and/or functions illustrated herein.

The memory 134 may be a single memory device or a plurality of memory devices. Such a memory device may be a read-only memory, random access memory, volatile memory, non-volatile memory, static memory, dynamic memory, flash memory, cache memory, and/or any device that stores digital information. While the components of B/R 104 are shown as being coupled by a particular bus structure, other architectures are likewise possible that include additional data busses and/or direct connectivity between components. B/R 104 can include additional components that are not expressly shown.

As previously discussed, the B/R 104 generates beacon data captured from a beacon that includes a unique identifier associated with a table ID, other data associated with the table to which it is affixed, and/or a position at the table. The B/R 104 further generates an RSSI, angle of arrival, time-of-flight data and/or other data for transmission to the processing system 100 via the network interface 136. While styled as a beacon “receiver”, the transmitter portion wireless transceiver 130 can be used to support time-of-flight calculation (when implemented), coordinate updates, resets and/or other control functions of B/Ts 102 for example, as may be required.

FIG. 1E presents a pictorial diagram representation of an example screen display. In particular, a screen display of display device 106 is presented that can be provided to staff of the venue to visually represent the positions of each of the tables. In the example shown, table positions 10-16 correspond to fixed booth seating. Table positions a-h correspond to fix positions at the bar. Tables 1-9 are re-arrangeable and are positioned on the map display at locations that correspond to the table positions calculated by the TPS application.

FIGS. 1F-1K present pictorial block diagrams of example table configurations. As previously discussed, each table of the venue could have more than one B/T 102 affixed thereto. Consider the table (#4) presented in conjunction with FIG. 1F that includes 4 B/Ts specifically 102-1, 102-2, 102-3, 102-4. In the example shown, these four B/Ts are positioned to correspond to possible seating positions of the table, and each corresponding beacon is associated with not only a table ID, but also a seating position indicator such as a table position ID. In this fashion, the unique identifier corresponding wireless beacon can be correlated, via the database of the processing system 100, with a corresponding table position ID along with other data associated with the table. The use of four B/Ts 102 for the table provides further information to help determine the position of the table, allows seating positions to be identified and optionally allows the processing system to determine and map additional information.

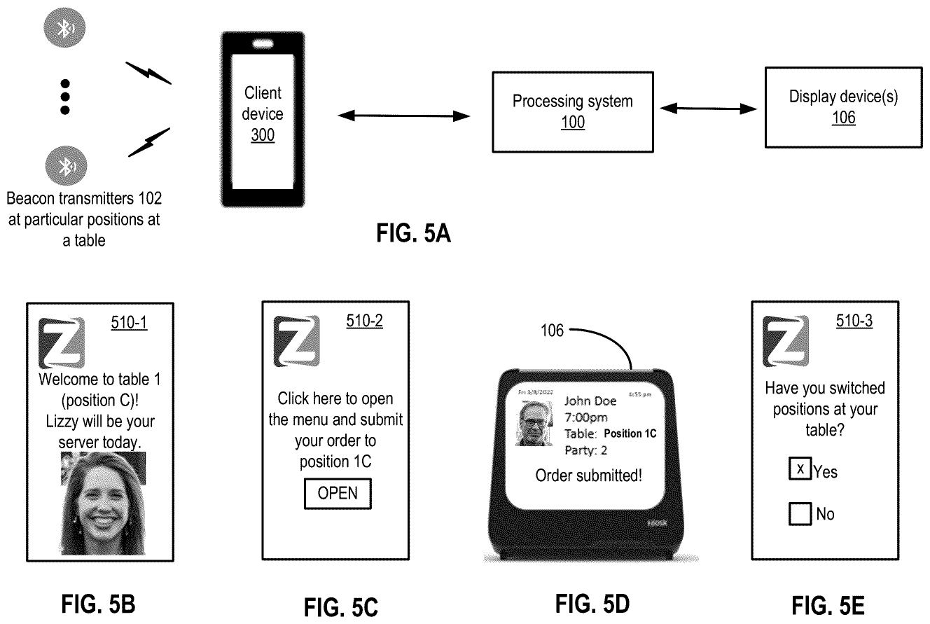

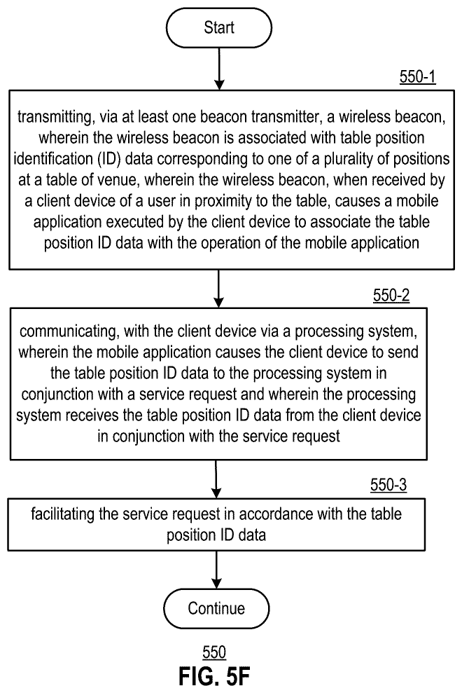

In the example shown, the orientation of the table has been rotated by 90 degrees from position-1 to position-2. Consider further an application (to be discussed further in conjunction with FIGS. 5A-5F that follow) where the B/Ts 102 on the same table are used to associate guests and/or orders to corresponding seat positions. Consider further that this could otherwise be confusing to servers that are used to assigning seat positions based on an absolute orientation with respect to the surroundings.

In addition or in the alternative to any of the foregoing, the TPS application determines the positions of the B/Ts 102-1, 102-2, 102-3 and 102-4 and maps them to absolute seating positions 4A, 4B, 4C and 4D in generating the map data for display of the map of the venue on the display device 106 as shown in FIG. 1G. In this fashion, a guest sitting adjacent to B/T 102-1 in table position-1, just as a guest sitting adjacent to B/T 102-4 in position-2, would be treated as sitting in the absolute seating position 4A reflected in the map display and referred to for consistency—allowing servers to provide services to patrons in that known position.

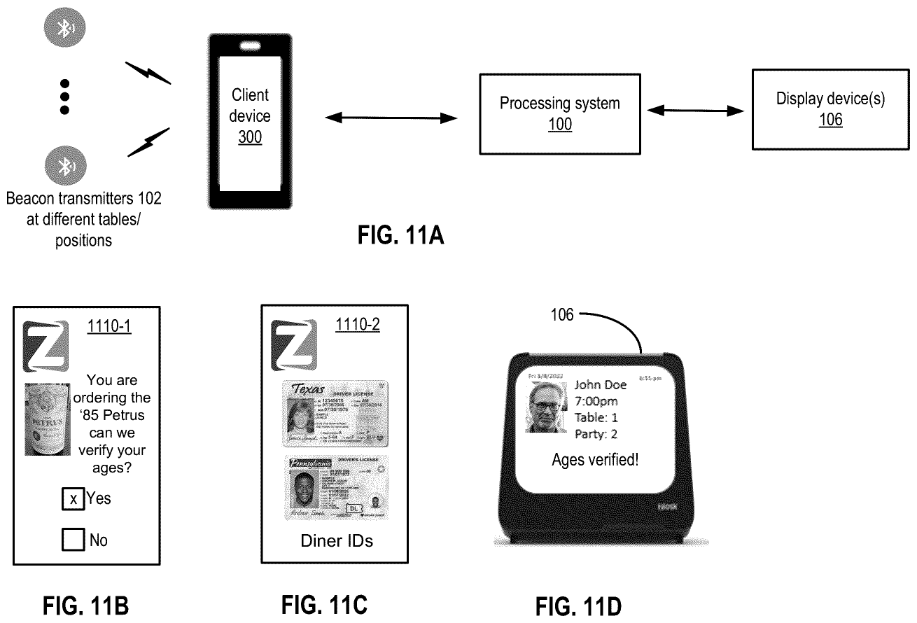

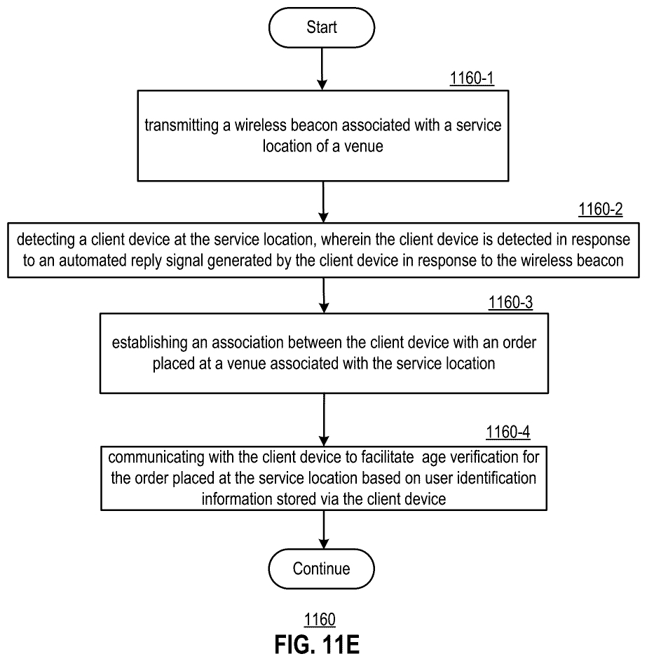

In addition or in the alternative to any of the foregoing, the TPS application can determine when two or more tables have been combined to accommodate a larger party. In the example shown in FIG. 1H, tables 4 and 5 have been combined. In FIG. 11, the positions of the B/Ts 102-1 through 102-8 have been mapped to absolute seating positions for display of the map of the venue on the display device 106. The TPS application can, in this example, determine that seating positions adjacent to B/Ts 102-2 and 102-8 (mapped to absolute seating positions 4B and 5D) are un-servable and prevent orders from being taken or delivered to/from these positions.

Also note that tables, once moved, may be returned to a different position than their initial position. In the example shown in FIG. 1J, after tables 4 and 5 were put together, table #4 having B/Ts 102-1 through 102-4 has been returned to the position normally occupied by table #5. In addition or in the alternative to any of the foregoing, the TPS application can recognize this shift based on the new positions of B/Ts 102-1 through 102-4, and reassign the table (prior table #4) to be table #5 in generating the map data for display of the map of the venue on the display device 106. Based on this mapping, B/Ts 102-1 through 102-4 now correspond to seating positions 5A-5D of table 5 so that orders placed from that table can be correctly delivered without server confusion.

FIG. 1L presents a flowchart representation 150 of an example method. In particular, a method is presented for use in conjunction with one or more functions and features described in conjunction with FIGS. 1A-1K. For example, a method is presented for use in a processing circuit and/or other processing module, such as may be included in the processing system 100 of FIG. 1B, that executes a TPS application.

Step 150-1 includes transmitting, via plurality of beacon transmitters, a plurality of wireless beacons, wherein each of the plurality of beacon transmitters is fixed to one of a plurality of tables of a venue, and wherein each of the plurality of wireless beacons is associated with table identification (ID) data corresponding to one of the plurality of tables of the venue. Step 150-2 includes receiving, via a plurality of beacon receivers, the wireless beacons transmitted by the plurality of beacon transmitters. Step 150-3 includes generating beacon data via the plurality of beacon receivers in response to the wireless beacons. Step 150-4 includes generating, via a processing circuit, location data that indicates a position of each of the plurality of tables. Step 150-5 includes generating map display data that plots the position of each of the plurality of tables on a map of the venue. Step 150-6 includes facilitating display of the map of the venue via a display device.

It should be noted that the method described above can be subjected to any or all of the particular combinations of optional features attributed to the system of FIGS. 1A and 1B as discussed in conjunction with FIGS. 1C-1K above.

In addition or in the alternative to any of the foregoing, each of the plurality of beacon receivers is located at a fixed position at the venue.

In addition or in the alternative to any of the foregoing, the beacon data generated by the each of the plurality of beacon receivers includes, for corresponding ones of the plurality wireless beacons, the unique identifier and at least one of a received signal strength, a signal phase, a signal magnitude, a time of flight, a distance and an angle of arrival.

In addition or in the alternative to any of the foregoing, each of the plurality of wireless beacons is associated with data indicating whether the corresponding one of the plurality of tables is in a fixed position.

In addition or in the alternative to any of the foregoing, the method further includes providing a plurality of other beacon transmitters, wherein each of the plurality of other beacon transmitters is fixed to one of a plurality of other tables of a venue, wherein each of the plurality of other beacon transmitters is configured to transmit one of a plurality of other wireless beacons, wherein each of the plurality of other wireless beacons is associated with table identification (ID) data corresponding to one of the plurality of other tables of the venue, and wherein each the plurality of other tables of the venue in an a fixed position in the venue, wherein the plurality of beacon receivers is further configured to receive the plurality of other wireless beacons transmitted by the plurality of beacon transmitters and to generate other beacon data in response thereto; wherein generating the map display data includes plotting the position of each of the plurality of other tables on the map of the venue.

In addition or in the alternative to any of the foregoing, the position of each of the plurality of tables is generated further in response to the other beacon data.

In addition or in the alternative to any of the foregoing, the method further includes: generating, in response to the beacon data, orientation data that indicates an orientation of each of the plurality of tables; wherein the map display data is further generated to plot the orientation of each of the plurality of tables on the map of the venue.

In addition or in the alternative to any of the foregoing, the method further includes: determining, in response to the beacon data, when two or more of the plurality of tables have been placed together; wherein the map display data is further generated to indicate that two or more of the plurality of tables have been placed together.

In addition or in the alternative to any of the foregoing, the plurality of beacon transmitters include two or more beacon transmitters affixed to one of the plurality of tables of the venue.

In addition or in the alternative to any of the foregoing the two or more beacon transmitters affixed to one of the plurality of tables of the venue represent two different table positions at the one of the plurality of tables and wherein the include two or more beacon transmitters each generate a corresponding one of the plurality of wireless beacons to further convey table position identification (ID) data.

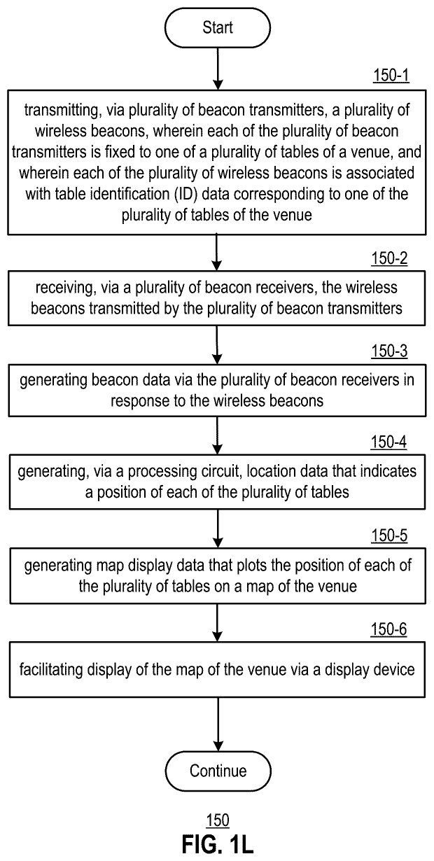

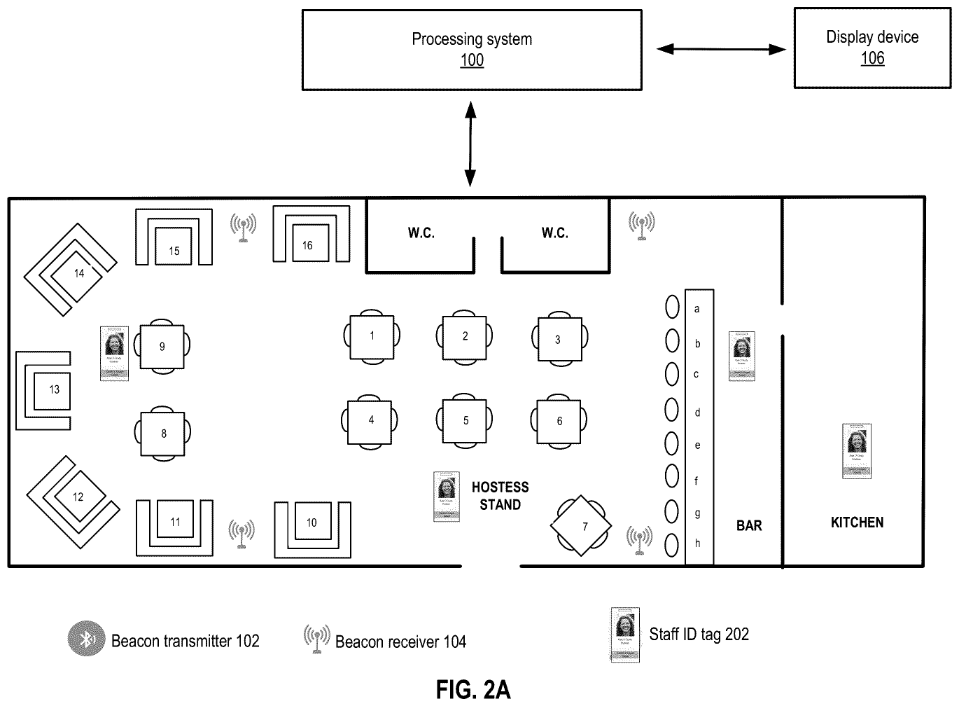

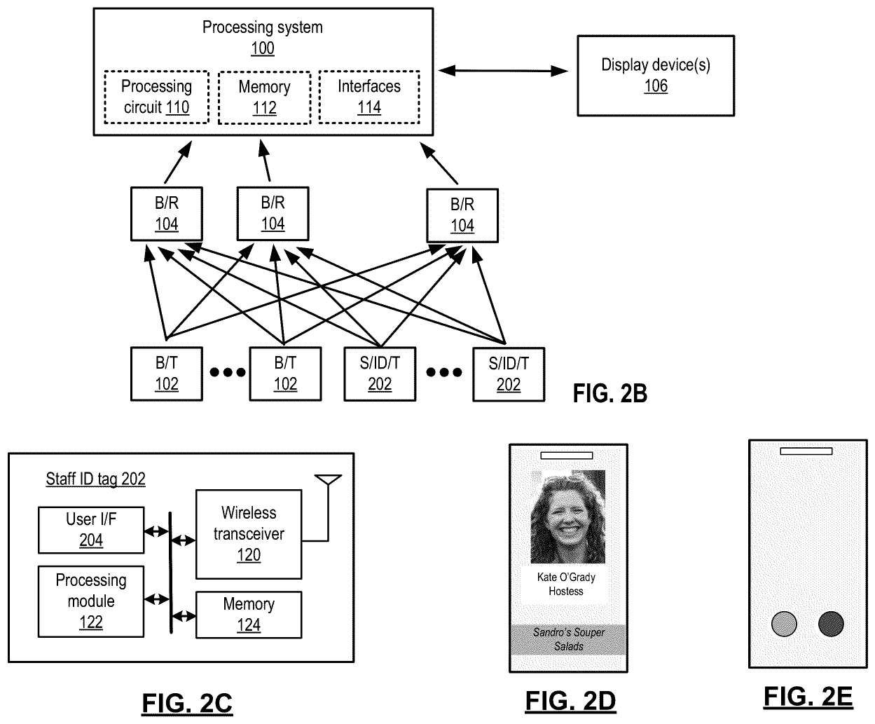

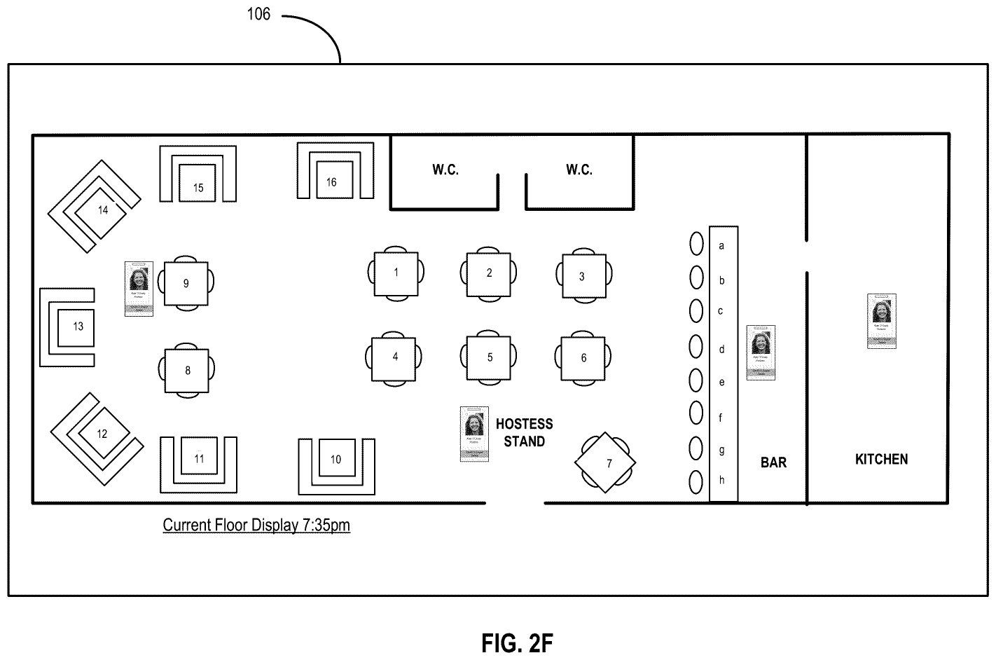

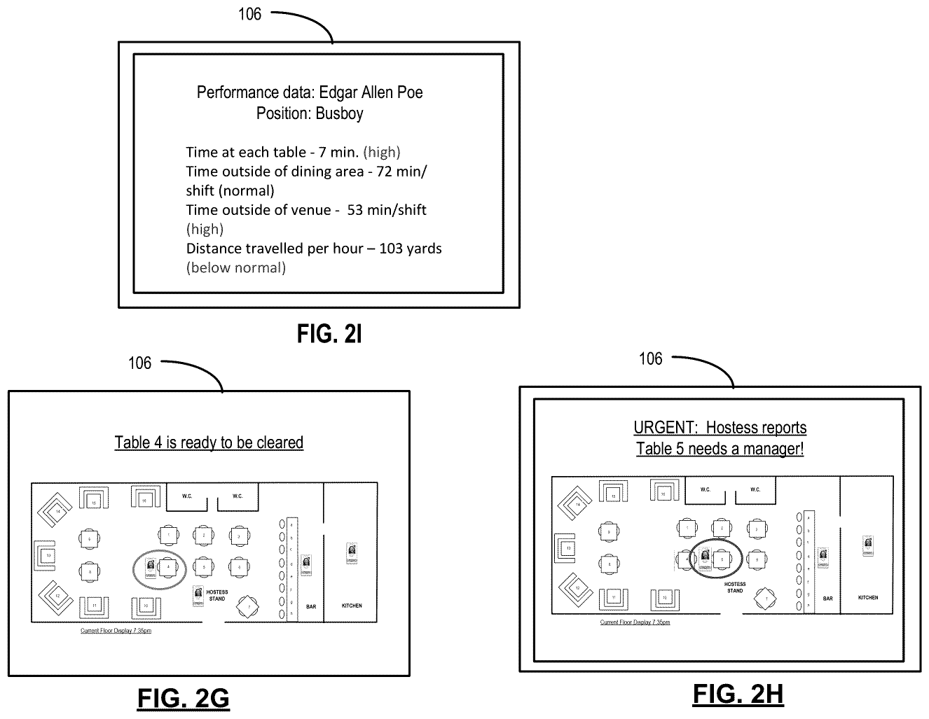

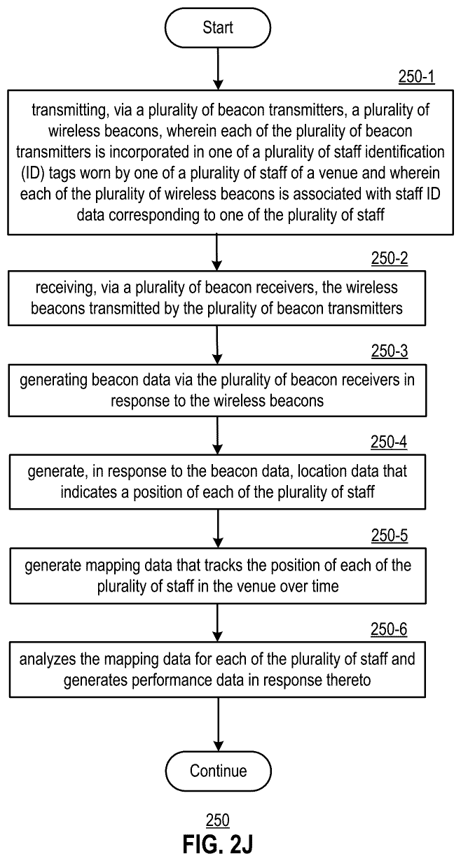

FIG. 2A presents a pictorial/block diagram representation of an example system. This system can be used in addition or in the alternative to any of the foregoing examples, including the examples provided in conjunction with FIGS. 1A-1L.

For example, a system is presented for use with a processing module 100 other processing system. In addition to any of the functions and features described in conjunction with FIGS. 1A-1L, staff identification (ID) tags 202 are provided to staff members to wear on their person while at work. These staff ID tags 202 include beacon transmitters that include or otherwise operate similarly to B/Ts 102 and allow the positions of the staff ID tags 202 to be determined in real-time via the processing system 100. This permits, for example, the position of the staff members to be mapped and analyzed in order to generate staff metrics, performance data, alerts and/or to enable other functions and features that will be described in the sections that follow.

FIG. 2B presents a block diagram representation of an example system. Similar elements described in conjunction with FIG. 1B are referred to by common reference numerals. In the addition, a plurality of beacon transmitters is incorporated in a corresponding plurality of staff ID tags (S/ID/T) 202, each worn by one of a plurality of staff of a venue. Each of the plurality of beacon transmitters is configured to transmit one of a plurality of wireless beacons, and wherein each of the plurality of wireless beacons is associated, via a unique identifier, with staff ID data corresponding to one of the plurality of staff.

The plurality of beacon receivers 104 is configured to receive the plurality of beacon signals transmitted by the plurality of beacon transmitters corresponding to the staff ID tags 202 and to generate beacon data in response thereto. The memory 112 of the processing system 100 stores operational instructions corresponding to a staff position system (SPS) application and the processing circuit 110 is configured to execute the operational instructions, wherein the operational instructions cause the processing circuit 110 to:
generate, in response to the beacon data, location data that indicates a position of each of the plurality of staff;
generate mapping data that tracks the position of each of the plurality of staff in the venue over time; and
analyze the mapping data, for each of the plurality of staff and generates performance data in response thereto.

In various examples, the SPS application operates in conjunction with, and similarly to, the TPS application to determine the positions of each of the beacon transmitters 102 incorporated in the staff ID tags 202 as discussed in conjunction with FIGS. 1A-1L. In particular, the positions of each of the beacon transmitters 102 can be used to determine (based on the staff ID associated with each beacon), the positions of corresponding staff members who are wearing the tags on their person. This association between staff ID and a particular beacon can also be accomplished in many different ways. As discussed above, the beacon data generated in response to a received wireless beacon can include the beacon's unique identifier. The processing system 100 can include a look-up table, index or other database structure that associates (e.g, that maps) each of the unique identifiers with a corresponding staff ID. Placing this association functionality in the processing system 100 allows the system to know which beacons are coming from beacon transmitters 102 of the venue and ignore the rest. Furthermore, Major/Minor fields can identify the “type” of beacon (e.g., table or staff) in order to find the beacon in the database more quickly. Once a particular beacon is located in the database and associated with a particular staff ID, information regarding the staff member, such as name, position, employee number, shift information, staff metrics, performance information, etc., can be retrieved as well. This improves the technology by using cloud logic, remappings and/or other mechanisms to make changes to the database that can “re-purpose” the tag without needing to push new data into the beacon transmitter 102 itself.

Further operations of the SPS application and the staff ID tags are presented in conjunction with FIGS. 2C-2J that follow and can be used in addition, in combination or as further alternatives to any of the foregoing.

In addition or alternative to any of the foregoing, each of the plurality of beacon receivers is located at a fixed position at the venue.

In addition or alternative to any of the foregoing, each of the plurality of staff identification (ID) tags includes a user interface that permits the user to generate a selected one of a plurality of alerts and wherein the corresponding one of the plurality of beacon signals indicates the selected one of a plurality of alerts.

FIG. 2C presents a block diagram representation of an example staff ID tag. In particular, a staff ID tag 202 is presented that includes a processing module 122, a memory 124 and a wireless transceiver 120 that includes one or more antenna as described in conjunction with FIG. 1C. In addition, the staff ID tag 202 includes a user interface 204, such as one or more buttons, a keypad or other user interface device that allow a staff member to interact with the tag. While not expressly shown, staff ID tag 202 can include a replaceable battery for powering the components of the device. In the alternative, B/T 102 can include a battery that is rechargeable via an external charging port, for powering the components of the device.

As previously discussed, the staff ID tag 202 generates a beacon that is associated with a staff ID, other data associated with the staff member who is to wear the tag and/or other data for use by the processing system 100 and particularly via an SPS application. While styled as a beacon “transmitter”, the receiver portion wireless transceiver 120 can be used to facilitate time-of-flight calculations (when implemented), updates, resets and/or other control functions of the system, as may be required.

In addition or in the alternative to any of the foregoing, the user interface 204 allows the staff member to utilize the staff ID tag 202 to generate one or more types of alert signaling. This alert signaling is wirelessly transmitted by the wireless transceiver 120 to the B/Rs 104, which in turn, generate corresponding alert data that is passed to the processing system 100. In various examples, the B/T 102 of the staff ID tag 202 can generate beacons with a plurality of different unique identifiers—e.g., a normal beacon with the unique identifier associated with staff ID, and one or more other beacons having different unique identifiers associated with one or more alert types (and, in further examples, is also associated with the staff ID). Similarly the alert data can indicate the unique identifier associated with one of a plurality of alert types. In addition, the alert data can further indicate the unique identifier associated with the staff ID data corresponding to the particular staff member that issued the alert. The SPS application can store the alert associations in a database in a similar fashion to the staff ID along with further information associated with the alerts such as an alert type, an alert urgency indication, alert routing information, and/or actions to be taken in response to the alert. Since the SPS application is able to determine where the staff member is located and detect which alert was generated, the SPS application further can then take action in response to the alert that can include, for example, sending a busser or manager to the correct table.

In addition or in the alternative to any of the foregoing, the alert type is a “bus this table” alert. The processing system 100 receives this alert data and the SPS application correlates the staff member's position in the venue (adjacent to Table #4, for example) at the time of the alert to make the determination that Table #4 needs to be bussed. The processing system 100 can generate display data that can include a message, “Table #4 needs to be bussed” for display on a display device 106 located in the kitchen of the venue.

In addition or in the alternative to any of the foregoing, the alert type is an “urgent call to manager”. The processing system 100 receives this alert data and the SPS application correlates the staff member's position in the venue (adjacent to Table #4, for example) at the time of the alert to make the determination that Table #4 is in urgent need of a manager. In other examples, the position of the staff member is indicated by a particular venue location (e.g., in the kitchen, near the hostess stand, in the dining room, in the parking lot, at the entrance, etc.) The processing system 100 can generate display data that can include a message, “URGENT: Table #4 needs a manager” or “URGENT: the hostess stand needs a manager” for display on a display device 106 located in the kitchen of the venue and/or an office of the manager. In this fashion, a staff member that has become involved with unruly guests, witnesses a robbery in progress, a fight or a guest with a weapon, sees a guest who is choking or having some other medical emergency, witnesses an accident, etc., has a mechanism to quickly request help by pressing the button on the staff ID tag 202.

In addition or in the alternative to any of the foregoing, the alert type is an “urgent: call 911” alert. In this case, the processing system 100 can generate display data that can include a message, “URGENT: CALL 911” for display on a display device 106 located in the kitchen and/or the manager office of the venue. In a further example, the processing system can launch an automated 911 call, either itself or through a dedicated emergency call center, via a network interface of the processing system 100.

FIG. 2D presents a pictorial diagram representation of an example staff ID tag. In particular, the front a staff ID tag 202 is shown that includes an identification of the venue, a photo of the staff member, and further includes further staff ID data, in this case identifying information of the staff member. FIG. 2E presents a pictorial diagram representation of a portion of the back of an example staff ID tag 202. In this example, the user interface 204 of the staff ID tag 202 includes a blue button and a red button (oriented as shown). In accordance with prior examples presented in conjunction with FIG. 2C, the blue button can be used by the staff member to launch an “buss table” alert and the red button can be used by the staff member to launch a “manager needed” alert.

FIGS. 2F-2I present a pictorial diagram representations of example screen displays. In FIG. 2F, a screen display of display device 106 is presented that can be provided to staff of the venue to visually represent the positions of each of the tables and the location of several staff. In the example shown one staff member is located near the hostess stand, one staff member is in the kitchen, one staff member is behind the bar, and one staff member is in the dining room adjacent to Table #9. In FIG. 2G, a staff member adjacent to Table #4 has generated an alert indicating that this table needs to be bussed as indicated further by the blue (color of the button pressed) ellipse on the display 106. In FIG. 2H, a staff member (the hostess) is adjacent to Table #5 and has generated an alert indicating that this table needs a manager as indicated further by the blue (color of the button pressed) ellipse on the display 106.

As discussed above, the SPS application allows the positions of the staff ID tags 202 to be determined in real-time. This permits, for example, the position of the staff members to be mapped and analyzed. In various examples, the SPS application includes a staff management application that accumulates this staff position data and analyzes it in order to generate staff metrics and/or other performance data, and in addition or in the alternative, to compare these values to performance thresholds, key performance indicators (KPIs), etc. In addition or in the alternative to any of the foregoing, the staff management application uses the real-time position data for: auto clock-in and clock-out—no need to record start and stop times, foot traffic and staff positioning, and/or speed to table or other staff efficiency metrics, etc. These staff metrics can be further used in a staff scheduling management system, for example, to automatically establish a work schedule based on reserved tables and/or weather (e.g., to schedule the most efficient staff at what is predicted to be the busiest times), to schedule staff to serve large groups or events, to predict preparation and delivery times, and for other venue management tasks.

In the example of FIG. 2I, performance for a particular busboy has been generated and is displayed on a display device 106 located in the manager's office. In the example, the performance data includes: time at each table, time outside of dining area, time outside of venue, distance travelled per hour. Accumulated values for each of these quantities are presented. In addition, these values are compared, via the SPS application, with key performance indicators and/or specific performance thresholds. Abnormal values not falling within normal/accepted boundaries are flagged indicated in red.

FIG. 2J presents a flowchart representation 250 of an example method. In particular, a method is presented for use in conjunction with one or more functions and features described in conjunction with FIGS. 1A-1L and 2A-2I. For example, a method is presented for use in a processing module that executes an SPS application and/or other processing system. Step 250-1 includes transmitting, via a plurality of beacon transmitters, a plurality of wireless beacons, wherein each of the plurality of beacon transmitters is incorporated in one of a plurality of staff identification (ID) tags worn by one of a plurality of staff of a venue and wherein each of the plurality of wireless beacons is associated with staff ID data corresponding to one of the plurality of staff. Step 250-2 includes receiving, via a plurality of beacon receivers, the wireless beacons transmitted by the plurality of beacon transmitters. Step 250-3 includes generating beacon data via the plurality of beacon receivers in response to the wireless beacons. Step 250-4 includes generating, in response to the beacon data, location data that indicates a position of each of the plurality of staff. Step 250-5 includes generating mapping data that tracks the position of each of the plurality of staff in the venue over time. Step 250-6 includes analyzing the mapping data for each of the plurality of staff and generating performance data in response thereto.

It should be noted that the method described above can be subjected to any or all of the particular combinations of optional features attributed to the system of FIGS. 2A and 2B as discussed in conjunction with FIGS. 2C-2I above.

In addition or alternative to any of the foregoing, each of the plurality of beacon receivers is located at a fixed position at the venue.

In addition or alternative to any of the foregoing, each of the plurality of staff identification (ID) tags includes a user interface that permits the user to generate a selected one of a plurality of alerts and wherein the corresponding one of the plurality of beacon signals indicates the selected one of a plurality of alerts.

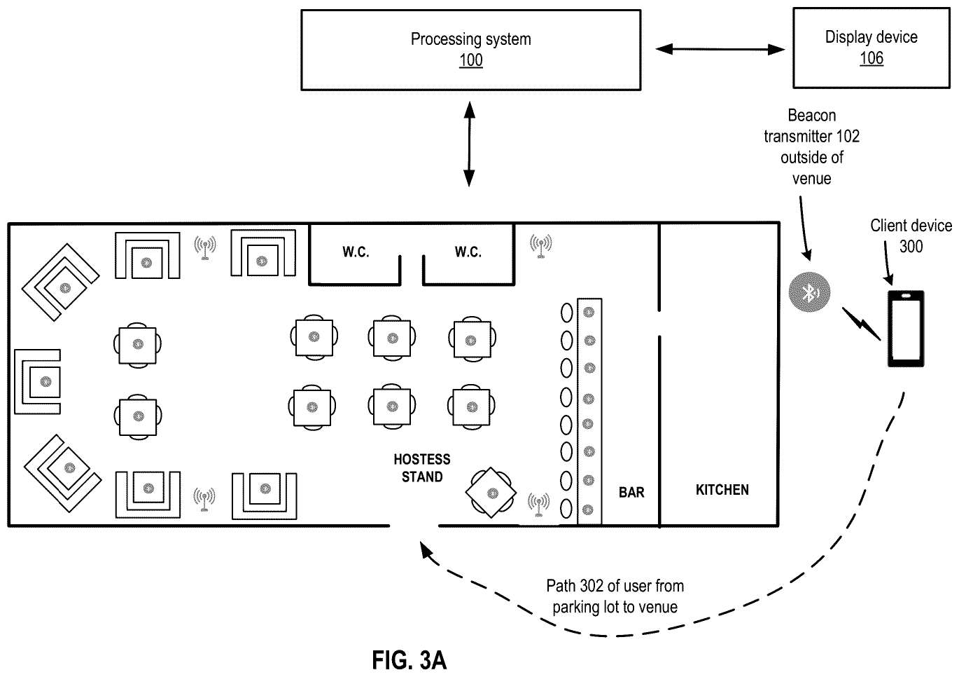

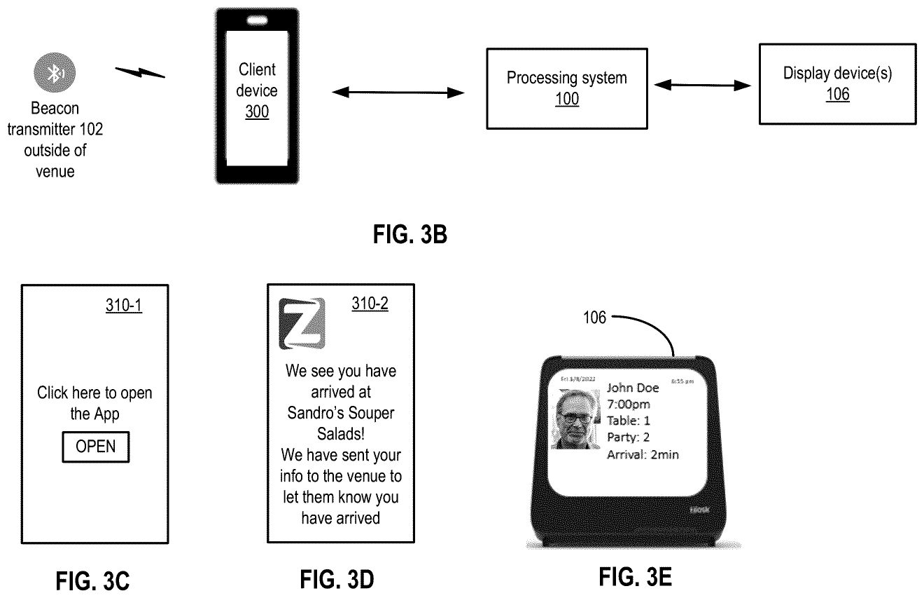

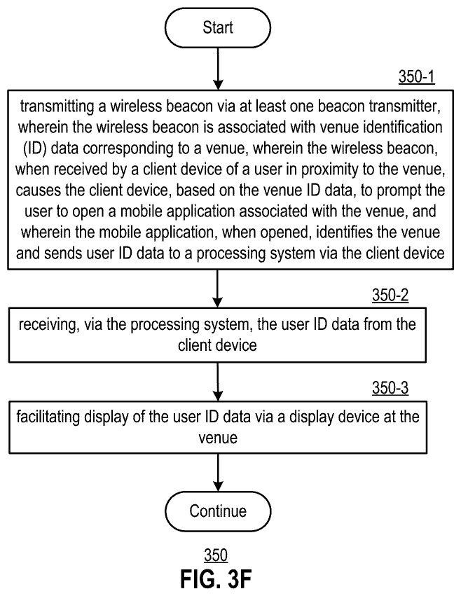

FIG. 3A presents a pictorial/block diagram representation of an example system. Similar elements presented in conjunction with FIG. 1A are referred to by common reference numerals. This system can be used in addition or in the alternative to any of the foregoing examples, including the examples provided in conjunction with FIGS. 1A-1L and 2A-2J.

In this example, a B/T 102 is located outside of the venue. This location can correspond to a parking area, a pathway to the venue, a location near the entrance or other outside location that is traversed by guests who wish to enter the venue. The B/T 102 sends a beacon that includes a message to a client device 300 of the guest (such as a smartphone or other mobile communication device) to download an application (app) associated with the venue and/or to open the mobile app (if it has previously been downloaded). The mobile app, once opened, causes the client device 300 to communicate with the processing system 100 and for example, provide information from the mobile app on the guest's client device 300 indicating to the processing system 100 which particular guest is arriving, and receiving a welcome message from the processing system 100, indicating reservation details, if any.

The processing system can then generate a message to be displayed on a display device 106 located at the hostess stand such as “John Doe is arriving in 1 min” and further to pull up his reservation information in the reservation system. This also allows the hostess to greet the diner by name—facilitating a personal VIP experience and/or to enable other functions and features that will be described in the sections that follow.

FIG. 3B presents a block diagram representation of an example system. In particular, a system is presented that includes elements from FIG. 3A that are referred to by common reference numerals.

Consider the following example of operation. At least one beacon transmitter 102, located outside of a venue, is configured to transmit a wireless beacon. The wireless beacon is associated with venue identification (ID) data corresponding to the venue. When the wireless beacon is received by a client device 300 of a user in proximity to the venue, the wireless beacon causes the client device 300, based on the venue ID data, to prompt the user to open a mobile application associated with the venue via the client device 300. In addition or in the alternative, GPS data retrieved from the client device 300 can be used to identify the venue based on proximity of the mobile device to the venue.

The processing system 100 includes a memory that stores operational instructions corresponding to a hostess application and a processing circuit configured to execute the operational instructions, wherein the operational instructions cause the processing circuit to:
communicate with the client device, wherein the mobile application, when opened, identifies the venue and sends user ID data to the processing system via the client device, and wherein the processing system receives the user ID data from the client device; and
facilitate display of the user ID data via a display device at the venue.

In addition or in the alternative to any of the foregoing, the user ID data includes a name associated with the user of the client device 300, and/or other data that is associated with user data stored via a database of the processing system 100 and can be used to retrieve any or all of such user data.

In addition or in the alternative to any of the foregoing, at least one beacon transmitter is located in proximity to an entrance to the venue.

In addition or in the alternative to any of the foregoing, the processing system 100 includes a wireless network interface that allows the processing system 100 to communicate directly with the client device 300.

In addition or in the alternative to any of the foregoing, the processing system 100 includes a network interface that allows the processing system 100 to communicate indirectly with the client device 300 via a network.

FIGS. 3C-3E present pictorial diagram representations of example screen displays. In FIG. 3C, a screen display 310-1 of a client device 300 has received a beacon from a B/T 102 outside the venue and has prompted the user the open the mobile app. In FIG. 3D, a screen display 310-2 of a client device 300 shows that the mobile app has opened, and a welcome message has been displayed along with an indication that the user's info has been passed along to the processing system of the venue. In FIG. 3E, a screen display of a display device 106 located at the hostess stand, displays information on the arriving guest provided by the mobile app, triggered by the mobile app and/or retrieved via the venue's reservation system.

FIG. 3F presents a flowchart representation 350 of an example method. In particular, a method is presented for use in conjunction with one or more functions and features, including those described in conjunction with FIGS. 1A-1L and 3A-3E.

Step 350-1 includes transmitting a wireless beacon via at least one beacon transmitter, wherein the wireless beacon is associated with venue identification (ID) data corresponding to a venue, wherein the wireless beacon, when received by a client device of a user in proximity to the venue, causes the client device, based on the venue ID data, to prompt the user to open a mobile application associated with the venue, and wherein the mobile application, when opened, identifies the venue and sends user ID data to a processing system via the client device. Step 350-2 includes receiving, via the processing system, the user ID data from the client device. Step 350-3 includes facilitating display of the user ID data via a display device at the venue.

It should be noted that the method described above can be subjected to any or all of the particular combinations of optional features attributed to the system of FIGS. 3A and 3B as discussed in conjunction with FIGS. 3C-3E above.

In addition or in the alternative to any of the foregoing, the user ID data includes a name associated with the user of the client device 300, and/or other data that is associated with user data stored via a database of the processing system 100 and can be used to retrieve any or all of such user data.

In addition or in the alternative to any of the foregoing, the at least one beacon transmitter is located in proximity to an entrance to the venue.

In addition or in the alternative to any of the foregoing, the processing system 100 includes a wireless network interface that allows the processing system 100 to communicate directly with the client device 300.

In addition or in the alternative to any of the foregoing, the processing system 100 includes a network interface that allows the processing system 100 to communicate indirectly with the client device 300 via a network.

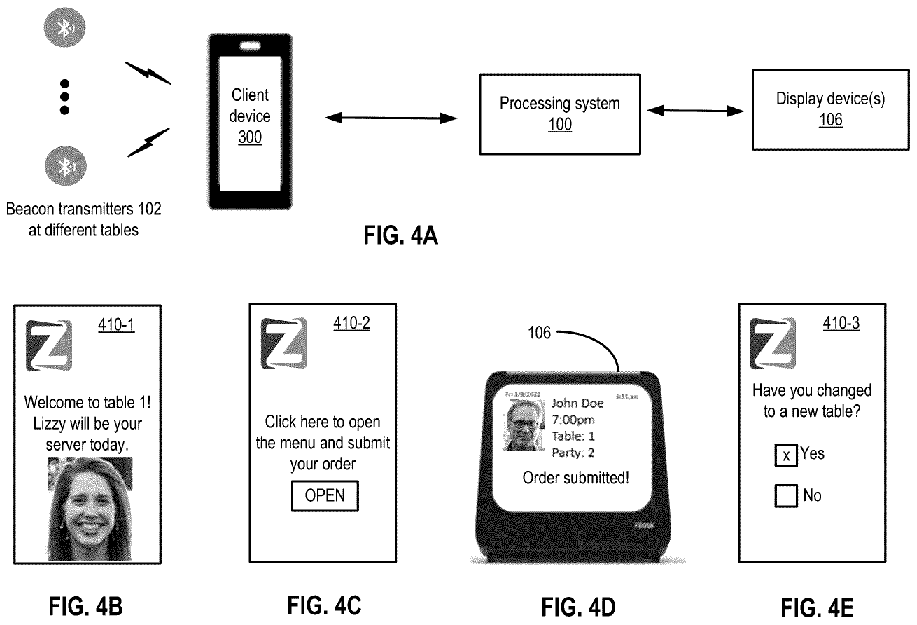

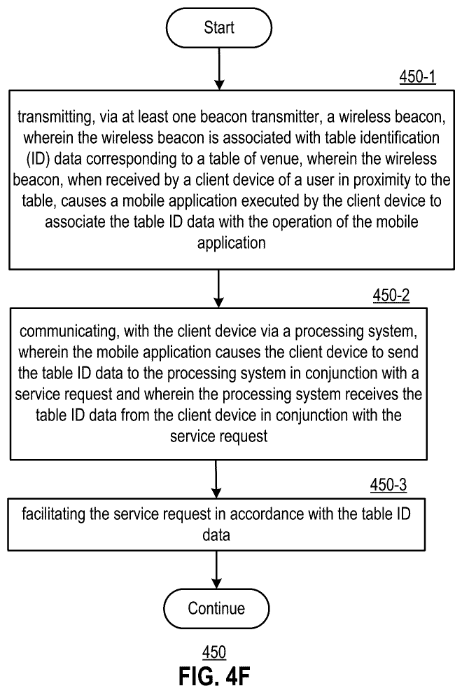

FIG. 4A presents a pictorial/block diagram representation of an example system. Similar elements presented in conjunction with FIG. 1A are referred to by common reference numerals. This system can be used in addition or in the alternative to any of the foregoing examples, including the examples provided in conjunction with FIGS. 1A-1L, 2A-2J, and 3A-3F.

In this example, a plurality of B/Ts 102 are located at a various tables of the venue. Each B/T 102 sends a beacon that includes a message to a client device 300 of the guest (such as a smartphone or other mobile communication device) to download an application (app) associated with the venue and/or to open the mobile app (if it has previously been downloaded). In the alternative, these steps could have been already performed as discussed in conjunction with FIGS. 3A-3F.

The beacon from each B/T 102 is associated with a table ID corresponding to a particular table. The mobile app, once opened, determines, based on signal strength (RSSI) and/or time of flight calculations, the distance to these B/Ts 102 and selects the particular one of the B/Ts 102 that is closest (i.e., shortest distance) to the client device 300 and receives a unique identifier associated with that particular beacon. In particular, the mobile app further causes the client device 300 to communicate (directly or indirectly) with the processing system 100 and, for example, can determine and/or otherwise retrieve the table ID from the database of the processing system 100 based on the unique identifier. The processing system 100 includes a service application that can facilitate various services via the client device 300 such as placing orders associated with the particular table associated with that unique identifier (and table ID) and receiving delivery of the orders at the particular table.

While described above as merely a smartphone or other communication device, the client device 300 can be one of a plurality of restaurant-supplied tablets or other mobile communication devices configured to execute the mobile app and to facilitate any of the services described in conjunction thereto. Because these devices are mobile, they can be shifted from table to table as needed and can thereafter be associated with a particular table where they are located using the techniques herein described.

Consider the following example of operation. At least one beacon transmitter 102 is configured to transmit a wireless beacon, wherein the wireless beacon is associated with table identification (ID) data corresponding to a table of venue, wherein the wireless beacon, when received by a client device of a user in proximity to the table, causes a mobile application executed by the client device to associate the table ID data with the operation of the mobile application.

The processing system 100 includes a memory that stores operational instructions corresponding to a service application and a processing circuit configured to execute the operational instructions, wherein the operational instructions cause the processing circuit to:
communicate with the client device, wherein the mobile application causes the client device to send the table ID data to the processing system in conjunction with a service request and wherein the processing system receives the table ID data from the client device in conjunction with the service request; and
facilitate the service request in accordance with the table ID data.

In addition or in the alternative to any of the foregoing, the service request includes a food order and facilitating the service request includes delivery of the food order to the table of the venue corresponding to the table ID data. It should also be noted that, in addition or in the alternative, the service request could include payment, a request for non-food items such as merchandise, a service call request such as need straws, need silverware, need napkins, need a spill cleaned up, and/or requests for other services.

In addition or in the alternative to any of the foregoing, at least one other beacon transmitter is configured to transmit a second wireless beacon, wherein the second wireless beacon is associated with venue identification (ID) data corresponding to a venue, wherein the second wireless beacon, when received by the client device in proximity to the venue, causes the client device, based on the venue ID data, to prompt the user to open the mobile application.

FIGS. 4B-4E present pictorial diagram representations of example screen displays. In FIG. 4B, a screen display 410-1 of a client device 300. The client device 300, has received a beacon from B/Ts 102 at various tables, and while running the mobile app, has determined that a B/T 102 from table 1 is the closest, and has associated table 1 to this particular client device.

In FIG. 4C, a screen display 410-2 of a client device 300 has prompted the user to open a menu app to place an order to be directed to the table. In FIG. 4D, a screen display of a display device 106 located in the kitchen, indicates a new order has been submitted and, for example, displays information on the order and the particular person/party/table it originated from.

It should be noted that, in certain circumstances, guests may opt to change tables. If a client device 300 has already been associated with a table before the change, the change of table can be detected by the client device 300 running the mobile app based on the determination that the B/T 102 from the prior table is now at a greater distance than a B/T 102 at the new table. In FIG. 4E, a screen display 410-3 of a client device 300 has prompted the user to confirm whether or not they have changed tables
and if so, the mobile application can proceed to reassociate the client device 300 associated with the guest to the table ID corresponding to the new table.

FIG. 4F presents a flowchart representation 450 of an example method. In particular, a method is presented for use in conjunction with one or more functions and features, including those described in conjunction with FIGS. 1A-1L and 4A-4E.

Step 450-1 includes transmitting, via at least one beacon transmitter, a wireless beacon, wherein the wireless beacon is associated with table identification (ID) data corresponding to a table of venue, wherein the wireless beacon, when received by a client device of a user in proximity to the table, causes a mobile application executed by the client device to associate the table ID data with the operation of the mobile application. Step 450-2 includes communicating, with the client device via a processing system, wherein the mobile application causes the client device to send the table ID data to the processing system in conjunction with a service request and wherein the processing system receives the table ID data from the client device in conjunction with the service request. Step 450-3 includes facilitating the service request in accordance with the table ID data.

It should be noted that the method described above can be subjected to any or all of the particular combinations of optional features attributed to the system of FIG. 4A as discussed in conjunction with FIGS. 4B-4E above.

In addition or in the alternative to any of the foregoing, the service request includes a food order and facilitating the service request includes delivery of the food order to the table of the venue corresponding to the table ID data.

In addition or in the alternative to any of the foregoing, at least one other beacon transmitter is configured to transmit a second wireless beacon, wherein the second wireless beacon is associated with venue identification (ID) data corresponding to a venue, wherein the second wireless beacon, when received by the client device in proximity to the venue, causes the client device, based on the venue ID data, to prompt the user to open the mobile application.

FIG. 5A presents a pictorial/block diagram representation of an example system. Similar elements presented in conjunction with FIG. 1A are referred to by common reference numerals. This system can be used in addition or in the alternative to any of the foregoing examples, including the examples provided in conjunction with FIGS. 1A-1L, 2A-2J, 3A-3F and 4A-4F.

In this example, a plurality of B/Ts 102 are located at particular table positions at a table of the venue. Each B/T 102 sends a beacon that includes a message to a client device 300 of the guest (such as a smartphone or other mobile communication device) to download an application (app) associated with the venue and/or to open the mobile app (if it has previously been downloaded. In the alternative, these steps could have been already performed as discussed in conjunction with FIGS. 3A-3F.

The beacon from each B/T 102 is associated with table position ID data corresponding to a position, such as a seating position, at a particular table. The mobile app, once opened, determines, based on signal strength (RSSI) and/or time of flight calculations the distance to these B/Ts 102 and selects the particular one of the B/Ts 102 that is closest (i.e., shortest distance) to the client device 300 and receives the unique identifier associated with that particular beacon. The mobile app further causes the client device 300 to communicate with the processing system 100 and further, for example, can determine and/or otherwise retrieve the table position ID data from the database of the processing system 100 based on the unique identifier of the beacon of the closest B/T 102. The processing system 100 includes a service application that can facilitate various services via the client device 300 such as placing orders associated with the particular table and table position ID data, and receiving delivery of the orders at the particular table for the particular position.

Consider the following example of operation. At least one beacon transmitter 102 is configured to transmit a wireless beacon, wherein the wireless beacon is associated with table position identification (ID) data corresponding to a position at a table of the venue, wherein the wireless beacon, when received by a client device of a user in proximity to the table position, causes a mobile application executed by the client device to associate the table position ID data with the operation of the mobile application.

The processing system 100 includes a memory that stores operational instructions corresponding to a service application and a processing circuit configured to execute the operational instructions, wherein the operational instructions cause the processing circuit to:
communicate with the client device, wherein the mobile application causes the client device to send the table position ID data to the processing system in conjunction with a service request and wherein the processing system receives the table position ID data from the client device in conjunction with the service request, and
facilitate the service request in accordance with the table position ID data.

In addition or in the alternative to any of the foregoing, the service request includes a food order and facilitating the service request includes delivery of the food order to the table of the venue and table position corresponding to the table position ID data. As previously discussed and in addition or in the alternative, the service request could include payment, a request for non-food items such as merchandise, a service call request such as need straws, need silverware, need napkins, need a spill cleaned up, and/or requests for other services.

In addition or in the alternative to any of the foregoing, at least one other beacon transmitter is configured to transmit a second wireless beacon, wherein the second wireless beacon is associated with venue identification (ID) data corresponding to a venue, wherein the second wireless beacon, when received by the client device in proximity to the venue, causes the client device, based on the venue ID data, to prompt the user to open the mobile application.

FIGS. 5B-5E present pictorial diagram representations of example screen displays. In FIG. 5B, a screen display 510-1 of a client device 300. The client device 300, has received a beacon from B/Ts 102 at various table positions, and while running the mobile app, has determined that a B/T 102 in position C of table 1 is the closest, and has associated table position 1C to this particular client device.

In FIG. 5C, a screen display 510-2 of a client device 300 has prompted the user to open a menu app to place an order to be directed to the particular table position. In FIG. 5D, a screen display of a display device 106 located in the kitchen, indicates a new order has been submitted from table position 1C and, for example, displays information on the order and the particular person/party it originated from.

It should be noted that, in certain circumstances, guests may opt to change table positions. If a client device 300 has already been associated with a table position before the change, the change of table position can be detected by the client device 300 running the mobile app based on the determination that the B/T 102 from the prior table position is now at a greater distance than a B/T 102 at the new table position. In FIG. 5E, a screen display 510-3 of a client device 300 has prompted the user confirm whether or not they have changed table positions—and if so, the mobile application can proceed to reassociate the client device 300 associated with the guest to the table position ID corresponding to the new table position.

FIG. 5F presents a flowchart representation 550 of an example method. In particular, a method is presented for use in conjunction with one or more functions and features, including those described in conjunction with FIGS. 1A-1L and 5A-5E.

Step 550-1 includes transmitting, via at least one beacon transmitter, a wireless beacon, wherein the wireless beacon is associated with table position identification (ID) data corresponding to one of a plurality of positions at a table of venue, wherein the wireless beacon, when received by a client device of a user in proximity to the table, causes a mobile application executed by the client device associate the table position ID data with the operation of the mobile application. Step 550-2 includes communicating, with the client device via a processing system, wherein the mobile application causes the client device to send the table position ID data to the processing system in conjunction with a service request and wherein the processing system receives the table position ID data from the client device in conjunction with the service request. Step 550-3 includes facilitating the service request in accordance with the table position ID data.

It should be noted that the method described above can be subjected to any or all of the particular combinations of optional features attributed to the system of FIG. 5A as discussed in conjunction with FIGS. 5B-5E above.

In addition or in the alternative to any of the foregoing, the service request includes a food order and facilitating the service request includes delivery of the food order to the table of the venue and table position corresponding to the table position ID data.

In addition or in the alternative to any of the foregoing, at least one other beacon transmitter is configured to transmit a second wireless beacon, wherein the second wireless beacon is associated with venue identification (ID) data corresponding to a venue, wherein the second wireless beacon, when received by the client device in proximity to the venue, causes the client device, based on the venue ID data, to prompt the user to open the mobile application.

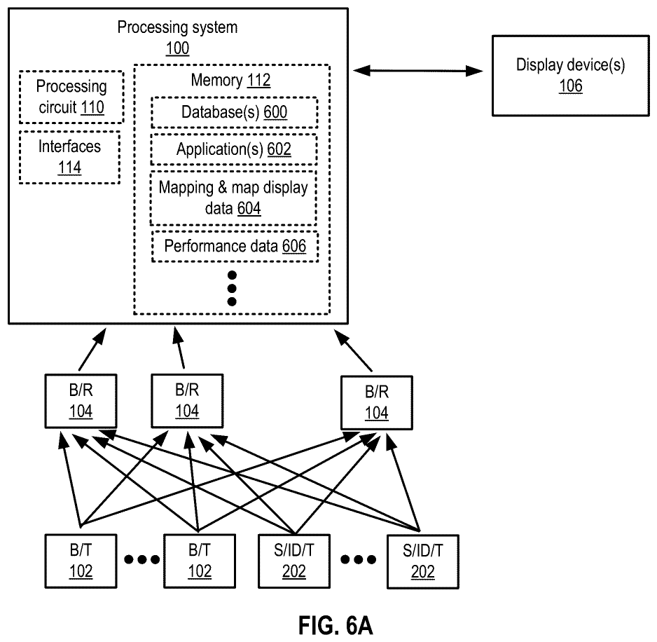

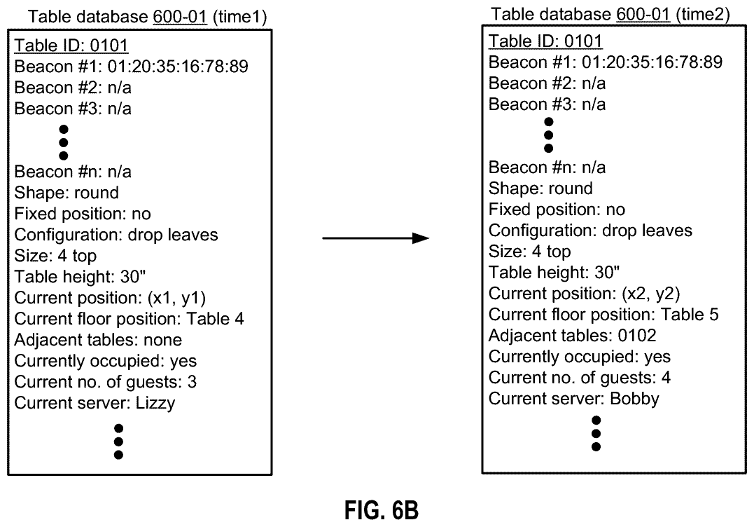

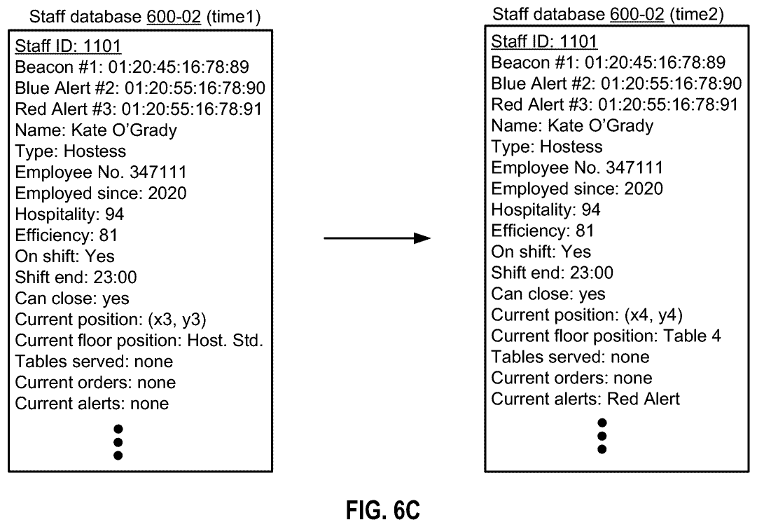

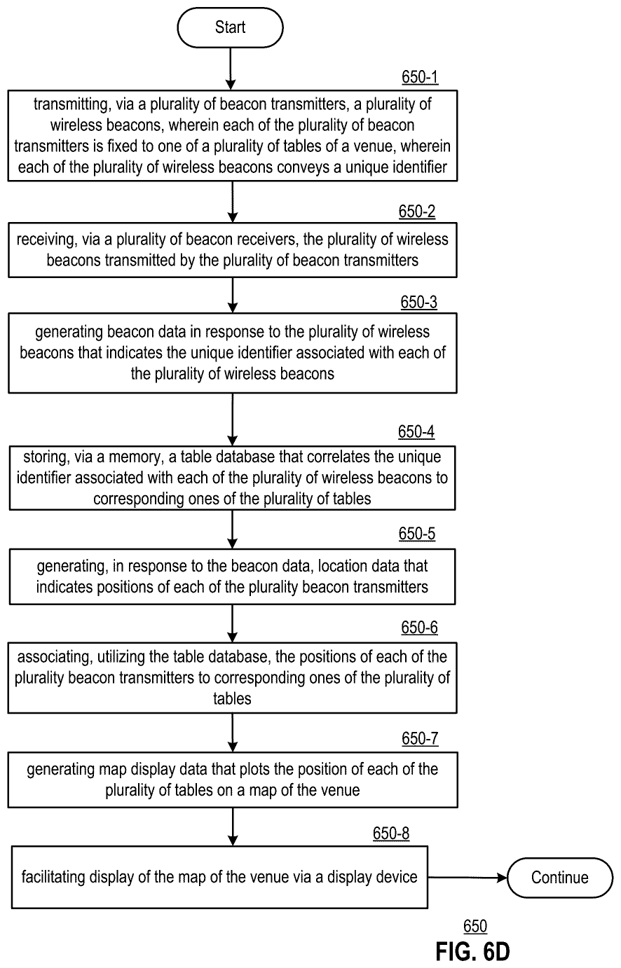

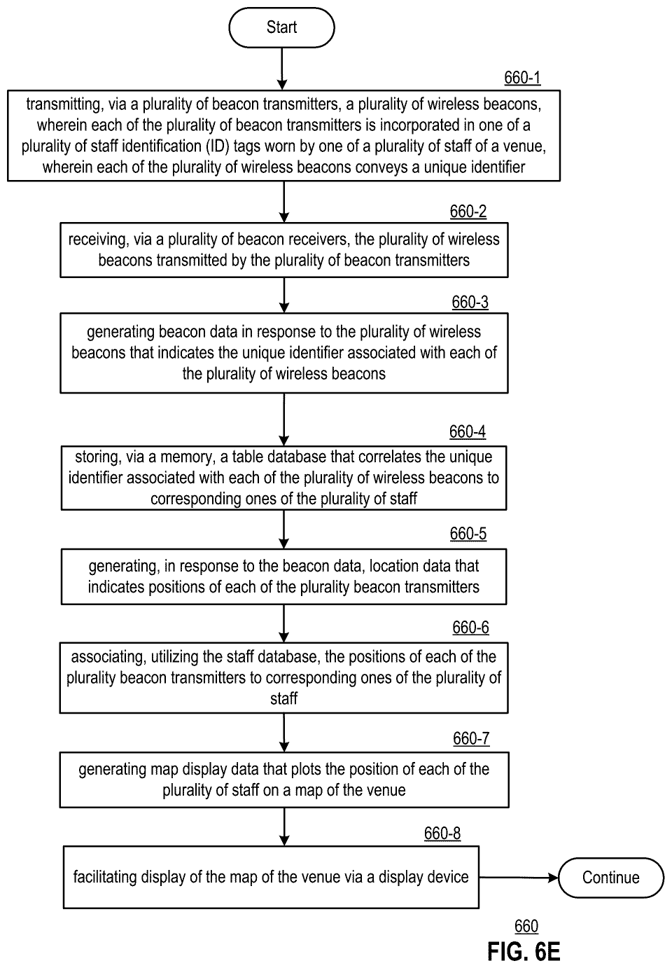

FIG. 6A presents a pictorial/block diagram representation of an example system. In particular, an example system is shown that includes processing system 100. Similar elements described in conjunction with FIG. 1B and/or 2B are referred to by common reference numerals. As previously described, the processing system 100 includes one or more databases (such as database(s) 600), one or more applications (such as one or more application(s) 602), mapping and map display data 604, performance data 606 and/or other data that is stored in memory 112.

Examples of a database 600 include a table database that associates (e.g., that maps) unique identifiers transmitted by the B/Ts 102 associated with tables with a corresponding table ID. During set-up of tables in a venue, the unique identifiers associated with B/T 102 are associated with the particular table they are affixed, the corresponding table ID, along with information regarding the table, such as the number of seats, the size, shape, dimensions (e.g., including height, and table top dimensions), composition, reconfigurability, whether or not it is movable, etc. Once a unique identifier is received for a particular beacon affixed to a table, this unique identifier can be located in the database, associated with a particular table ID, and used to access any or all of the information regarding the table and furthermore, to update the position of the table based on the determined position of the corresponding B/T 102. Furthermore, Major/Minor fields in the beacon can identify the “type” of beacon (table, table/seating position, alert, staff, etc.) in order to find the beacon in the database more quickly.

Examples of a database 600 include a staff database that associates (e.g., that maps) unique identifiers transmitted by the B/Ts 102 associated with staff ID tags with a corresponding staffID. During set-up of staff ID tags in a venue, the unique identifiers associated with B/T 102 (both for positioning and for various alerts) are associated with the staff ID tags they are affixed, the corresponding staff ID, along with information regarding the staff member, such as name, position, employee number, shift information, staff metrics, performance information, etc. Once a unique identifier is received for a particular beacon of a staff ID tag, this unique identifier can be located in the database, associated with a particular staff ID, and used to access any or all of the information regarding the staff member and furthermore, to update the position of the staff member based on the determined position of the corresponding B/T 102 of the staff ID tag.

Examples of the applications 602 include a TPS application that facilitates table positioning, an SPS application that facilitates staff positioning, a hostess application that facilitates the jobs performed by a hostess, a menu application that facilitates order selections, a service application that facilitates the acceptance and fulfillment of service requests, and/or one or more other applications associated with the operation of the intelligent venue. The mapping and map display data 604 include the mapping data and map display data as previously described. The performance data 606 can include the staff performance data as previously described.

Consider the following examples where a system includes a plurality of beacon transmitters, such as B/Ts 102, wherein each of the plurality of beacon transmitters is fixed to one of a plurality of tables of a venue, wherein each of the plurality of beacon transmitters is configured to transmit one of a plurality of wireless beacons, and wherein each of the plurality of wireless beacons conveys a unique identifier. A plurality of beacon receivers, such as B/Rs 104 are configured to receive the plurality of wireless beacons transmitted by the plurality of beacon transmitters and to generate beacon data in response thereto that indicates the unique identifier associated with each of the plurality of wireless beacons. A processing system, such as processing system 100, includes a memory 112 that stores operational instructions corresponding to a table position system (TPS) application and a processing circuit 110 configured to execute the operational instructions, wherein the operational instructions cause the processing circuit to:
store, via the memory, a table database that correlates the unique identifier associated with each of the plurality of wireless beacons to corresponding ones of the plurality of tables;
generate, in response to the beacon data, location data that indicates positions of each of the plurality beacon transmitters;
associate, utilizing the table database, the positions of each of the plurality beacon transmitters to corresponding ones of ones of the plurality of tables;
generate map display data that plots the position of each of the plurality of tables on a map of the venue; and
facilitate display of the map of the venue via a display device.

In addition or in the alternative to any of the foregoing, the operational instructions further cause the processing circuit to: update the table database to indicate the position, (e.g., a current position) of each of the plurality of tables.

In addition or in the alternative to any of the foregoing, the beacon data generated by the each of the plurality of beacon receivers includes, for corresponding ones of the plurality wireless beacons, at least one of: a received signal strength, a signal phase, a signal magnitude, a time of flight, a distance or an angle of arrival.

In addition or in the alternative to any of the foregoing, the table database indicates whether or not each of the plurality of tables is in a fixed position.

In addition or in the alternative to any of the foregoing, the operational instructions further cause the processing circuit to: generate, in response to the beacon data, orientation data that indicates an orientation of each of the plurality of tables; wherein the map display data is further generated to plot the orientation of each of the plurality of tables on the map of the venue.

In addition or in the alternative to any of the foregoing, the operational instructions further cause the processing circuit to: update the table database to indicate the orientation of each of the plurality of tables.

In addition or in the alternative to any of the foregoing, the operational instructions further cause the processing circuit to: determine, in response to the beacon data, when two or more of the plurality of tables have been placed together; wherein the map display data is further generated to indicate that two or more of the plurality of tables have been placed together.

In addition or in the alternative to any of the foregoing, the operational instructions further cause the processing circuit to: update the table database to indicate that two or more of the plurality of tables have been placed together.

In addition or in the alternative to any of the foregoing, the operational instructions further cause the processing circuit to: associate the positions of corresponding ones of ones of the plurality of tables to corresponding floor position numbers; and generate map display data to further indicate the corresponding floor position numbers of each of the plurality of tables on the map of the venue.

In addition or in the alternative to any of the foregoing, the operational instructions further cause the processing circuit to: update the table database to indicate the corresponding floor position numbers of each of the plurality of tables.

Consider the following examples where a system includes a plurality of beacon transmitters, such as B/Ts 102, wherein each of the plurality of beacon transmitters is incorporated in one of a plurality of staff identification (ID) tags worn by one of a plurality of staff of a venue, wherein each of the plurality of beacon transmitters is configured to transmit one of a plurality of wireless beacons, and wherein each of the plurality of wireless beacons conveys a unique identifier. A plurality of beacon receivers, such as B/R 104 are configured to receive the plurality of wireless beacons transmitted by the plurality of beacon transmitters and to generate beacon data in response thereto that indicates the unique identifier associated with each of the plurality of wireless beacons. A processing system, such as processing system 100, includes a memory 112 that stores operational instructions corresponding to a staff position system (TPS) application and a processing circuit 110 configured to execute the operational instructions, wherein the operational instructions cause the processing circuit to:
store, via the memory, a staff database that correlates the unique identifier associated with each of the plurality of wireless beacons to corresponding ones of the plurality of staff;
generate, in response to the beacon data, location data that indicates positions of each of the plurality beacon transmitters;
associate, utilizing the staff database, the positions of each of the plurality beacon transmitters to corresponding ones of ones of the plurality of staff;
generate map display data that plots the positions of each of the plurality of staff on a map of the venue; and
facilitate display of the map of the venue via a display device.

In addition or in the alternative to any of the foregoing, the operational instructions further cause the processing circuit to: analyze the positions of each of the plurality of staff over time and generate performance data corresponding to each of the plurality of staff.

In addition or in the alternative to any of the foregoing, the operational instructions further cause the processing circuit to: update the staff database to indicate the performance data corresponding to each of the plurality of staff.

In addition or in the alternative to any of the foregoing, each of the plurality of staff identification (ID) tags includes a user interface that permits the user to generate a selected one of a plurality of alerts, wherein each of the plurality of beacon transmitters is configured to transmit another one of a plurality of wireless beacons that conveys another unique identifier corresponding to the selected one of the plurality of alerts and wherein the operational instructions further cause the processing circuit to: correlate, via the staff database, the another unique identifier to the selected one of the plurality of alerts and the corresponding one of the plurality of staff; generate display data that indicates the selected one of the plurality of alerts; and facilitate display of the display data via the display device.

In addition or in the alternative to any of the foregoing, the operational instructions further cause the processing circuit to: correlate, via the staff database, the another unique identifier to the corresponding one of the plurality of staff; wherein the display data is generated to further indicate the corresponding one of the plurality of staff in association with the selected one of the plurality of alerts.

FIG. 6B presents a process/flow diagram representation of an example database. In particular a portion of table database 600-1 is presented as an example of database(s) 600 and at two different times designated as time1 and time2. The portion corresponds to data associated with a single table having table ID 0101. In the example shown, the table has been set up with a single B/T 102 having a wireless beacon with a unique identifier (01:20:35:16:78:89). In the example shown, the third pair of numbers “35” designate this as a table beacon, as opposed to a staff beacon, alert beacon or other beacon type.

Consider the following example corresponding to time1. The processing system 100 generates, in response to the beacon data generated by the B/Rs 104 from the B/T 101 corresponding to table 0101 that indicates the unique identifier (01:20:35:16:78:89), location data that indicates a position (x1, y1) of the beacon transmitter for this table. The processing system then associates, utilizing the table database 600-1 and based on the unique identifier (01:20:35:16:78:89), the position (x1, y1) to the table 0101. Because the position (x1, y1) is closest to the desired position of “table 4” in the venue, the processing system stores the current floor position (e.g., a floor position number) for the table 0101 as “table 4”. This allows the processing system to generate map display data that plots the position of the table 0101 on a map of the venue for display by a display device 106 and further to label this table as table 4 on the map.

In the example corresponding to time2, the system has determined that the position of table 0101 has been relocated to position (x2, y2), a position adjacent to table 0102 (indicating these two tables have been put together) and the table database 600-1 has been updated. Because the position (x2, y2) is closest to the desired position of “table 5” in the venue, the processing system stores the current floor position for the table 0101 as “table 5”. This allows the processing system to generate map display data that plots the position of the table 0101 on a map of the venue for display by a display device 106 and further to label this table as table 5 on the map.

FIG. 6C presents a process/flow diagram representation of an example database. In particular a portion of staff database 600-2 is presented as an example of database(s) 600 and at two different times designated as time1 and time2. The portion corresponds to data associated with a staff member, Kate O'Grady having staff ID 1101. In the example shown, the staff ID tag emits a wireless beacon with a unique identifier (01:20:45:16:78:89). In the example shown, the third pair of numbers “45” designate this as a staff position beacon, as opposed to other beacon type. Furthermore, the staff ID tag can emit a blue alert beacon with a unique identifier (01:20:55:16:78:90) and a red alert beacon with a unique identifier (01:20:55:16:78:91). In the examples shown, the third pair of numbers “55” designate these as alert beacons, as opposed to other beacon types.

Consider the following example corresponding to time1. The processing system 100 generates, in response to the beacon data generated by the B/Rs 104 from the B/T 101 corresponding to staff ID tag for staff member 1101 that indicates the unique identifier (01:20:45:16:78:89), location data that indicates a position (x3, y3) of the beacon transmitter for this staff member. The processing system then associates, utilizing the table database 600-2 and based on the unique identifier (01:20:45:16:78:89), the position (x3, y3) to the staff member 1101. Because the position (x3, y3) is closest to the hostess stand in the venue, the processing system stores the current floor position for the staff member 1101 as being at the “host. std.”. This allows the processing system to generate map display data that plots the position of the staff member 1101 on a map of the venue for display by a display device 106.

In the example corresponding to time2, the system has determined that the position of staff member 1101 has been relocated to a position (x4, y4), a position adjacent to table 4 and the staff database 600-2 has been updated. Furthermore, a beacon having unique identifier (01:20:55:16:78:91) indicating that the staff member has pressed her red alert button. The staff database 600-2 has been updated to indicate this red alert condition as well and the processing system can indicate this alert when generating the map display data for display on display device 106.

FIG. 6D presents a flowchart representation of an example method. In particular, a method 650 is presented for use in conjunction with any or all of the functions and features previously described, including those described in conjunction with FIGS. 1A-1L, 2A-2J and 6A-6C.

Step 650-1 includes transmitting, via a plurality of beacon transmitters, a plurality of wireless beacons, wherein each of the plurality of beacon transmitters is fixed to one of a plurality of tables of a venue, wherein each of the plurality of wireless beacons conveys a unique identifier. Step 650-2 includes receiving, via a plurality of beacon receivers, the plurality of wireless beacons transmitted by the plurality of beacon transmitters. Step 650-3 includes generating beacon data in response to the plurality of wireless beacons that indicates the unique identifier associated with each of the plurality of wireless beacons. Step 650-4 includes storing, via a memory, a table database that correlates the unique identifier associated with each of the plurality of wireless beacons to corresponding ones of the plurality of tables.

Step 650-5 includes generating, in response to the beacon data, location data that indicates positions of each of the plurality beacon transmitters. Step 650-6 includes associating, utilizing the table database, the positions of each of the plurality beacon transmitters to corresponding ones of the plurality of tables. Step 650-7 includes generating map display data that plots the position of each of the plurality of tables on a map of the venue. Step 650-6 includes facilitating display of the map of the venue via a display device.

In addition or in the alternative to any of the foregoing, the method further includes: updating the table database to indicate the position of each of the plurality of tables.

In addition or in the alternative to any of the foregoing, the beacon data generated by the each of the plurality of beacon receivers includes, for corresponding ones of the plurality wireless beacons, at least one of: a received signal strength, a signal phase, a signal magnitude, a time of flight, a distance and an angle of arrival.

In addition or in the alternative to any of the foregoing, the table database indicates whether or not each of the plurality of tables is in a fixed position.

In addition or in the alternative to any of the foregoing, the method further includes: generating, in response to the beacon data, orientation data that indicates an orientation of each of the plurality of tables; wherein the map display data is further generated to plot the orientation of each of the plurality of tables on the map of the venue.

In addition or in the alternative to any of the foregoing, the method further includes: updating the table database to indicate the orientation of each of the plurality of tables.

In addition or in the alternative to any of the foregoing, the method further includes: determining, in response to the beacon data, when two or more of the plurality of tables have been placed together; wherein the map display data is further generated to indicate that two or more of the plurality of tables have been placed together.

In addition or in the alternative to any of the foregoing, the method further includes: updating the table database to indicate that two or more of the plurality of tables have been placed together.

In addition or in the alternative to any of the foregoing, the method further includes: associating the positions of corresponding ones of ones of the plurality of tables to corresponding floor position numbers; and generating map display data to further indicate the corresponding floor position numbers of each of the plurality of tables on the map of the venue.

In addition or in the alternative to any of the foregoing, the method further includes: updating the table database to indicate the corresponding floor position numbers of each of the plurality of tables.

FIG. 6E presents a flowchart representation of an example method. In particular, a method 660 is presented for use in conjunction with any or all of the foregoing functions and features previously described, including those described in conjunction with FIGS. 1A-1L, 2A-2J and 6A-6D.

Step 660-1 includes transmitting, via a plurality of beacon transmitters, a plurality of wireless beacons, wherein each of the plurality of beacon transmitters is incorporated in one of a plurality of staff identification (ID) tags worn by one of a plurality of staff of a venue, wherein each of the plurality of wireless beacons conveys a unique identifier. Step 660-2 includes receiving, via a plurality of beacon receivers, the plurality of wireless beacons transmitted by the plurality of beacon transmitters. Step 660-3 includes generating beacon data in response to the plurality of wireless beacons that indicates the unique identifier associated with each of the plurality of wireless beacons. Step 660-4 includes storing, via a memory, a staff database that correlates the unique identifier associated with each of the plurality of wireless beacons to corresponding ones of the plurality of staff.

Step 660-5 includes generating, in response to the beacon data, location data that indicates positions of each of the plurality beacon transmitters. Step 660-6 includes associating, utilizing the staff database, the positions of each of the plurality beacon transmitters to corresponding ones of the plurality of tables. Step 660-7 includes generating map display data that plots the position of each of the plurality of staff on a map of the venue. Step 660-8 includes facilitating display of the map of the venue via a display device.

In addition or in the alternative to any of the foregoing, the further includes: analyzing the positions of each of the plurality of staff over time and generating performance data corresponding to each of the plurality of staff.

In addition or in the alternative to any of the foregoing, the further includes: updating the staff database to indicate the performance data corresponding to each of the plurality of staff.

In addition or in the alternative to any of the foregoing, each of the plurality of staff identification (ID) tags includes a user interface that permits the user to generate a selected one of a plurality of alerts, wherein each of the plurality of beacon transmitters is configured to transmit another one of a plurality of wireless beacons that conveys another unique identifier corresponding to the selected one of the plurality of alerts and wherein the operational instructions further cause the processing circuit to: correlate, via the staff database, the another unique identifier to the selected one of the plurality of alerts and the corresponding one of the plurality of staff; generate display data that indicates the selected one of the plurality of alerts; and facilitate display of the display data via the display device.

In addition or in the alternative to any of the foregoing, the further includes: correlating, via the staff database, the another unique identifier to the corresponding one of the plurality of staff; wherein the display data is generated to further indicate the corresponding one of the plurality of staff in association with the selected one of the plurality of alerts.

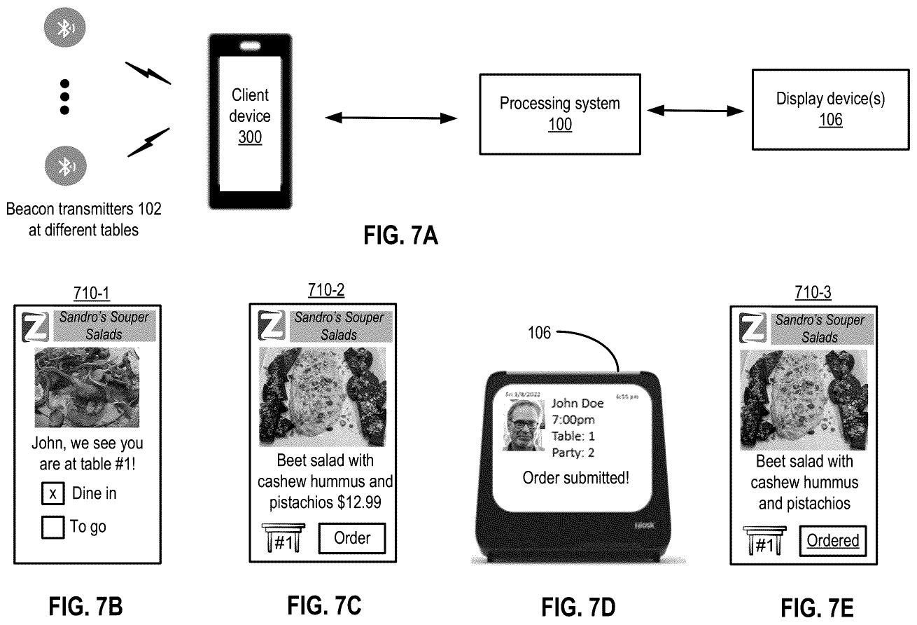

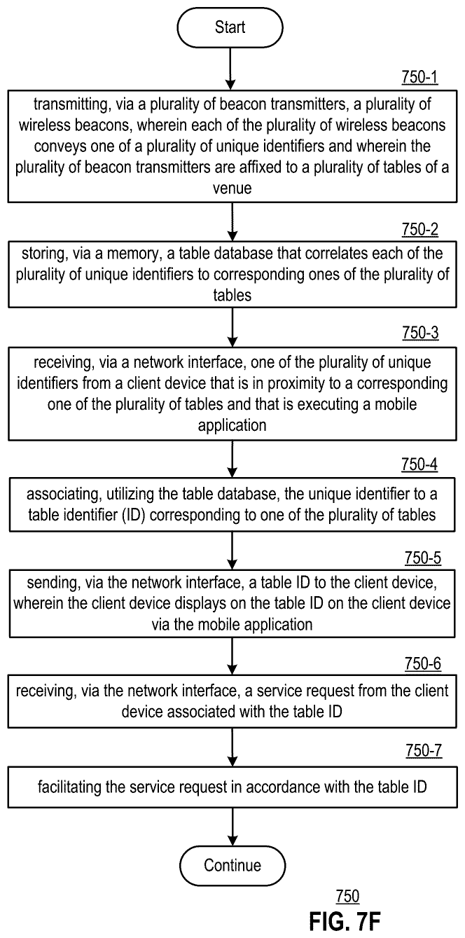

FIG. 7A presents a pictorial/block diagram representation of an example system. Similar elements presented in conjunction with FIG. 1A are referred to by common reference numerals. This system can be used in addition or in the alternative to any of the foregoing examples, including the examples provided in conjunction with FIGS. 1A-1L, 2A-2J, 3A-3F, 4A-4F, 5A-5F, 6A-6E.

The beacon from each B/T 102 includes a unique identifier that is associated with a table ID corresponding to a particular table. The mobile app, once opened, determines, based on signal strength (RSSI), angle of arrival and/or time of flight calculations, the distance to these B/Ts 102 and selects the particular one of the B/Ts 102 that is closest (i.e., shortest distance) to the client device 300 and receives a unique identifier associated with that particular beacon. In particular, the mobile app further causes the client device 300 to communicate (directly or indirectly) with the processing system 100 which can, for example, determine and/or otherwise retrieve the table ID from the table database of the processing system 100 based on the unique identifier received by the client device 300. The processing system 100 includes a service application that can facilitate various services via the client device 300 such as placing orders associated with the particular table associated with that unique identifier (and table ID) and receiving delivery of the orders at the particular table.

While described above as merely a smartphone or other communication device, the client device 300 can be one of a plurality of restaurant-supplied tablets or other mobile communication devices configured to execute the mobile app and to facilitate any of the services described in conjunction thereto. Because these devices are mobile, they can be shifted from table to table as needed and can thereafter be associated with a particular table where they are located using the techniques herein described.

Consider the following example of operation. A plurality of beacon transmitters, such as B/Ts 102 are configured to transmit a plurality of wireless beacons, wherein each of the plurality of wireless beacons conveys one of a plurality of unique identifiers and wherein the plurality of beacon transmitters are affixed to a plurality of tables of a venue. A processing system, such as processing system 100, includes a memory that stores operational instructions corresponding to a service application and a processing circuit configured to execute the operational instructions, wherein the operational instructions cause the processing circuit to:
store, via the memory, a table database that correlates each of the plurality of unique identifiers to corresponding ones of the plurality of tables;
receive, via a network interface, one of the plurality of unique identifiers from a client device that is in proximity to a corresponding one of the plurality of tables and that is executing a mobile application;
associate, utilizing the table database, the unique identifier to a table identifier (ID) corresponding to one of the plurality of tables;
send, via the network interface, a table ID to the client device, wherein the client device displays on the table ID on the client device via the mobile application;
receive, via the network interface, a service request from the client device associated with the table ID; and
facilitate the service request in accordance with the table ID.

In addition or in alternative to any of the foregoing, the service request includes a food order and facilitating the service request includes delivery of the food order to the table of the venue corresponding to the table ID.

FIGS. 7B-7E present pictorial diagram representations of example screen displays. In FIG. 4B, a screen display 710-1 of a client device 300. The client device 300, has received a beacon from B/Ts 102 at various tables, and while running the mobile app, has determined that a B/T 102 from table 1 is the closest, and has associated table 1 to this particular client device.

In FIG. 7C, a screen display 710-2 of a client device 300 presents a menu app to place an order to be directed to the table #1 as indicated by the table number icon in the lower left. In FIG. 7D, a screen display of a display device 106 located in the kitchen, indicates a new order has been submitted and, for example, displays information on the order and the particular person/party/table it originated from. In FIG. 7E, a screen display 710-3 of a client device 300 has indicated to the user that the order has been placed.

FIG. 7F presents a flowchart representation 750 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E and 7A-7E.

Step 750-1 includes transmitting, via a plurality of beacon transmitters, a plurality of wireless beacons, wherein each of the plurality of wireless beacons conveys one of a plurality of unique identifiers and wherein the plurality of beacon transmitters are affixed to a plurality of tables of a venue. Step 750-2 includes storing, via a memory, a table database that correlates each of the plurality of unique identifiers to corresponding ones of the plurality of tables. Step 750-3 includes receiving, via a network interface, one of the plurality of unique identifiers from a client device that is in proximity to a corresponding one of the plurality of tables and that is executing a mobile application. Step 750-5 includes associating, utilizing the table database, the unique identifier to a table identifier (ID) corresponding to one of the plurality of tables.

Step 750-6 includes sending, via the network interface, a table ID to the client device, wherein the client device displays on the table ID on the client device via the mobile application. Step 750-7 includes receiving, via the network interface, a service request from the client device associated with the table ID. Step 750-8 includes facilitating the service request in accordance with the table ID.

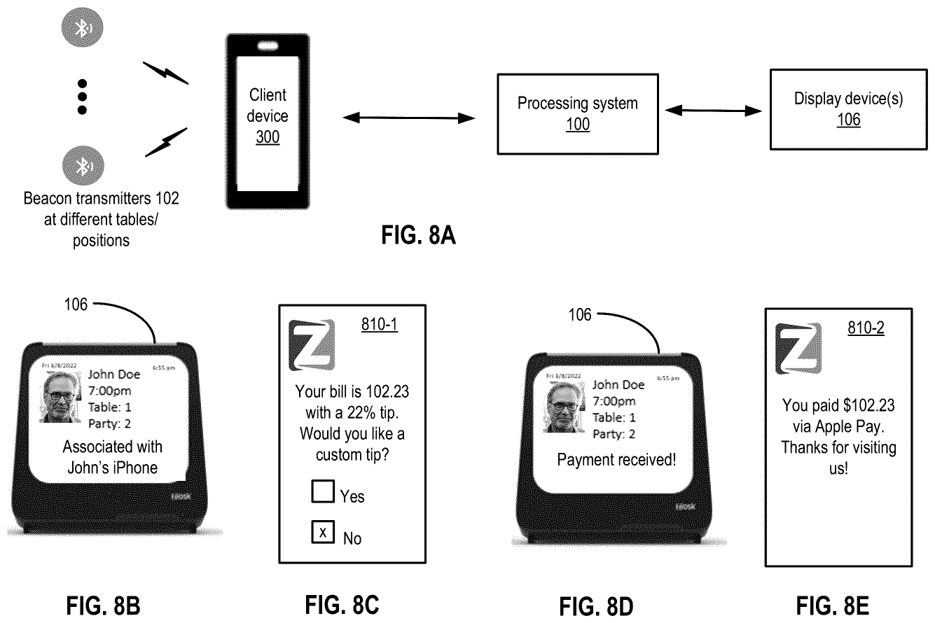

FIG. 8A presents a block diagram representation of an example system. In particular, a system is presented that includes client device 300, processing system 100 and display device 106 and further can be used in addition, or in the alternative to any of the systems previously described. This example focuses on the use of a client device 300 for payment at a service location associated with avenue. When it is time to pay, the user's client device 300 can be set on the table, present in an item such as a physical wallet purse or handbag on, at or near the table or other service location, present in a pocket of the user near the table or other service location and/or otherwise in proximity with to a service location so as to be associated with the table number (and/or seat position or other location such as a particular pick-up location, a particular parking spot, a particular drive-thru location, a particular gas pump, a cash register or other check-out location, at a check-in location, and/or other location associated with a venue, either inside or out) and the user's bill for an order or other transaction associated with the venue. The processing system 100 and the client device 300 can then process payment in one simple transaction. This example recognizes that ordering and service may or may not use the client devices, but payment can be processed simply and easily by recognizing the table and the device, recognizing it is time to pay, optionally receiving a custom tip amount or using a default tip amount set by the user/or the venue and retrieving the payment info from the client device 300, such as a credit card (e.g., Visa, Mastercard, Amex, etc.) or payment service associated with an app (e.g., Venmo, Zelle, PayPal, Apple Pay, etc.) or with an electronic wallet of the device (e.g., an Apple or Android wallet, etc.). As used herein retrieving payment information from the client device can also include by retrieving a payment token, retrieving from the client device account information of the venue, the platform and/or other system that is sufficient to identify based on additional information regarding a credit card, bank account, credit or crypto balance and/or other payment methodology that can be stored elsewhere, (e.g., other than on the client device).

Consider the following example of operation where at least one beacon transmitter 102 is configured to transmit a wireless beacon associated with a service location of a venue, such as a table number and/or seating position. The processing system 100 includes a memory that stores operational instructions corresponding to an intelligent venue application and a processing circuit configured to execute the operational instructions, wherein the operational instructions cause the processing circuit to:
detect a client device 300 at the service location, wherein the client device is detected in response to an automated reply signal generated by the client device in response to the wireless beacon, this can be performed before placing an order such as when the diner arrives or after and order has been placed (e.g., placed through traditional methods),
establish an association between the client device 300 with an order placed at the service location, wherein once the association is established, the client device emits feedback to the user of the client device indicating the association. As used herein, “feedback” can include, e.g., a buzz, a beep or other sound, haptic feedback and/or a popup, notification or other indication presented via the screen display, that for example, can contain, graphics, text and/or other media. Furthermore, this association can be indicated by the display device 106 as shown in FIG. 8B.
communicate with the client device 300 to facilitate payment of the order (e.g., the bill for the order) placed at the service location based on payment information stored via the client device. This can include the establishment of a custom tip as shown in screen display 810-1 of client device 300 shown in FIG. 8C, indicated by the display device 106 as shown in FIG. 8D and/or screen display 810-2 of client device 300 shown in FIG. 8E.

In addition or in the alternative to any of the foregoing, the payment information is stored via an electronic wallet of the client device.

In addition or in the alternative to any of the foregoing the payment of the order is facilitated automatically without requiring interaction with the user of the client device.

In addition or in the alternative to any of the foregoing, the feedback to the user includes an audible alert.

FIG. 8F presents a flowchart representation 860 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F and 8A-8E.

Step 860-1 includes transmitting a wireless beacon associated with a service location of a venue. Step 860-2 includes detecting a client device at the service location, wherein the client device is detected in response to an automated reply signal generated by the client device in response to the wireless beacon. Step 860-3 includes establishing an association between the client device with an order placed at the service location; wherein once the association is established, the client device emits feedback to the user of the client device indicating the association. Step 860-4 includes communicating with the client device to facilitate payment of the order placed at the service location based on payment information stored via the client device.

In addition or in the alternative to any of the foregoing, the payment information is stored via an electronic wallet of the client device.

In addition or in the alternative to any of the foregoing, the payment of the order is facilitated automatically without requiring interaction with the user of the client device.

In addition or in the alternative to any of the foregoing, the feedback to the user includes an audible alert.

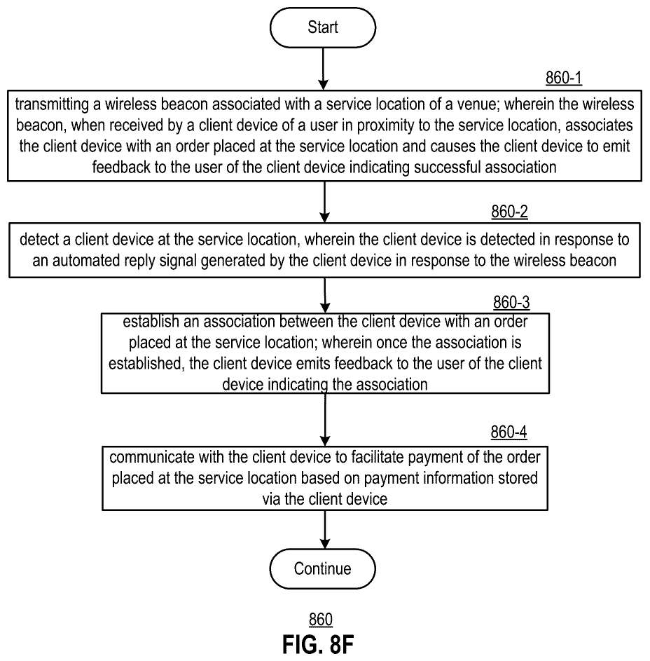

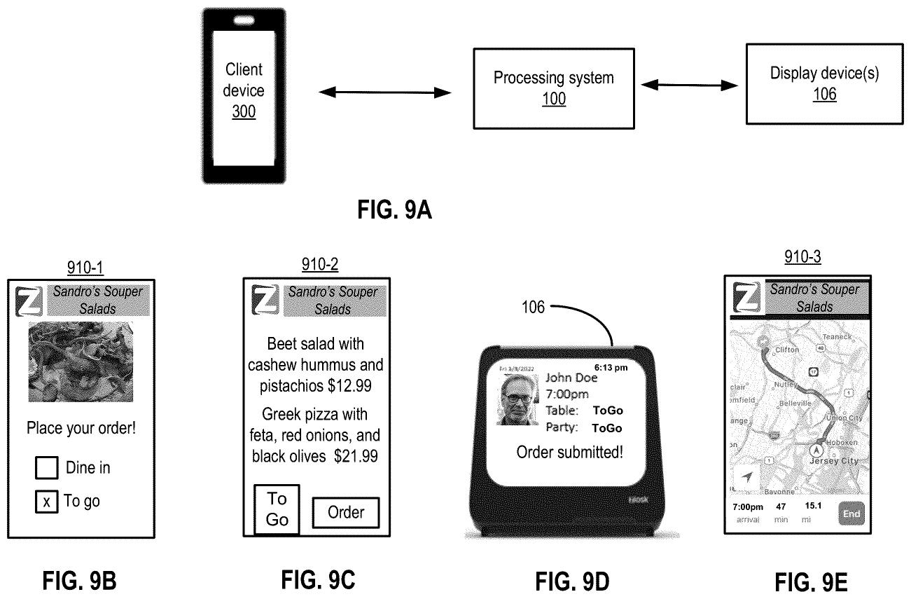

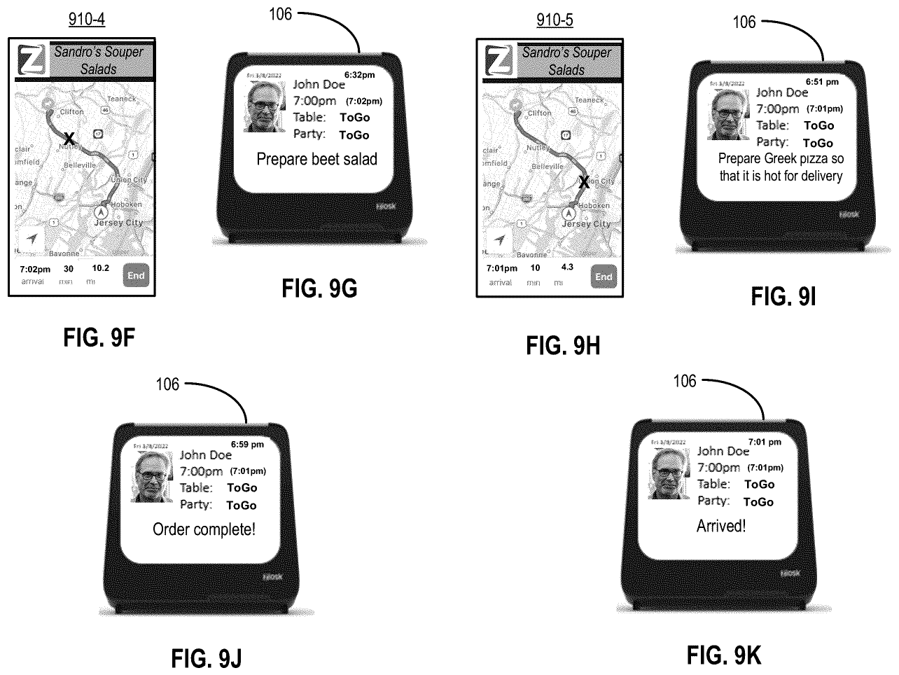

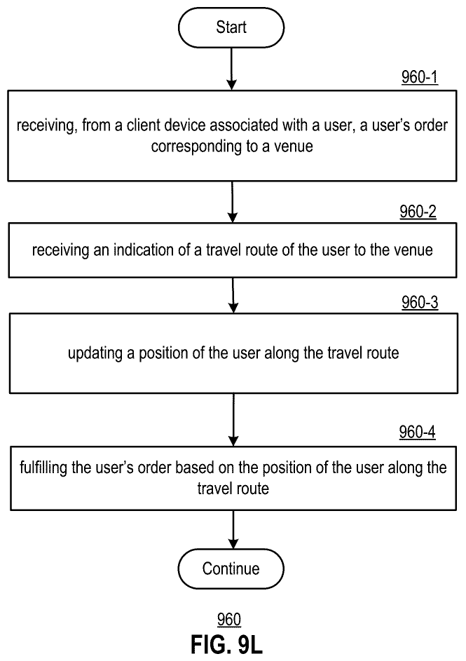

FIG. 9A presents a block diagram representation of an example system. In particular, a system is presented that includes client device 300, processing system 100 and display device 106 and further can be used in addition, or in the alternative to any of the systems previously described. This example recognizes that the location of the user/client device can be collected in different ways and can be used for more than just table/seating position. When the user has placed an order, the system can intelligently process the order based on the current client device location (e.g., established via GPS coordinates generated via a GPS receiver included in the client device 300) and generate a projected arrival time and/or the actual position of the user along a route to the venue (e.g., based on the venue's know location and a map database or application that calculates routes and times) so that the order is ready for just-in-time delivery. Considering the example of a food to-go order or delivery order by delivery service—at the time of pick up, hot food can be hot, frozen food can be frozen, French fries and salads can be crispy instead of limp, etc.

Consider the following example of operation where the processing system 100 includes a memory that stores operational instructions corresponding to an intelligent venue application and a processing circuit configured to execute the operational instructions, wherein the operational instructions cause the processing circuit to:
receive, from a client device 300 associated with a user, a user's order corresponding to a venue generated as shown via screen displays 910-1 and 910-2 of FIGS. 9B and 9C. Receipt of the order can be indicated on display device 106 as shown in FIG. 9D.
receive an indication of a travel route of the user to the venue. This can include a projected arrival time, a starting point and/or starting time of travel, a particular route such as corresponding to a map application, etc. that are also received from the client device 300. An example of such an application of client device 300 is shown via screen display 910-3 of FIG. 9E.
update a position of the user along the travel route. This can include updates to the projected arrival time, route updates and/or positions of the client device 300 (e.g. shown via screen displays 910-4 and 910-5 of 9F and 9H along the route that are also received from the client device 300).
fulfill the user's order based on the position of the user along the travel route.

In addition or in the alternative to any of the foregoing, the system can also determine an estimated time of arrival of the user at the venue based on the position of the user along the travel route and/or fulfilling the user's order is based on the estimated time of arrival of the user at the venue.

In addition or in the alternative to any of the foregoing, fulfilling the user's order is further based on estimated preparation times of a plurality of items included in the user's order.

In addition or in the alternative to any of the foregoing, a plurality of items included in the user's order include a first item with a first preparation time and a second item with a second preparation time that is less than the first preparation time, and wherein fulfilling the user's order includes preparing the first item before the second item. In the example of FIG. 9G, the beet salad is prepared when the user is still 30 minutes out and the Greek pizza is prepared later when the user is only 10 minutes away as shown in FIG. 91 so that it will be completed as shown in FIG. 9J and still be hot on arrival as indicated in FIG. 9K.

In addition or in the alternative to any of the foregoing, fulfilling the user's order includes preparing the first item of the plurality of items with a completion time that coincides with the estimated time of arrival of the user at the venue.

FIG. 9L presents a flowchart representation 960 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F and 9A-9K.

Step 960-1 includes receiving, from a client device associated with a user, a user's order corresponding to a venue. Step 960-2 includes receiving an indication of a travel route of the user to the venue. Step 960-3 includes updating a position of the user along the travel route. Step 960-4 includes fulfilling the user's order based on the position of the user along the travel route.

In addition or in the alternative to any of the foregoing, the method can also determine an estimated time of arrival of the user at the venue based on the position of the user along the travel route, wherein fulfilling the user's order is based on the estimated time of arrival of the user at the venue.

In addition or in the alternative to any of the foregoing, fulfilling the user's order is further based on estimated preparation times of a plurality of items included in the user's order.

In addition or in the alternative to any of the foregoing, a plurality of items included in the user's order include a first item with a first preparation time and a second item with a second preparation time that is less than the first preparation time, and wherein fulfilling the user's order includes preparing the first item before the second item.

In addition or in the alternative to any of the foregoing, fulfilling the user's order includes preparing the first item of the plurality of items with a completion time that coincides with the estimated time of arrival of the user at the venue.

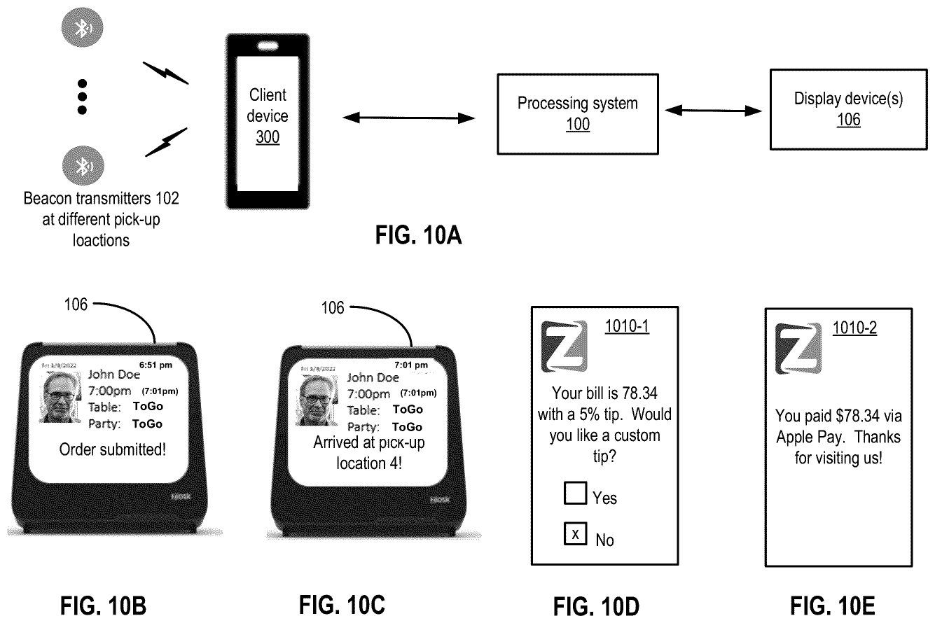

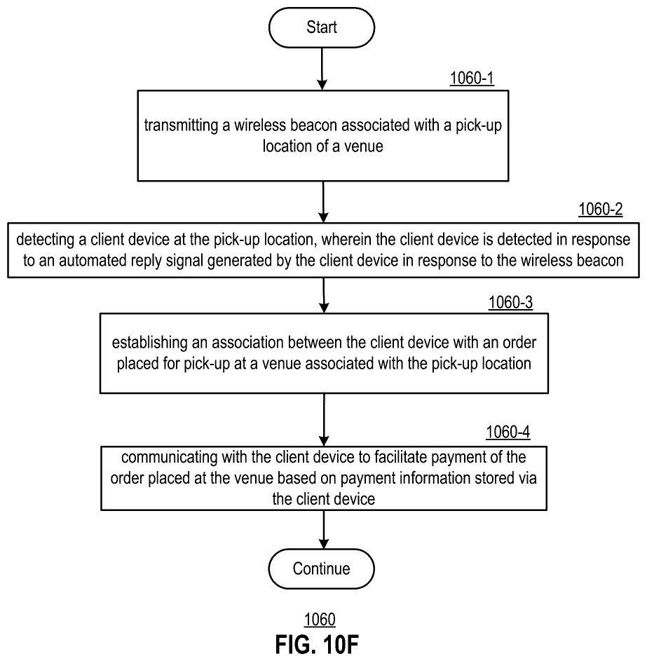

FIG. 10A presents a block diagram representation of an example system. In particular, a system is presented that includes client device 300, processing system 100 and display device 106 and further can be used in addition, or in the alternative to, any of the systems previously described. This example recognizes that beacon transmitters 102 can be placed at pick-up locations outside of a venue (e.g., including a restaurant, store or other retail establishment) such as a drive-thru location or designed pick-up parking spots. Once an order is been received from a user (see e.g., FIG. 10B), detection of the client device 300 at the pick-up location can be used by the system to determine that the client device has arrived at the venue (as previously described) and furthermore can be used by the system to determine which particular pick-up location the user has arrived at (based on, for example, any of the beacon location methodologies previously described). In the example of FIG. 10C, the user has arrived at pick-up location 4, one of several designated pick-up parking spots outside of a venue.

Consider the following example of operation where at least one beacon transmitter 102 is configured to transmit a wireless beacon associated with a pick-up location of a venue, such as a drive thru location, a pick-up parking spot, etc. The processing system 100 includes a memory that stores operational instructions corresponding to an intelligent venue application and a processing circuit configured to execute the operational instructions, wherein the operational instructions cause the processing circuit to:
detect a client device at the pick-up location, wherein the client device is detected in response to an automated reply signal generated by the client device in response to the wireless beacon;
establish an association between the client device with an order placed for pick-up at a venue associated with the pick-up location; and
communicate with the client device to facilitate payment of the order placed at the venue based on payment information stored via the client device as shown, for example in screen displays 1010-1 and 11010-2 of FIGS. 10D and 10E.

In addition or in the alternative to any of the foregoing, the payment information is stored via an electronic wallet of the client device.

In addition or in the alternative to any of the foregoing, the payment of the order is facilitated automatically without requiring interaction with the user of the client device.

In addition or in the alternative to any of the foregoing, once the association is established, the client device emits feedback to the user of the client device indicating the association; and wherein the feedback to the user includes an audible alert.

FIG. 10F presents a flowchart representation 1060 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, and 10A-10E.

Step 1060-1 includes transmitting a wireless beacon associated with a pick-up location of a venue. Step 1060-2 includes detecting a client device at the pick-up location, wherein the client device is detected in response to an automated reply signal generated by the client device in response to the wireless beacon. Step 1060-3 includes establishing an association between the client device with an order placed for pick-up at a venue associated with the pick-up location. Step 1060-4 includes communicating with the client device to facilitate payment of the order placed at the venue based on payment information stored via the client device.

In addition or in the alternative to any of the foregoing, the payment information is stored via an electronic wallet of the client device.

In addition or in the alternative to any of the foregoing, the payment of the order is facilitated automatically without requiring interaction with the user of the client device.

In addition or in the alternative to any of the foregoing, once the association is established, the client device emits feedback to the user of the client device indicating the association; and wherein the feedback to the user includes an audible alert.

FIG. 11A presents a block diagram representation of an example system. In particular, a system is presented that includes client device 300, processing system 100 and display device 106 and further can be used in addition, or in the alternative to any of the systems previously described. This example focuses on the use of a client device 300 for age verification, for example, to validate diner age to qualify for drinks. The driver's license for one or more diners can be validated or otherwise stored to the app and/or scanned to be part of the app and/or retrieved via an electronic wallet of the user. This can include, for example, capturing and storing an image of the ID via the client device, analyzing the image data, recognizing whether an ID is valid or invalid, recognizing and storing age information and/or other analysis. The validation and/or the scan can be shared with the server and/or the processing system 100 to verify the diner's age. This can be done automatically when the diner places his/her phone on the table and/or is associated with an order or can be requested in response to an order via the app or a direct request received via the server.

In addition or alternative to any of the foregoing, once the client device is detected at a service location, the system links a guest account to the table and/or seating position. A server could then verify the age(s) based on a physical check of the ID(s) and/or via the age verification and/or guest ID information from the client device and mark the guest (or guests) as over 21 using their server tablet. This fact could be stored with the guest account. Going forward the system would always unlock alcohol when this guest sits at a table with his/her client device. This ensures a human verified credentials at some point. Having the ID's scanned and the images presented would allow a future server to pull up the information on their server tablet to double check the people at the table are who the system says they are based on the proximity of the client device(s) and/or optional guest photos, ID photos, etc. In further examples, the system can also keep track of the size of the party and the number and timing of the drinks being ordered to maintain the consumption of alcohol below presumptive over-consumption thresholds.

In the screen display 1110-1 of FIG. 11B, the user has ordered a bottle of wine. In the screen display 1110-2 of FIG. 11C, the diner's IDs and/or other age validation information are stored for display to the server and/or for communication with the processing system 100 for automatic verification. In FIG. 11D, the system indicates that the ages of the diners have been verified.

Consider the following example of operation where at least one beacon transmitter 102 is configured to transmit a wireless beacon associated with a service location of a venue, such as a table number and/or seating position. The processing system 100 includes a memory that stores operational instructions corresponding to an intelligent venue application and a processing circuit configured to execute the operational instructions, wherein the operational instructions cause the processing circuit to:
detect a client device at the service location, wherein the client device is detected in response to an automated reply signal generated by the client device in response to the wireless beacon;
establish an association between the client device with an order placed at the service location; and
communicate with the client device to facilitate age verification for the order placed at the service location based on user identification information stored via the client device.

It should be noted that the client device can be associated with the service location of the guest before an order exists. At that point the client device can detect the sensor and communicate with the processing system which associates the client device (e.g., the guest(s) with that table and the client data will be known to the processing system (either uploaded from devices or retrieved from a guest database). The age verification information will be known to the processing system and can be requested by display device 106 either on the table or in the server's hand in the case of a server tablet. The age verification information can include data fields such as age as well as images such as ID's for display on server tablet to aid in human double checking. Generally, the guest is blocked from even putting alcohol in the cart to initiate the existence of an order until after their ID's are checked, their prior verification has been accessed and/or the guests have been properly identified.

In addition or in the alternative to any of the foregoing, the user identification information is stored via an electronic wallet of the client device.

In addition or in the alternative to any of the foregoing, the age verification is facilitated automatically without requiring interaction with the user of the client device.

In addition or in the alternative to any of the foregoing, once the association is established, the client device emits feedback to the user of the client device indicating the association; and wherein the feedback to the user includes an audible alert.

FIG. 11E presents a flowchart representation 1160 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F and 11A-11D.

Step 1160-1 includes transmitting a wireless beacon associated with a service location of a venue. Step 1160-2 includes detecting a client device at the service location, wherein the client device is detected in response to an automated reply signal generated by the client device in response to the wireless beacon. Step 1160-3 includes establishing an association between the client device with an order placed at the service location. Step 1160-4 includes communicating with the client device to facilitate age verification for the order placed at the service location based on user identification information stored via the client device.

In addition or in the alternative to any of the foregoing, the user identification information is stored via an electronic wallet of the client device.

In addition or in the alternative to any of the foregoing, the age verification is facilitated automatically without requiring interaction with the user of the client device.

In addition or in the alternative to any of the foregoing, once the association is established, the client device emits feedback to the user of the client device indicating the association; and wherein the feedback to the user includes an audible alert.

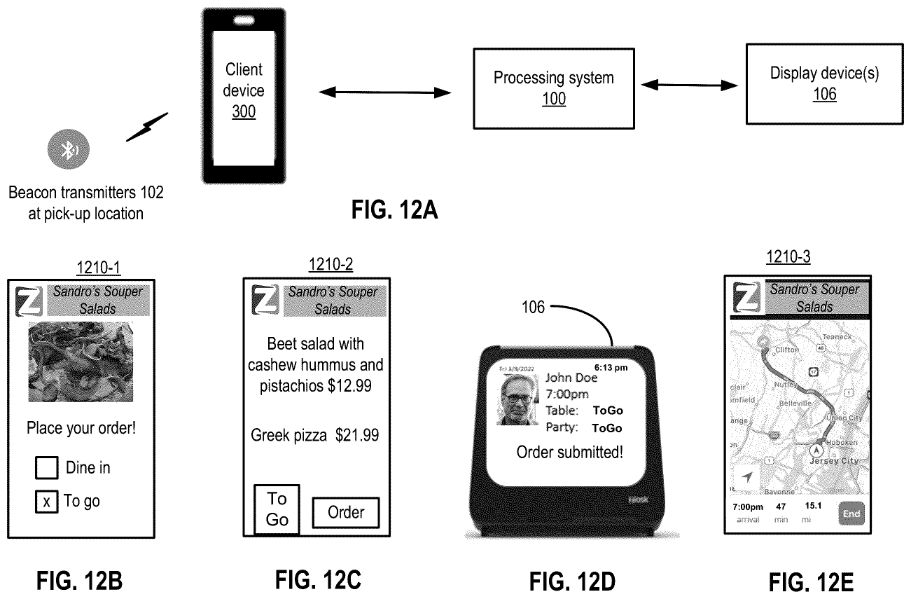

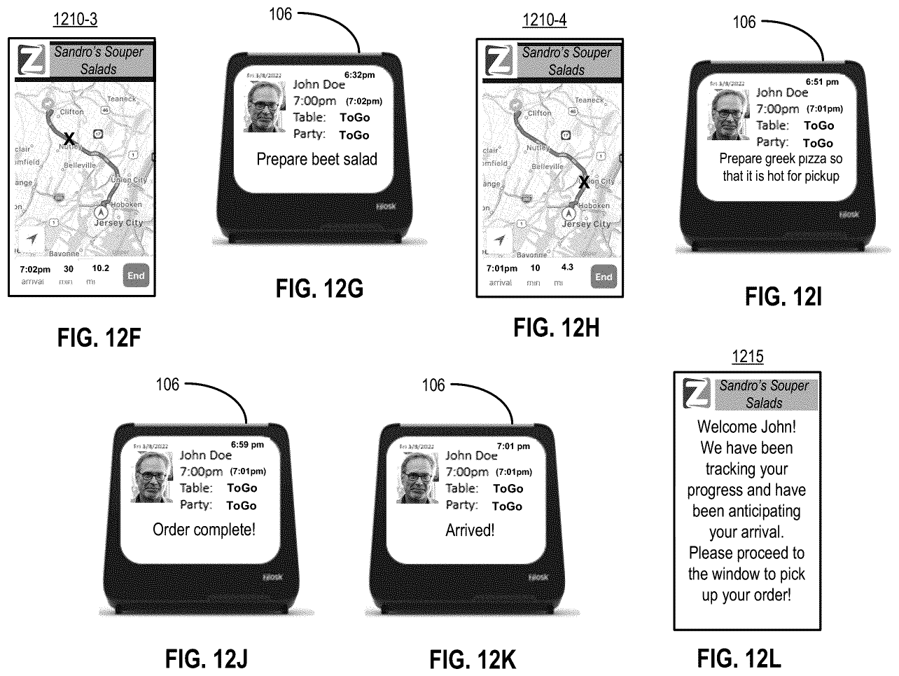

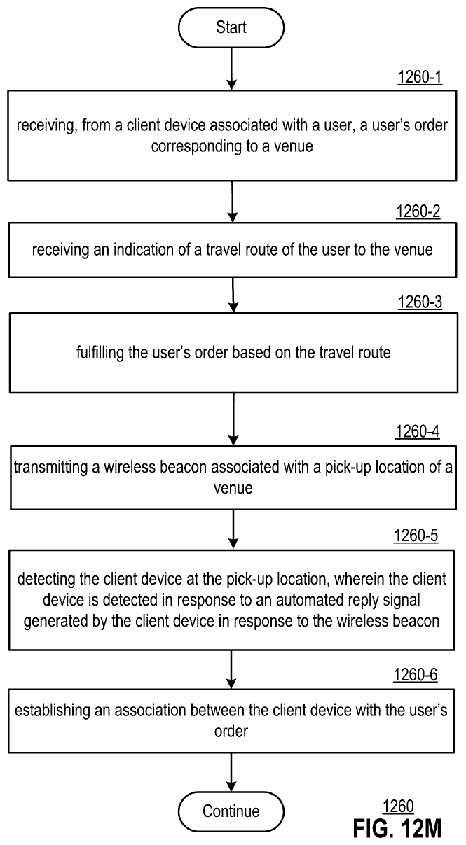

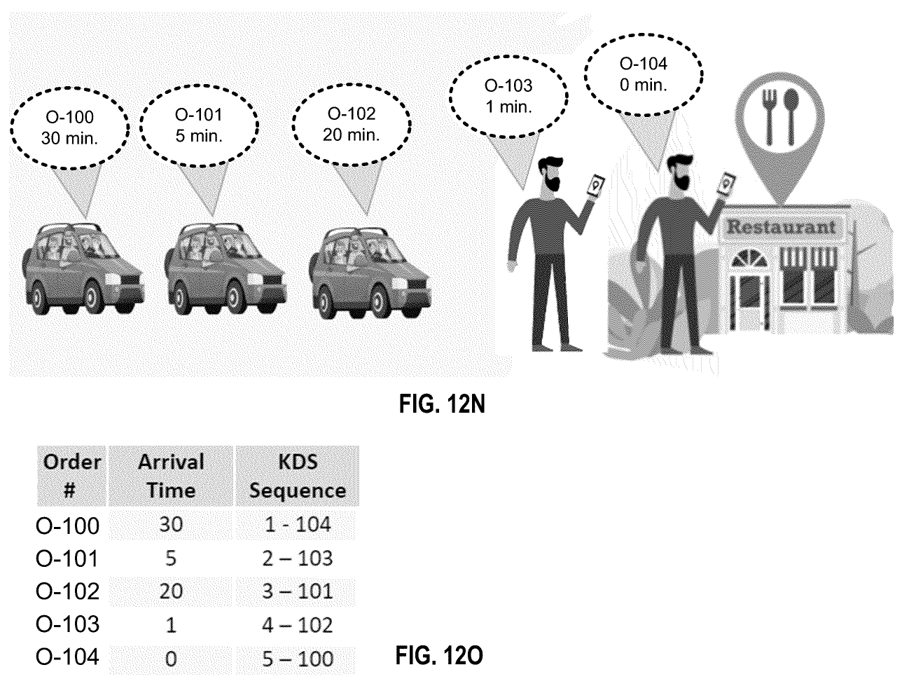

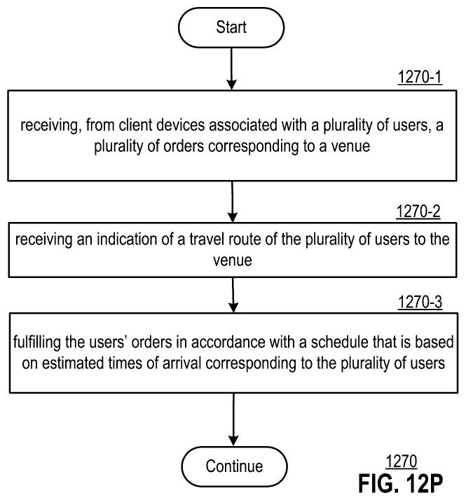

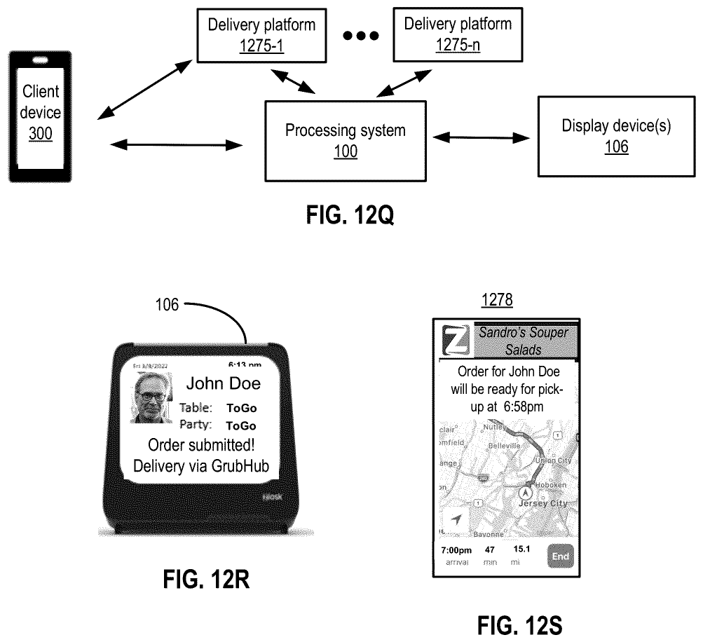

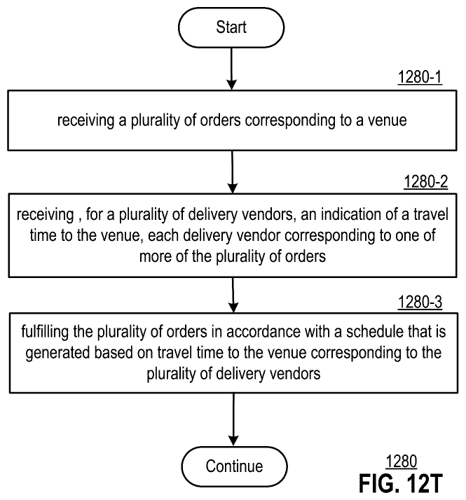

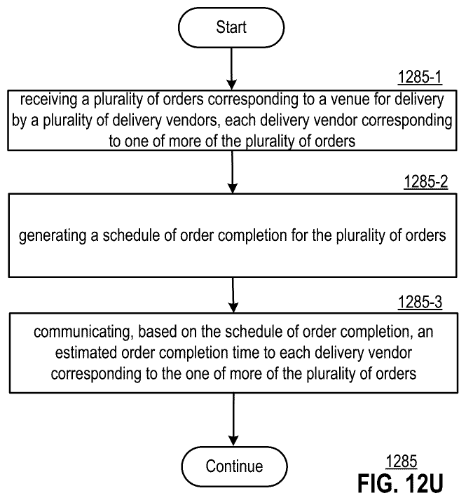

FIG. 12A presents a block diagram representation of an example system. In particular, a system is presented that includes client device 300, processing system 100 and display device 106 and further can be used in addition, or in the alternative to any of the systems previously described. Like the system of FIG. 9A, the system can intelligently process an order based on the projected arrival time and/or the actual position of the user along a route to the venue so that the order is ready for just-in-time delivery as shown in FIGS. 12B-12K (e.g., similarly to FIGS. 9B-9K). Like the system of FIG. 10A, arrival at a pick-up location can be indicated using one or more beacon transmitters 102. In the example shown in FIG. 12L, the pick-up location corresponding to a drive-thru and a screen display 1215 is presented at the drive-thru that indicates the order is ready and/or to proceed to a particular window or other location for pick-up.

Consider the following example of operation where at least one beacon transmitter 102 is configured to transmit a wireless beacon associated with a pick-up location of a venue, such as a drive thru location, a pick-up parking spot, etc. The processing system 100 includes a memory that stores operational instructions corresponding to an intelligent venue application and a processing circuit configured to execute the operational instructions, wherein the operational instructions cause the processing circuit to:
receive, from a client device associated with a user, a user's order corresponding to a venue;
receive an indication of a travel route of the user to the venue;
fulfill the user's order based on the travel route;
detect the client device at the pick-up location, wherein the client device is detected in response to an automated reply signal generated by the client device in response to the wireless beacon; and
establish an association between the client device with the user's order.

In various examples, some of these steps can be performed utilizing the client device, a library or application of the client device, logic in the cloud and/or via the processing system itself.

In addition or in the alternative to any of the foregoing, the system operates to determine an estimated time of arrival of the user at the venue based on the position of the user along the travel route.

In addition or in the alternative to any of the foregoing, fulfilling the user's order is based on the estimated time of arrival of the user at the venue.

In addition or in the alternative to any of the foregoing, fulfilling the user's order is further based on estimated preparation times of a plurality of items included in the user's order.

In addition or in the alternative to any of the foregoing, a plurality of items included in the user's order include a first item with a first preparation time and a second item with a second preparation time that is less than the first preparation time, and wherein fulfilling the user's order includes preparing the first item before the second item.

In addition or in the alternative to any of the foregoing, fulfilling the user's order includes preparing the first item of the plurality of items with a completion time that coincides with the estimated time of arrival of the user at the venue.

FIG. 12M presents a flowchart representation 1260 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E and 12A-12L.

Step 1260-1 includes receiving, from a client device associated with a user, a user's order corresponding to a venue. Step 1260-2 includes receiving an indication of a travel route of the user to the venue. Step 1260-3 includes fulfilling the user's order based on the travel route. Step 1260-4 includes transmitting a wireless beacon associated with a pick-up location of a venue. Step 1260-5 includes detecting the client device at the pick-up location, wherein the client device is detected in response to an automated reply signal generated by the client device in response to the wireless beacon. Step 1260-6 includes establishing an association between the client device with the user's order.

In addition or in the alternative to any of the foregoing, the method operates to determine an estimated time of arrival of the user at the venue based on the position of the user along the travel route.

In addition or in the alternative to any of the foregoing, fulfilling the user's order is based on the estimated time of arrival of the user at the venue.

In addition or in the alternative to any of the foregoing, fulfilling the user's order is further based on estimated preparation times of a plurality of items included in the user's order.

In addition or in the alternative to any of the foregoing, a plurality of items included in the user's order include a first item with a first preparation time and a second item with a second preparation time that is less than the first preparation time, and wherein fulfilling the user's order includes preparing the first item before the second item.

In addition or in the alternative to any of the foregoing, fulfilling the user's order includes preparing the first item of the plurality of items with a completion time that coincides with the estimated time of arrival of the user at the venue.

FIG. 12N presents a pictorial representation of an example of orders placed by a plurality of users. In addition or alternative to any of the foregoing, the prior systems and/or methods can be modified to not only determine an estimated time of arrival at the venue for users that have placed an order, but to schedule the processing of orders for fulfillment, such as in an order queue of other data structure, so that orders are prepared on a just-in-time basis or otherwise to promote efficiency and/or to have food or other items prepared so that they are fresh at the time the order is delivered or picked up by the user or by a delivery vendor (e.g., a delivery driver associated with a delivery company such as Uber Eats, GrubHub, DoorDash or other delivery company) on-route to the venue. This adapts to the fact that some orders placed before others should be fulfilled after these later orders—based on the times that the corresponding users/customers/delivery vendors are expected to arrive, whether or not they are dining-in and/or already arrived.

In various embodiments, a system of an intelligent venue operates by:
receiving, from client devices associated with a plurality of users, a plurality of orders corresponding to a venue
receiving an indication of a travel route of the plurality of users to the venue; and
fulfilling the users' orders in accordance with a schedule that is based on estimated times of arrival corresponding to the plurality of users.

In the example presented, five orders have placed labeled O-100, O-101, O-102, O-103 and O-104, with arrive times of 30 minutes, 5 minutes, 20 minutes, 1 minute and 0 minutes, respectively. The “KDS” order queue is arranged as shown in FIG. 12O to reflect the expected arrival time calculated based on client device positions and travel times. In this example, order O-104 is processed first because the customer has already arrived. Conversely, order O-100 is placed in fifth position since the customer is 30 minutes away. As will be appreciated the order queue can be updated as orders are prepared and fulfilled. Furthermore, as previously discussed, order preparation can depend on factors relating to the order itself, such as order preparation time, hot and or cold foods and/or the estimated time the food being ordered can sit without reducing quality and/or the number of orders being prepared and/or in queue. In various examples, an optimization algorithm and/or other AI can be employed to optimize food quality, the dwell time for pick-up/delivery, optimize kitchen staff operations, expected customer experience, etc.

FIG. 12P presents a flowchart representation 1270 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E and 12A-12O.

Step 1270-1 includes receiving, from client devices associated with a plurality of users, a plurality of orders corresponding to a venue. Step 1270-2 includes receiving an indication of a travel route of the plurality of users to the venue. Step 1270-3 includes fulfilling the user's order in accordance with a schedule that is based on estimated times of arrival corresponding to the plurality of users.

In addition or in the alternative to any of the foregoing, an order queue can be generated based on the schedule and/or updated as orders are prepared and fulfilled.

In addition or in the alternative to any of the foregoing, the schedule can further be based on factors relating to the order itself, such as order preparation time, hot and or cold foods and/or the estimated time the food being ordered can sit without reducing quality and/or the number of orders being prepared and/or in queue.

In addition or in the alternative to any of the foregoing, an optimization algorithm and/or other AI can be employed to optimize food quality, the dwell time for pick-up/delivery, optimize kitchen staff operations, etc.

FIG. 12Q presents a pictorial/block diagram representation of an example system. In the example shown, the processing system 100 coordinates order fulfillment and device via delivery platforms (1275-1 . . . 1275-n) that communicate processing system 100 via a network such as the Internet. These delivery platforms (which can also be referred to as order delivery platforms) can correspond to delivery companies such as Uber Eats, GrubHub, DoorDash, Amazon, UPS, FedEx or other delivery companies that employ delivery vendors (e.g., drivers) to pick-up orders and deliver them to the costumers that ordered them. In various examples, orders from a client device 300 can be received in multiple different ways.

In one example, an order placed by a customer's (e.g., user's) client device can be generated directly with the processing system 100. If delivery is selected by the user, the processing system can then coordinate with a particular delivery platform (selected either by the user or by the processing system 100) to facilitate pick-up and delivery. In this case, the driver's location, route and/or expected arrival time at the venue (collected by the delivery platform based on client devices 300 of the delivery drivers/vendors) can be conveyed to the processing system 100 to facilitate a schedule of order preparation, processing and fulfillment (as previously described) in conjunction with direct customer pick-ups for customers enroute and/or orders placed at the venue itself.

In a further example, the user of client device 300 places the order from the venue directly with a particular one of the delivery platforms (1275-1 . . . 1275-n). The order is shared with the processing system 100 to facilitate order, delivery and pick-up. In FIG. 12R a display screen indicating the order is displayed via display device 106. And again, the driver's location, route and/or expected arrival time at the venue (collected by the delivery platform based on client devices 300 of the delivery vendors) can be conveyed to the processing system to facilitate a schedule of order preparation, processing and fulfillment in conjunction with direct customer pick-ups for customers enroute and/or orders placed at the venue itself.

In various embodiments, a system of an intelligent venue operates by:
receiving a plurality of orders corresponding to a venue;
receiving, for a plurality of delivery vendors, an indication of a travel time to the venue, each delivery vendor corresponding to one of more of the plurality of orders; and
fulfilling the plurality of orders in accordance with a schedule that is generated based on travel time to the venue corresponding to the plurality of delivery vendors.

In addition or in the alternative to any of the foregoing, the operations further include:
determining the estimated times of arrival based on the position of the plurality of delivery vendors along their corresponding travel routes to the venue.

In addition or in the alternative to any of the foregoing, fulfilling the user's orders is further based on estimated preparation times of items included in the users' orders.

In addition or in the alternative to any of the foregoing, an order queue is generated based on the schedule and/or updated as orders are prepared and fulfilled.

In addition or in the alternative to any of the foregoing, the schedule is further based on one or more factors relating to the order itself.

In addition or in the alternative to any of the foregoing, the schedule is further based on additional orders received from guests at the venue.

In addition or in the alternative to any of the foregoing, an optimization algorithm and/or other AI is utilized to optimize one or more of: food quality at the time of fulfillment, a dwell time for pick-up or delivery, and/or kitchen staff operations.

In addition or in the alternative to any of the foregoing, the plurality of orders are received from one or more order delivery platforms.

In addition or in the alternative to any of the foregoing, the indication of the travel time to the venue corresponding to the plurality of delivery vendors is received from one or more order delivery platforms.

In various embodiments, the schedule of order preparation, processing and fulfillment can include a schedule of order completion that indicates estimated order completion times for orders being picked-up by customers and/or delivery vendors. This information can be conveyed by the processing system 100 back to the customer/delivery vendor either directly or via a corresponding delivery platform. In the case of customer pick-up, this gives the option for the customer to leave later, stop to get gas, etc., if the estimated order completion time is later than his/her estimated arrival time at the venue. In the case of order delivery, the delivery vendor may opt to fulfill another order in lieu of waiting at the venue until an order is complete.

In the example shown in FIG. 12S, a screen display 1278 of a delivery vendor's client device indicates that the estimated order completion time is 6:58 pm for her order being picked-up for John Doe. In this case, the processing system 100 was able to accommodate the driver's expected arrival time of 7:00 pm in the schedule. The order will be fresh upon arrival and the driver will not need to wait. While shown as a display screen for a driver's client device, a similar display screen could be sent to a customer's client device 300 to provide the estimated order completion time for an order to be picked-up by the user himself or herself.

In various embodiments, a system of an intelligent venue operates by:
receiving a plurality of orders corresponding to a venue for delivery by a plurality of delivery vendors, each delivery vendor corresponding to one of more of the plurality of orders;
generating a schedule of order completion for the plurality of orders; and
communicating, based on the schedule of order completion, an estimated order completion time to each delivery vendor corresponding to the one of more of the plurality of orders.

In addition or in the alternative to any of the foregoing, the schedule is further based on additional orders received from guests at the venue.

In addition or in the alternative to any of the foregoing, an optimization algorithm and/or other AI is utilized to optimize one or more of: food quality at the time of fulfillment, a dwell time for pick-up or delivery, and/or kitchen staff operations.

In addition or in the alternative to any of the foregoing, the plurality of orders are received from one or more order delivery platforms.

FIG. 12T presents a flowchart representation of an example method. In particular, this method 1280 can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E and 12A-12S.

Step 1280-1 includes receiving a plurality of orders corresponding to a venue. Step 1280-2 includes receiving, for a plurality of delivery vendors, an indication of a travel time to the venue, each delivery vendor corresponding to one of more of the plurality of orders. Step 1280-3 includes fulfilling the plurality of orders in accordance with a schedule that is generated based on travel time to the venue corresponding to the plurality of delivery vendors.

In addition or in the alternative to any of the foregoing, the operations further include:
determining the estimated times of arrival based on the position of the plurality of delivery vendors along their corresponding travel routes to the venue.

In addition or in the alternative to any of the foregoing, fulfilling the user's orders is further based on estimated preparation times of items included in the users' orders.

In addition or in the alternative to any of the foregoing, an order queue is generated based on the schedule and/or updated as orders are prepared and fulfilled.

In addition or in the alternative to any of the foregoing, the schedule is further based on one or more factors relating to the order itself.

In addition or in the alternative to any of the foregoing, the schedule is further based on additional orders received from guests at the venue.

In addition or in the alternative to any of the foregoing, an optimization algorithm and/or other AI is utilized to optimize one or more of: food quality at the time of fulfillment, a dwell time for pick-up or delivery, and/or kitchen staff operations.

In addition or in the alternative to any of the foregoing, the plurality of orders are received from one or more order delivery platforms.

In addition or in the alternative to any of the foregoing, the indication of the travel time to the venue corresponding to the plurality of delivery vendors is received from one or more order delivery platforms.

FIG. 12U presents a flowchart representation of an example method. In particular, this method 1285 can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E and 12A-12T.

Step 1285-1 includes receiving a plurality of orders corresponding to a venue for delivery by a plurality of delivery vendors, each delivery vendor corresponding to one of more of the plurality of orders. Steo 1285-2 includes generating a schedule of order completion for the plurality of orders. Step 1285-3 includes communicating, based on the schedule of order completion, an estimated order completion time to each delivery vendor corresponding to the one of more of the plurality of orders.

In addition or in the alternative to any of the foregoing, the schedule is further based on additional orders received from guests at the venue.

In addition or in the alternative to any of the foregoing, an optimization algorithm and/or other AI is utilized to optimize one or more of: food quality at the time of fulfillment, a dwell time for pick-up or delivery, and/or kitchen staff operations.

In addition or in the alternative to any of the foregoing, the plurality of orders are received from one or more order delivery platforms.

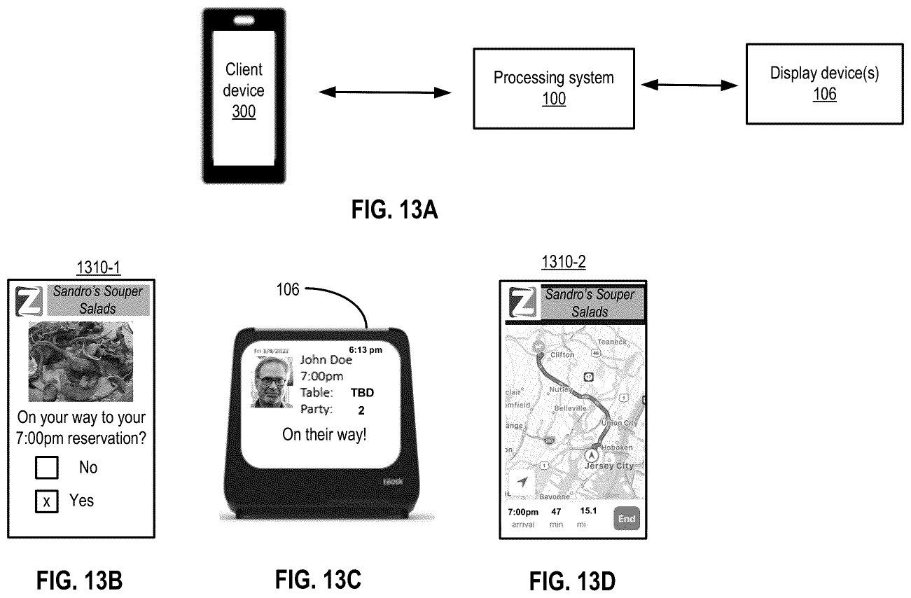

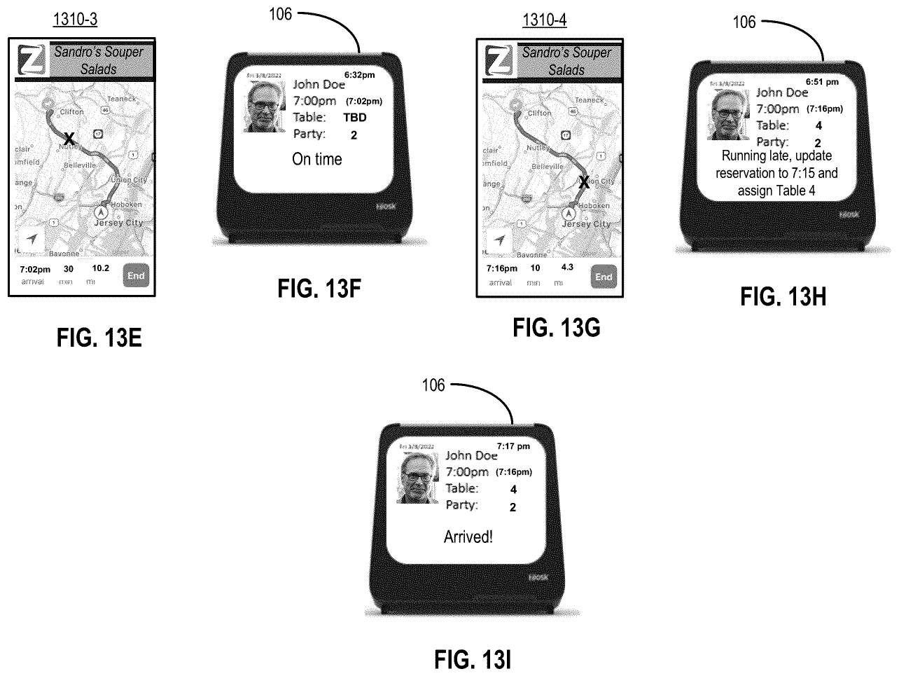

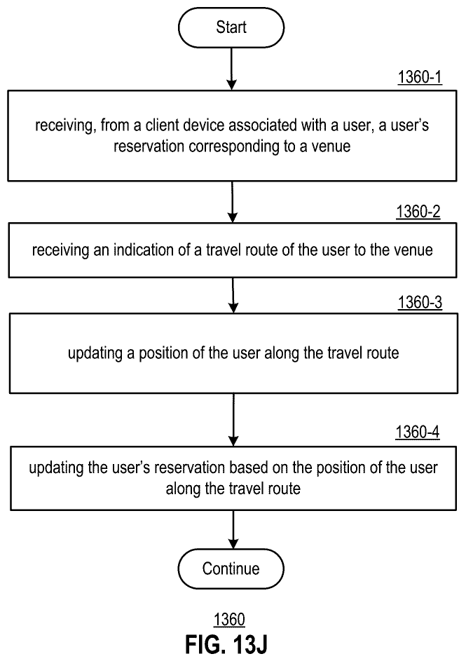

FIG. 13A presents a block diagram representation of an example system. In particular, a system is presented that includes client device 300, processing system 100 and display device 106 and further can be used in addition, or in the alternative to any of the systems previously described. Like the system of FIGS. 9A, 12A and/or 12Q, the system can intelligently determine the projected arrival time, based on, for example, the actual position of the user along a route to the venue. In this case, the system can determine that a user holding a reservation is on route and further can update the reservation time—in case the system determines that the user will arrive late. In addition or the alternative, the guests “lateness” can be communicated without an update to the reservation to accommodate venues that may not want to change the reservation, but simply want to know the guest(s) are running late and possibly how late they might be.

In the example shown, the user indicates they are on the way as shown in screen display 1310-1 of FIG. 13B and this is registered by the system as shown in FIG. 13C. Route information from client device 300 is indicated in screen display 1310-2 of FIG. 13D. A few minutes later, the position of the client device indicates that the user is still on-time (see, e.g., screen display 1310-3 of FIG. 13E) and this is registered by the system as shown in FIG. 13F. In FIG. 13G, the client device indicates that the user is delayed and has an updated arrival time (see, e.g., screen display 1310-4). In FIG. 13H, the system has updated the time of the reservation to more closely coincide with the user's expected arrival, and the actual arrival is indicated in FIG. 13I.

Consider the following example of operation where the processing system 100 includes a memory that stores operational instructions corresponding to an intelligent venue application and a processing circuit configured to execute the operational instructions, wherein the operational instructions cause the processing circuit to:
receive, from a client device associated with a user, a user's reservation corresponding to a venue;
receive an indication of a travel route of the user to the venue;
update a position of the user along the travel route; and
update the user's reservation based on the position of the user along the travel route.

In addition or in the alternative to any of the foregoing, the system operates to determine an estimated time of arrival of the user at the venue based on the position of the user along the travel route; wherein updating the user's reservation is based on an estimated time of arrival of the user at the venue.

In addition or in the alternative to any of the foregoing, the user's reservation is updated to coincide with the estimated time of arrival of the user at the venue.

FIG. 13J presents a flowchart representation 1360 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U and 13A-13I.

Step 1360-1 includes receiving, from a client device associated with a user, a user's reservation corresponding to a venue. Step 1360-2 includes receiving an indication of a travel route of the user to the venue. Step 1360-3 includes updating a position of the user along the travel route. Step 1360-4 includes updating the user's reservation based on the position of the user along the travel route.

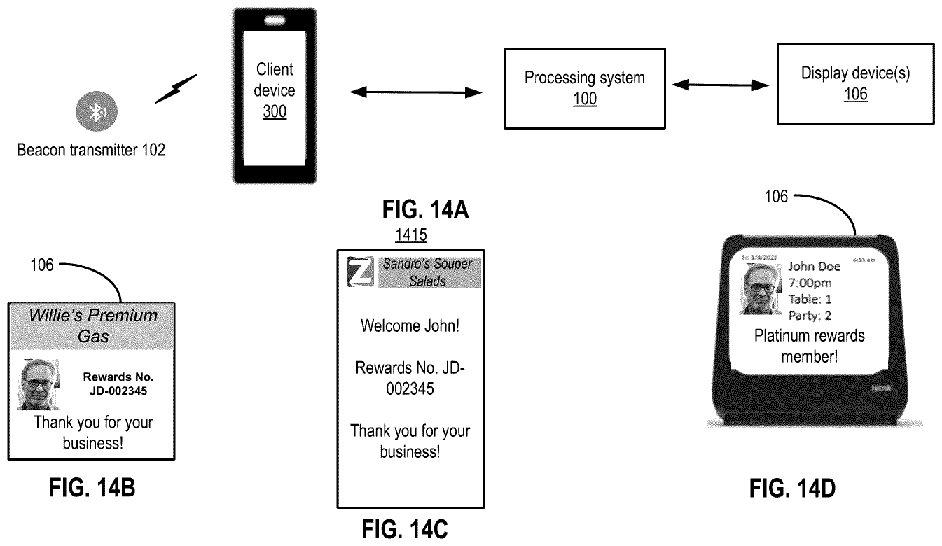

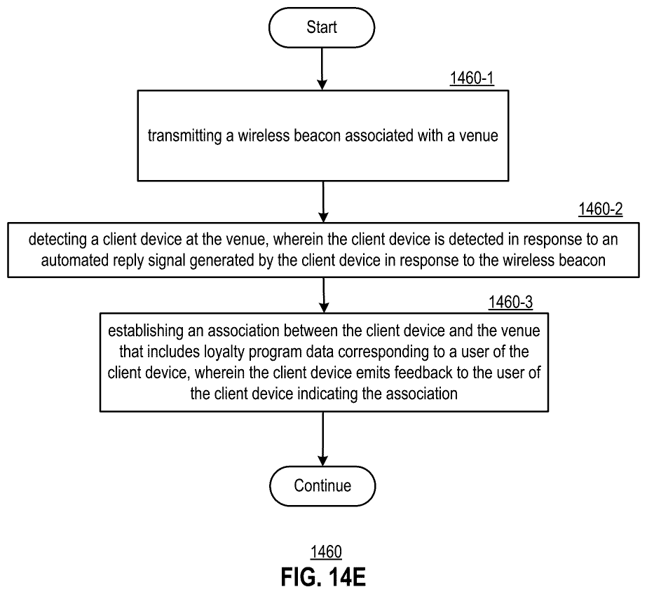

FIG. 14A presents a block diagram representation of an example system. In particular, a system is presented that includes client device 300, processing system 100 and display device 106 and further can be used in addition, or in the alternative to any of the systems previously described. The following examples focus on the use of a client device 300 for sharing a user's loyalty program data associated with a venue and/or other account that is recognized by a venue.

In accordance with various examples, when a user's client device 300 comes in range with a beacon transmitter 102, the client device is detected and an association is established between the client device and the venue that includes loyalty program data corresponding to a user of the client device. In various examples, the loyalty program data can include: user identification data associated with the program; coupons, discounts, status upgrades, current or future promotions, pending and/or earned rewards associated with or to be associated with the user; additional promotions that can be claimed by the user; promotion requirements for future awards; user loyalty status; past loyalty program activity of the user; and/or other information associated with a loyalty/reward program, payment information, account information and/or other information about or identifying the user.

For example, the client device can be detected: (a) at a pick-up location, at the venue's parking lot, at the venue's entrance, at a gas pump, at a drive-thru lane, and/or other location outside the venue; (b) when the user's client device 300 is set on the table of the venue, present in an item such as a physical wallet purse or handbag on, at or near the table or other service location of the venue, present in a pocket of the user near the table or other service location of the venue and/or otherwise in proximity with to a service location so as to be associated with the table number (and/or seat position or other location) of the venue; (c) at or in proximity to a check out location at a venue such as a cashier station; (d) at or in proximity to a check-in location at a venue such as a host/hostess stand, will-call window, ticket sales booth, hotel check-in desk, airport check-in, airport gate, baggage check-in, security check point; or (e) at any other location associated with a venue of any kind. The processing system 100 and the client device 300 can then recognize and/or display the loyalty program data associated with the user and/or utilize the loyalty program data in or after processing orders, purchases, venue access, upgrades, in presenting coupons, in applying discounts, in upgrading services, and/or other uses associated with any kind of venue transactions. As used herein loyalty program data can be retrieved from the client device, retrieved from a user account information associated with the venue, the platform and/or other system that is sufficient to identify the loyalty program data based on additional information that can be stored elsewhere, (e.g., other than on the client device).

Consider the following example of operation where at least one beacon transmitter 102 is configured to transmit a wireless beacon associated with a venue. The processing system 100 includes a memory that stores operational instructions corresponding to an intelligent venue application and a processing circuit configured to execute the operational instructions, wherein the operational instructions cause the processing circuit to: detect a client device at the venue in response to an automated reply signal generated by the client device in response to the wireless beacon; and to establish an association between the client device and the venue that includes loyalty program data corresponding to a user of the client device, wherein the client device emits feedback to the user of the client device indicating the association (as previously described).

FIG. 14B presents an example where a user's client device comes in proximity to the pump at a gasoline station and the display device 106 of the station indicates that the user's information and loyalty program reward information have been successfully received. In FIG. 14C a screen display 1415 associated with a drive thru indicates the user has been identified along with the user's loyalty program reward information. FIG. 14D presents an example where a user's client device is identified at a restaurant and the display 106 indicates that the user's information and loyalty program reward information so that the user's “platinum” status can be recognized in providing service to the user.

It should be noted that any screen displays associated with a display device associated with a venue disclosed herein, including but not limited to display devices associated with a gas pump, diver-thru location, pick-up location, that for example may facilitate payments, orders, pick-ups or other deliveries, loyalty rewards, marketing, promotions, etc., can in addition or in the alternative, be displayed on a client device 300—including a smartphone or other handheld device and/or a vehicle having an integrated client device 300-1.

FIG. 14E presents a flowchart representation 1460 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J and 14A-14D.

Step 1460-1 includes transmitting a wireless beacon associated with a venue. Step 1460-2 includes detecting a client device at the venue in response to an automated reply signal generated by the client device in response to the wireless beacon. Step 1460-3 includes establishing an association between the client device and the venue that includes loyalty program data corresponding to a user of the client device, wherein the client device emits feedback to the user of the client device indicating the association.

In addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J and 14A-14D, consider an example where at least one beacon transmitter is configured to transmit a first wireless beacon associated with a venue. A processing system that includes a memory that stores operational instructions corresponding to an intelligent venue application and a processing circuit configured to execute the operational instructions, wherein the operational instructions cause the processing circuit to: detect a client device at the venue, wherein the client device is detected in response to an automated reply signal generated by the client device in response to the first wireless beacon; establish an association between the client device with a transaction at the venue; wherein once the association is established, the client device emits feedback to a user of the client device indicating the association; and communicate with the client device to facilitate payment for the transaction based on payment information previously associated with the user.

In addition or in the alternative to any of the foregoing, the payment information is stored via an electronic wallet of the client device.

In addition or in the alternative to any of the foregoing, the operations further include communicating with the client device to facilitate payment for the transaction based on payment information previously associated with the user.

In addition or in the alternative to any of the foregoing, the payment for the transaction is facilitated automatically without requiring interaction with the user of the client device.

In addition or in the alternative to any of the foregoing, the feedback to the user includes at least one of an audible alert, haptic feedback or display of a visual indication.

In addition or in the alternative to any of the foregoing, the association indicates loyalty program data of the user.

In addition or in the alternative to any of the foregoing, the first wireless beacon is associated with a gas pump at the venue, and wherein the wherein a display device at the gas pump displays an indication that loyalty program data associated the user is being applied to the transaction.

In addition or in the alternative to any of the foregoing, the transaction is based on an order placed by the user corresponding to the venue, wherein the operational instructions further cause the processing circuit to: receive the order from the client device; receive an indication of a travel route of the user to the venue; update a position of the user along the travel route; and fulfill the user's order based on the position of the user along the travel route.

In addition or in the alternative to any of the foregoing, the operational instructions further cause the processing circuit to: receive an indication of an estimated arrival time of the user at the venue; and display the indication of the estimated arrival time of the user via a display device at the venue.

In addition or in the alternative to any of the foregoing, the operational instructions further cause the processing circuit to: correlate the estimated arrival time of the user to a reservation of the user at the venue.

In addition or in the alternative to any of the foregoing, the first wireless beacon is associated with a pick-up location at the venue and wherein the operational instructions further cause the processing circuit to: display the indication of the pick-up location via a display device at the venue.

In addition or in the alternative to any of the foregoing, the first wireless beacon is associated with a seating location of the venue and wherein the operational instructions further cause the processing circuit to: display, responsive to the association, the indication of an arrival of the user at the venue via a display device at the venue.

In addition or in the alternative to any of the foregoing, the first wireless beacon is associated with a seating location of the venue, wherein the transaction is based on an order placed by the user corresponding to the seating location, and wherein the seating location includes at least one of: a table indicator or a seating position indicator.

In addition or in the alternative to any of the foregoing, the at least one beacon transmitter includes a plurality of beacon transmitters, wherein each of the plurality of beacon transmitters is fixed to one of a plurality of tables of the venue, wherein each of the plurality of beacon transmitters is configured to transmit one of a plurality of wireless beacons including the first wireless beacon, and wherein each of the plurality of wireless beacons conveys a unique identifier; wherein the system further includes a plurality of beacon receivers configured to receive the plurality of wireless beacons transmitted by the plurality of beacon transmitters and to generate beacon data in response thereto that indicates the unique identifier associated with each of the plurality of wireless beacons; and wherein the operational instructions further cause the processing circuit to: store, via the memory, a table database that correlates the unique identifier associated with each of the plurality of wireless beacons to corresponding ones of the plurality of tables; generate, in response to the beacon data, location data that indicates positions of each of the plurality beacon transmitters; associate, utilizing the table database, the positions of each of the plurality beacon transmitters to corresponding ones of ones of the plurality of tables; generate map display data that plots the position of each of the plurality of tables on a map of the venue; and facilitate display of the map of the venue via a display device at the venue; wherein the association of the client device to the venue includes determining one of the plurality of tables associated with a position of the client device.

In addition or in the alternative to any of the foregoing, the operational instructions further cause the processing circuit to: update the table database to indicate the position of each of the plurality of tables.

In addition or in the alternative to any of the foregoing, the table database indicates whether or not each of the plurality of tables is in a fixed position.

In addition or in the alternative to any of the foregoing, the operational instructions further cause the processing circuit to: generate, in response to the beacon data, orientation data that indicates an updated orientation of at least one of the plurality of tables; wherein the map display data is further generated to plot the updated orientation of the at least one of plurality of tables on the map of the venue.

In addition or in the alternative to any of the foregoing, the plurality of beacon transmitters includes multiple beacon transmitters affixed to at least one of the plurality of tables, wherein the at least one of the plurality of tables has a plurality of seating positions and wherein the operational instructions further cause the processing circuit to: generate map display data to further indicate seating position indicators corresponding to the plurality seating positions for the at least one of the plurality of tables.

In addition or in the alternative to any of the foregoing, the association of the client device to the venue includes determining one of the plurality of seating positions associated with the position of the client device.

In addition or in the alternative to any of the foregoing, the operational instructions further cause the processing circuit to: determine, in response to the beacon data, when two or more of the plurality of tables have been placed together; wherein the map display data is further generated to indicate that two or more of the plurality of tables have been placed together.

In addition or in the alternative to any of the foregoing examples, including the examples provided in conjunction with FIGS. 1A-1L, 2A-2J, 3A-3F, 4A-4F, 5A-5F, 6A—6E, 7A—7F, 8A—8F, 9A-9L, 10A-10F, 11A-11E, 12A-12U, 13A-13J and 14A-14D, consider an example method that includes the steps of: transmitting a wireless beacon associated with a service location of a venue; detecting a client device at the venue, wherein the client device is detected in response to an automated reply signal generated by the client device in response to the wireless beacon; establishing an association between the client device with a transaction at the venue; wherein once the association is established, the client device emits feedback to the user of the client device indicating the association; and communicating with the client device to facilitate payment for the transaction based on payment information previously associated with the user.

In addition or in the alternative to any of the foregoing, the payment information is stored via an electronic wallet of the client device.

In addition or in the alternative to any of the foregoing, the method further includes communicating with the client device to facilitate payment for the transaction based on payment information previously associated with the user.

In addition or in the alternative to any of the foregoing, the payment for the transaction is facilitated automatically without requiring interaction with the user of the client device.

In addition or in the alternative to any of the foregoing, the feedback to the user includes at least one of: an audible alert, haptic feedback or display of a visual indication.

In addition or in the alternative to any of the foregoing, the association indicates loyalty program data of the user.

In addition or in the alternative to any of the foregoing, the first wireless beacon is associated with a gas pump at the venue, and wherein the wherein a display device at the gas pump displays an indication that loyalty program data associated the user is being applied to the transaction.

In addition or in the alternative to any of the foregoing, the transaction is based on an order placed by the user corresponding to the venue, wherein method further includes: receive the order from the client device; receiving an indication of a travel route of the user to the venue; updating a position of the user along the travel route; and fulfilling the user's order based on the position of the user along the travel route.

In addition or in the alternative to any of the foregoing, method further includes: receiving an indication of an estimated arrival time of the user at the venue; and displaying the indication of the estimated arrival time of the user via a display device at the venue.

In addition or in the alternative to any of the foregoing, method further includes: correlating the estimated arrival time of the user to a reservation of the user at the venue.

In addition or in the alternative to any of the foregoing, the first wireless beacon is associated with a pick-up location at the venue and wherein method further includes: displaying the indication of the pick-up location via a display device at the venue.

In addition or in the alternative to any of the foregoing, the first wireless beacon is associated with a seating location of the venue and wherein method further includes: displaying, responsive to the association, the indication of an arrival of the user at the venue via a display device at the venue.

In addition or in the alternative to any of the foregoing, the first wireless beacon is associated with a seating location of the venue, wherein the transaction is based on an order placed by the user corresponding to the seating location, and wherein the seating location includes at least one of: a table indicator or a seating position indicator.

In addition or in the alternative to any of the foregoing, the at least one beacon transmitter includes a plurality of beacon transmitters, wherein each of the plurality of beacon transmitters is fixed to one of a plurality of tables of the venue, wherein each of the plurality of beacon transmitters is configured to transmit one of a plurality of wireless beacons including the first wireless beacon, and wherein each of the plurality of wireless beacons conveys a unique identifier; wherein the system further includes a plurality of beacon receivers configured to receive the plurality of wireless beacons transmitted by the plurality of beacon transmitters and to generate beacon data in response thereto that indicates the unique identifier associated with each of the plurality of wireless beacons; and wherein method further includes: storing, via the memory, a table database that correlates the unique identifier associated with each of the plurality of wireless beacons to corresponding ones of the plurality of tables; generating, in response to the beacon data, location data that indicates positions of each of the plurality beacon transmitters; associating, utilizing the table database, the positions of each of the plurality beacon transmitters to corresponding ones of ones of the plurality of tables; generating map display data that plots the position of each of the plurality of tables on a map of the venue; and facilitating display of the map of the venue via a display device at the venue; wherein the association of the client device to the venue includes determining one of the plurality of tables associated with a position of the client device.

In addition or in the alternative to any of the foregoing, method further includes: updating the table database to indicate the position of each of the plurality of tables.

In addition or in the alternative to any of the foregoing, the table database indicates whether or not each of the plurality of tables is in a fixed position.

In addition or in the alternative to any of the foregoing, method further includes: generating, in response to the beacon data, orientation data that indicates an updated orientation of at least one of the plurality of tables; wherein the map display data is further generated to plot the updated orientation of the at least one of plurality of tables on the map of the venue.

In addition or in the alternative to any of the foregoing, the plurality of beacon transmitters includes multiple beacon transmitters affixed to at least one of the plurality of tables, wherein the at least one of the plurality of tables has a plurality of seating positions and wherein method further includes: generating map display data to further indicate seating position indicators corresponding to the plurality seating positions for the at least one of the plurality of tables.

In addition or in the alternative to any of the foregoing, the association of the client device to the venue includes determining one of the plurality of seating positions associated with the position of the client device.

In addition or in the alternative to any of the foregoing, method further includes: determining, in response to the beacon data, when two or more of the plurality of tables have been placed together, wherein the map display data is further generated to indicate that two or more of the plurality of tables have been placed together.

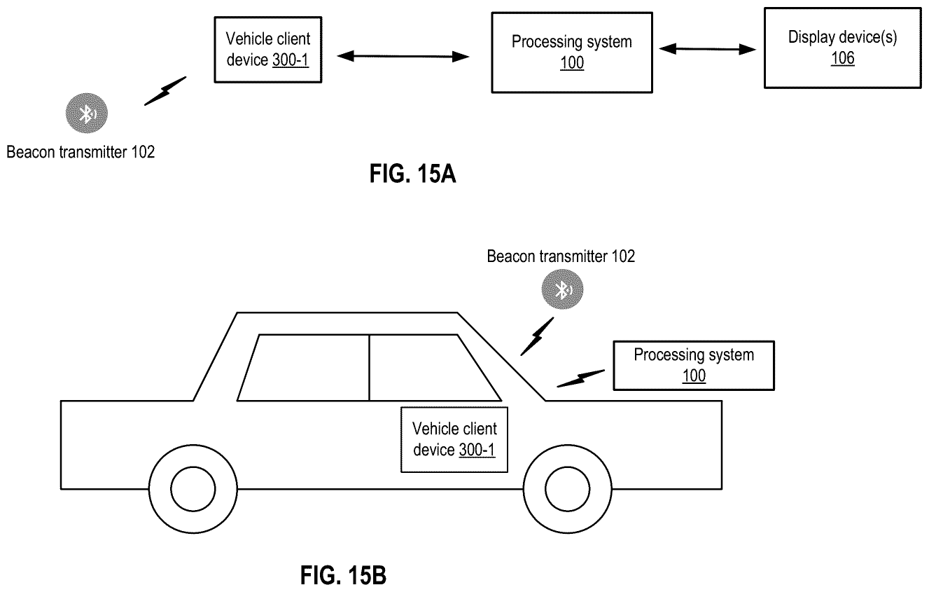

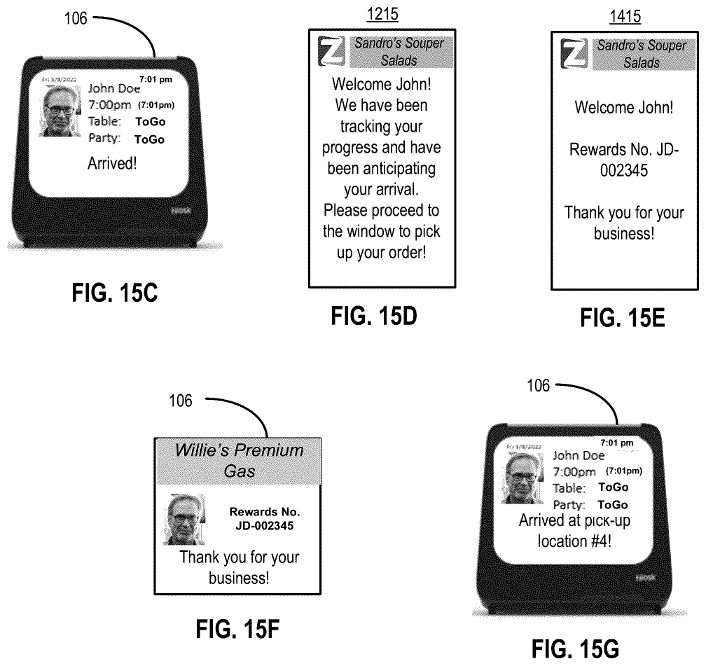

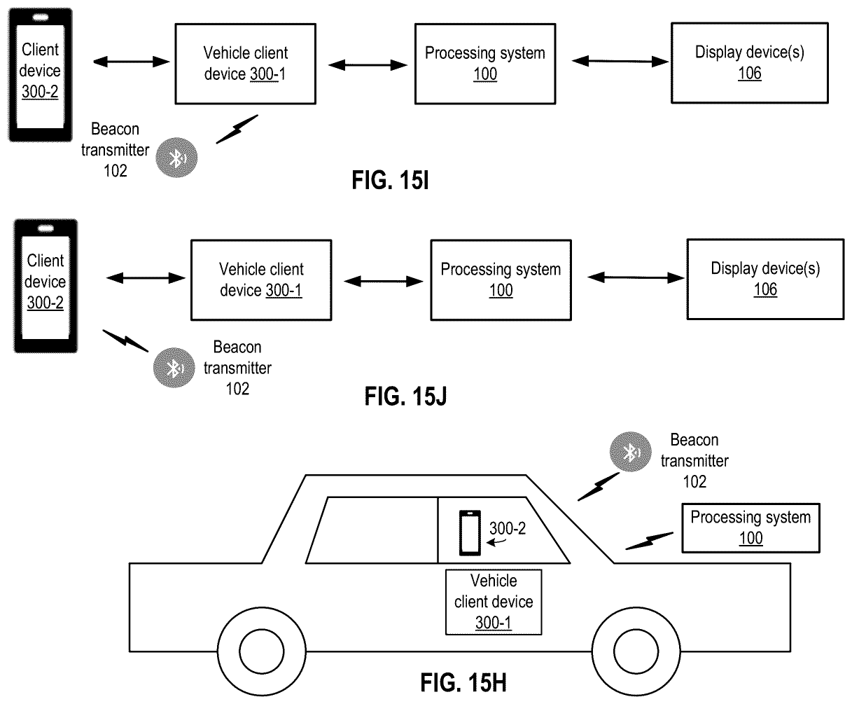

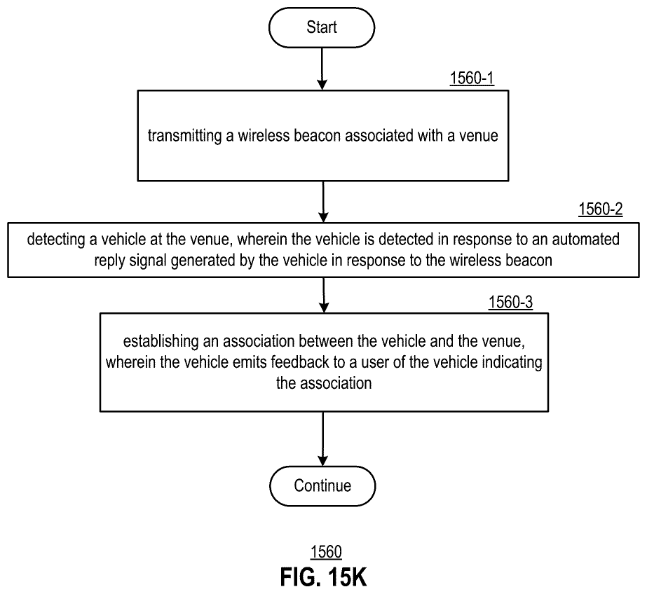

FIG. 15A presents a block diagram representation of an example system. In particular, a system is presented that includes vehicle client device 300-1, processing system 100 and display device 106 and further can be used in addition, or in the alternative to any of the systems previously described. The vehicle client device 300-1 can be a further example of a client device 300 and/or in conjunction with a client device 300 to provide some or all of the functionality of the client device 300 as previously described, at least in terms of its mobility, communications, etc., —but may be limited in terms of its size, weight, its inability to enter some venues, to be carried on a user's person, placed on a table top, etc. In various examples, the vehicle client device can be a component of a smart car or other vehicle that contains one or more processors, memory, a display such as a touch screen or other display screen and/or input devices and that supports the implementation of a graphical user interface, at least one haptic feedback device such as a vibrating seat or steering wheel, a device or interface that supports audio output, a Bluetooth transceiver that operates, for example via a Bluetooth 3, 4 or 5 protocol or other Bluetooth protocol, a WiFi transceiver, and/or a 4G or 5G transceiver for communicating voice and data via a radio access network. In particular, the vehicle client device 300-1 is configured to communicate wirelessly with a beacon transmitter 102 and/or with the processing system 100 as shown in FIG. 15B.

In various examples, the vehicle client device 300-1 can be detected at a venue pick-up location, at a venue's parking lot, at a gas pump, at a drive-thru lane, and/or other location outside the venue, support an association between the vehicle client device 300-1 and the venue (e.g., via processing system 100) to identify the position of the vehicle (e.g., based on the reception of one or more beacon signals by the client device 300-1), support orders, sharing loyalty program data, deliveries, payments, facilitate age verifications, notifications of a user's arrival at the venue and/or other features previously described in conjunction with client device 300.

In various examples, the vehicle client device 300-1 includes a vehicle navigation system that utilizes a GPS receiver and that generates data associated with vehicle position and tracking, route guidance, estimated arrival times, etc. that can be used as previously described to process orders to coincide with estimated arrival, track and/or update reservations, etc. and/or support or otherwise facilitate other location-based features previously described in conjunction with client device 300.

Consider the following example of operation where at least one beacon transmitter 102 is configured to transmit a wireless beacon associated with a venue. The processing system 100 includes a memory that stores operational instructions corresponding to an intelligent venue application and a processing circuit configured to execute the operational instructions, wherein the operational instructions cause the processing circuit to: detect a vehicle at the venue in response to an automated reply signal generated by the vehicle in response to the wireless beacon; and to establish an association with the vehicle, wherein the client device emits feedback to the user of the client device indicating the association (as described herein).

In FIG. 15C, the display device 106 in the venue indicates, responsive to the detection of a beacon signal and the association of vehicle client device 300-1 with the venue (e.g., via the processing system 100), that the user has arrived. In FIG. 15D, screen display 1215 of a venue drive-thru indicates, responsive to the association of vehicle client device 300-1 with the venue (e.g., via the processing system 100) and/or the reception of vehicle route and/or other vehicle tracking, indicates that the user has arrived. In FIG. 15E, screen display 1415 of a venue drive-thru indicates, responsive to the association of vehicle client device 300-1 with the venue (e.g., via the processing system 100), that the user's loyalty program data has been accessed. In FIG. 15F, the display device 106 of a venue gas pump indicates, responsive to the association of vehicle client device 300-1 with the venue (e.g., via the processing system 100), that the user's loyalty program data has been accessed. In FIG. 15G, the display device 106 in the venue indicates, responsive to the detection of a beacon signal and the association of vehicle client device 300-1 with the venue (e.g., via the processing system 100), that the user has arrived at pick-up location #4.

While the proceeding has described the operation of the vehicle client device 300-1—as the client device 300, in other examples, a client device 300-2 such as a smartphone or tablet can operate in conjunction with vehicle client device 300-1 to provide the functionality of the client device 300 as shown in FIG. 15H. For example, the client device 300-2 and/or vehicle client device 300-1 can include an intelligent venue application, a navigation app, a wallet and/or one or more other applications so that these two devices cooperatively support the features previously ascribed to the client device 300.

Consider the example shown in FIG. 151 where the vehicle client device 300-1 is configured to communicate wirelessly with a beacon transmitter 102, client device 300-2 and/or with the processing system 100. In various examples, the client device 300-2 stores the user's loyalty program data, payment information, age verification data and other personal information of the user. An application executed by the vehicle client device 300-1 can support the reception of beacon signals and cooperate with client device 300-2 to support the association with the processing system 100.

Consider the example shown in FIG. 15J where the client device 300-2 is configured to communicate wirelessly with a beacon transmitter 102, and the vehicle client device 300-1. In various examples, the client device 300-2 stores the user's loyalty program data, payment information, age verification data and/or other personal information of the user and supports the reception of beacon signals. An application executed by the vehicle client device 300-1 cooperates with client device 300-2 to support the association with the processing system 100.

FIG. 15K presents a flowchart representation 1560 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E and 15A-15J.

Step 1560-1 includes transmitting a wireless beacon associated with a venue. Step 1560-2 includes detecting a vehicle at the venue in response to an automated reply signal generated by the vehicle in response to the wireless beacon. Step 1560-3 includes establishing an association between the vehicle and the venue, wherein the vehicle emits feedback to the user of the client device indicating the association.

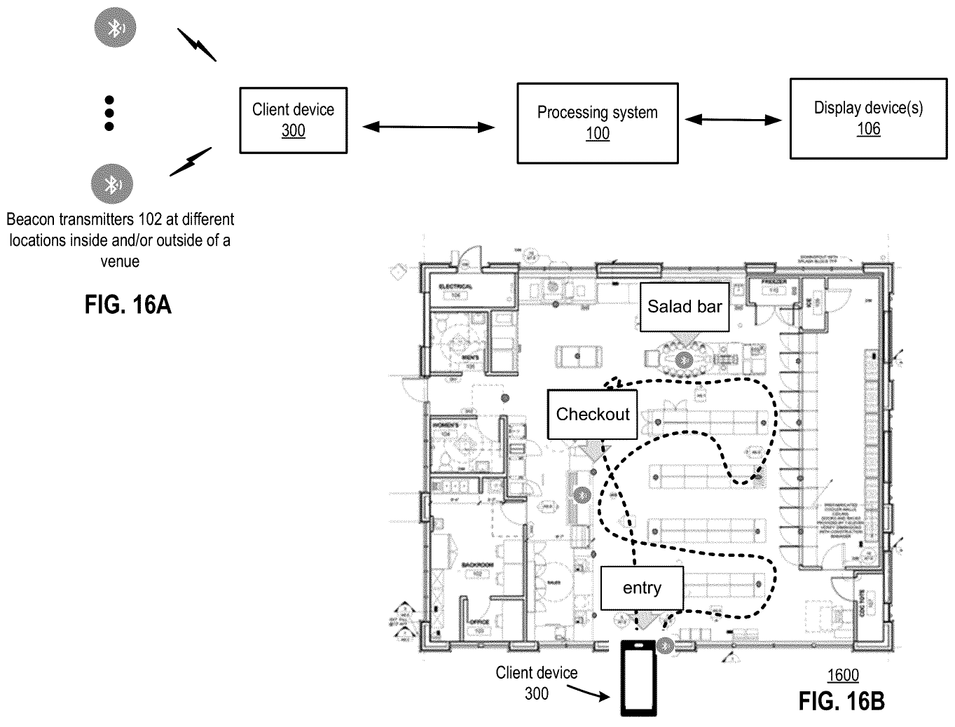

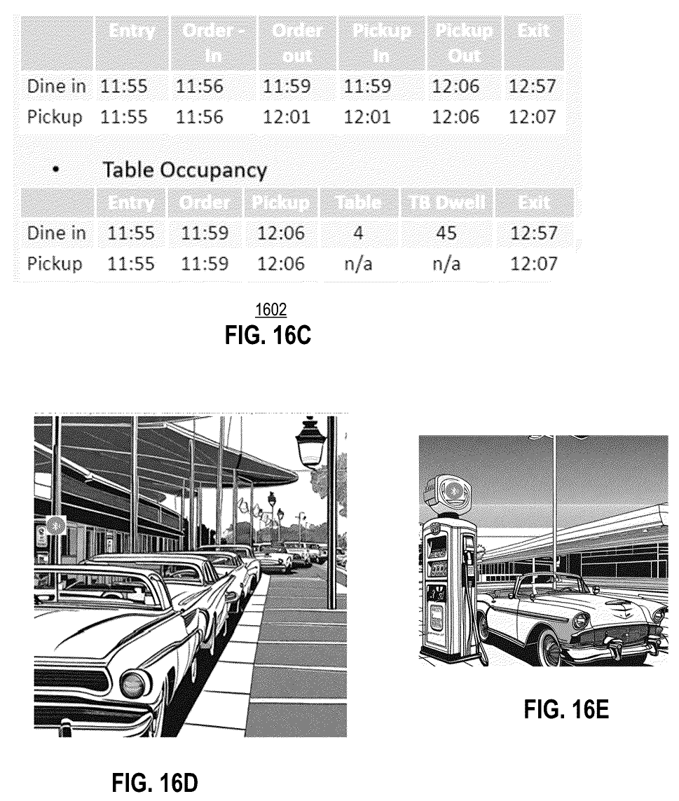

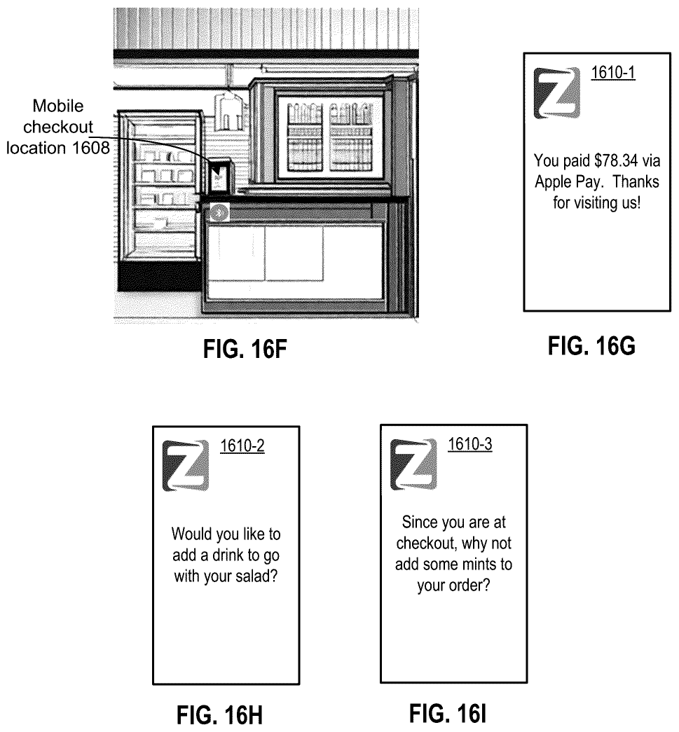

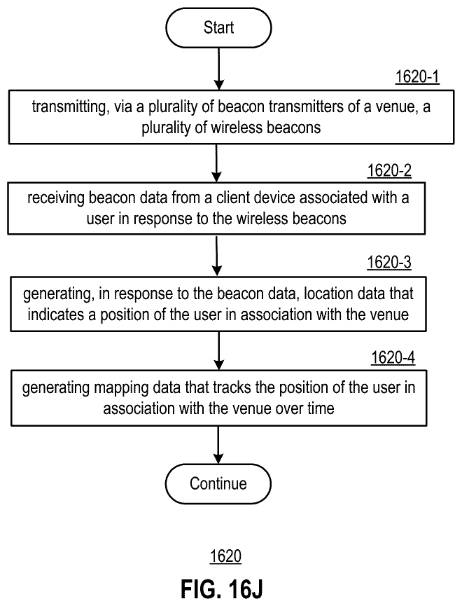

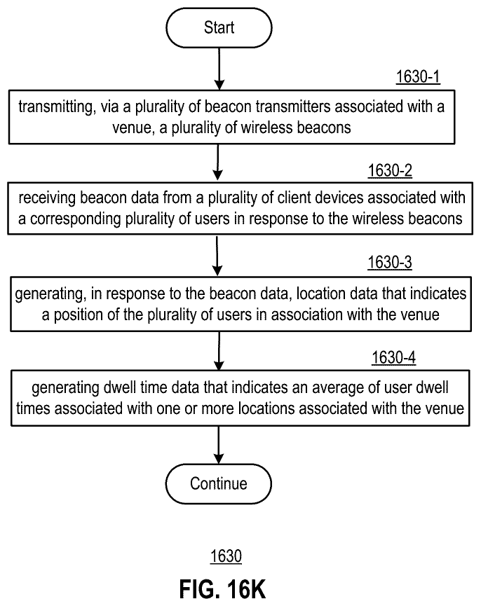

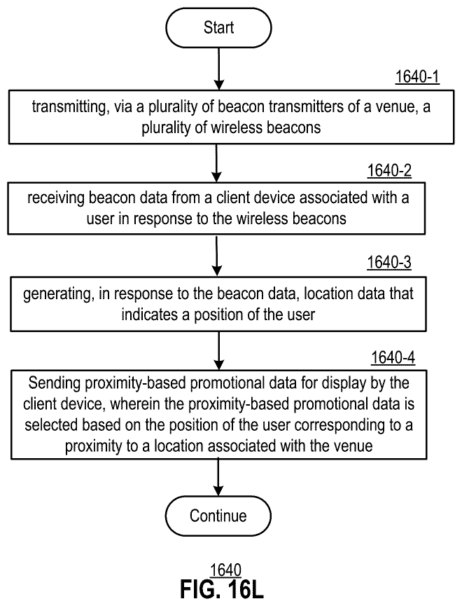

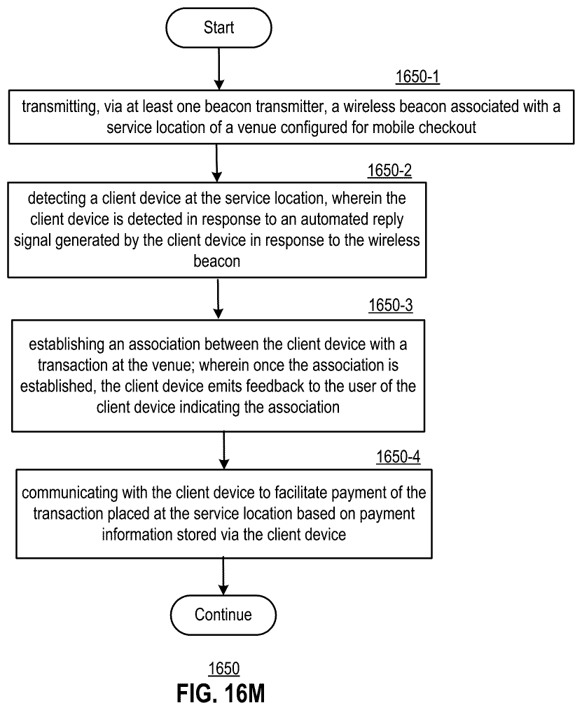

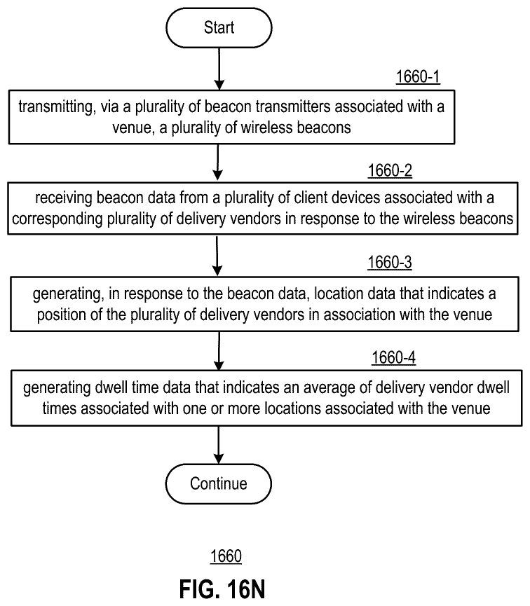

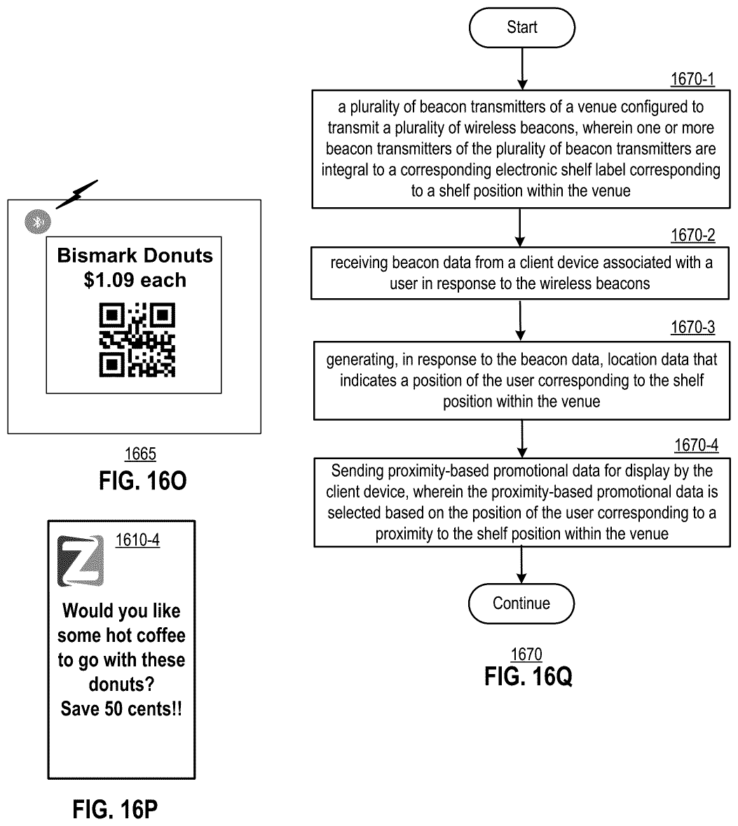

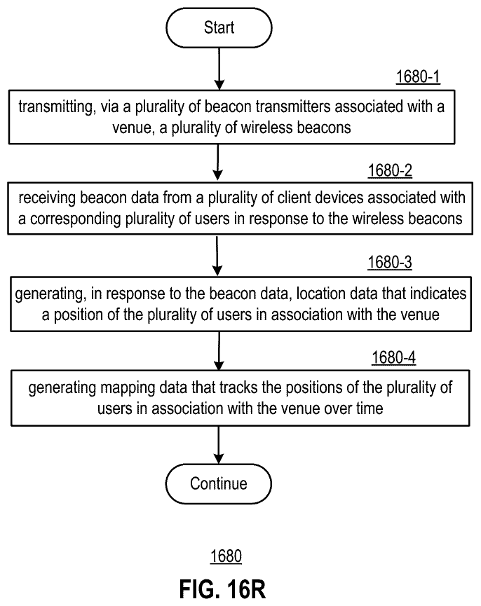

FIG. 16A presents a pictorial/block diagram representation of an example system. In particular, this system is shown can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E and 15A-15K. Beacon transmitters 102 are positioned at different locations inside or outside of a venue. The wireless beacons generated by these beacon transmitters are received by one or more client devices 300 associated with corresponding users (and which can also include vehicle client devices 300-1). An intelligent venue application or other software of the client devices 300 communicates beacon data with the processing system 100 in order to indicate (e.g., to allow the processing system 100 to determine) the positions of these client devices—and by implication the position of the corresponding users including customers and/or delivery vendors. The positions so determined can be used for many different purposes.

In various examples, these user/delivery vendor positions can be used in generating foot traffic patterns, user time/motion studies, not only for individual users but also accumulated for multiple users to generate reports by time of day, day of week, day of the month that can be displayed. Other statistics such as dwell time can be calculated for specific locations such as order and pick-up locations, mobile checkout locations, tables, counters or bars for table, counter or bar service, product displays or kiosks, drive through locations including ordering and pick-up, outside pick-up locations, gas pumps and recharging stations and/or other locations of interest associated with a venue. Any of this information can be used to determine trends, and/or approve the efficiency and quality of service provided by the venue.

In addition, the position of the user at the venue can be used to generate geo-fenced promotions or notifications when a user is in proximity to a display, a service kiosk, a mobile check-out location, a service counter, or other specific location, either inside or outside of the venue, having associated promotions that are specific to this location in the venue.

In various embodiments the processing system 100 operates by:
receiving beacon data from a client device associated with a user in response to the wireless beacons;
generating, in response to the beacon data, location data that indicates a position of the user in association with the venue; and
generating mapping data that tracks the position of the user in association with the venue over time.

In various embodiments the processing system 100 includes: a plurality of beacon transmitters associated with a structure configured to transmit a plurality of wireless beacons; and a processing system that includes a memory that stores operational instructions corresponding to an intelligent structure application and a processing circuit configured to execute the operational instructions, wherein the operational instructions cause the processing circuit to perform operation that include:
receiving beacon data from client devices associated with a corresponding plurality of users in response to the wireless beacons;
generating, in response to the beacon data, location data that indicates positions of the plurality of users in association with the structure; and
generating mapping data that tracks the positions of the plurality of users in association with the structure over time.

In addition or in the alternative to any of the foregoing, the mapping data includes display data for display by a display device.

In addition or in the alternative to any of the foregoing. the mapping data is accumulated for a plurality of users that include the user.

In addition or in the alternative to any of the foregoing. the mapping data indicates a traffic pattern of the user within the venue.

In addition or in the alternative to any of the foregoing. the mapping data indicates a traffic pattern of the user outside the venue.

In addition or in the alternative to any of the foregoing. the mapping data indicates a traffic pattern of the user within the venue and outside the venue.

In various embodiments the processing system 100 operates by:
receiving beacon data from a plurality of client devices associated with a corresponding plurality of users in response to the wireless beacons;
generating, in response to the beacon data, location data that indicates a position of the plurality of users in association with the venue; and
generating dwell time data that indicates an average of user dwell times associated with one or more locations associated with the venue.

In addition or in the alternative to any of the foregoing, the one or more locations include a pick-up location.

In addition or in the alternative to any of the foregoing, the one or more locations include an order location.

In addition or in the alternative to any of the foregoing, the one or more locations include a table or a bar.

In various embodiments the processing system 100 operates by:
receiving beacon data from a plurality of client devices associated with a corresponding plurality of users in response to the wireless beacons outside a venue;
generating, in response to the beacon data, location data that indicates a position of the plurality of users in association with the venue; and
generating dwell time data that indicates an average of user dwell times associated with one or more locations associated with the venue.

In addition or in the alternative to any of the foregoing, the one or more locations include a pick-up location.

In addition or in the alternative to any of the foregoing, the one or more locations include an order location.

In addition or in the alternative to any of the foregoing, the one or more locations include a gas pump or recharging station.

In various embodiments the processing system 100 operates by:
receiving beacon data from a plurality of client devices associated with a corresponding plurality of delivery vendors in response to the wireless beacons;
generating, in response to the beacon data, location data that indicates a position of the plurality of delivery vendors in association with the venue; and
generating dwell time data that indicates an average of delivery vendor dwell times associated with one or more locations associated with the venue.

In addition or in the alternative to any of the foregoing, the one or more locations include a pick-up location.

In various embodiments the processing system 100 operates by:
transmitting, via a plurality of beacon transmitters of a venue, a plurality of wireless beacons, wherein one or more beacon transmitters of the plurality of beacon transmitters are integral to a corresponding electronic shelf label corresponding to a shelf position within the venue;
receiving beacon data from a client device associated with a user in response to the wireless beacons;
generating, in response to the beacon data, location data that indicates a position of the user corresponding to the shelf position within the venue; and
sending proximity-based promotional data for display by the client device, wherein the proximity-based promotional data is selected based on the position of the user corresponding to the shelf position within the venue.

In addition or in the alternative to any of the foregoing, the shelf position corresponds to a product display.

In addition or in the alternative to any of the foregoing, the proximity-based promotional data is based on the products associated with the product display.

In various embodiments the processing system 100 operates by:
receiving beacon data from a client device associated with a user in response to the wireless beacons;
generating, in response to the beacon data, location data that indicates a position of the user; and
sending proximity-based promotional data for display by the client device, wherein the proximity-based promotional data is selected based on the position of the user corresponding to a proximity to a location associated with the venue.

In addition or in the alternative to any of the foregoing, the one or more locations includes a kiosk.

In addition or in the alternative to any of the foregoing, the one or more locations includes a product display.

In addition or in the alternative to any of the foregoing, the one or more locations includes a mobile check-out location.

In various embodiments the processing system 100 operates by:
detecting a client device at the service location, wherein the client device is detected in response to an automated reply signal generated by the client device in response to the wireless beacon;
establishing an association between the client device with a transaction at the venue; wherein once the association is established, the client device emits feedback to the user of the client device indicating the association; and
communicating with the client device to facilitate payment of the transaction placed at the service location based on payment information stored via the client device.

In addition or in the alternative to any of the foregoing, the payment information is stored via an electronic wallet of the client device.

In addition or in the alternative to any of the foregoing, the payment of the order is facilitated automatically without requiring interaction with the user of the client device.

In addition or in the alternative to any of the foregoing, the feedback to the user includes an audible alert.

FIG. 16B presents a pictorial/block diagram representation 1600 of an example system of client device position tracking over time. In the example shown, a venue has beacon transmitters 102 at a point of entry, a mobile checkout location and a salad bar, an optionally other locations that can further be used to determine accurate positions of the user within the venue whether by proximity, trigonometric algorithms, etc. A user with a client device has entered the venue at the entry point and has traversed the venue along the track indicated by the dashed line. As previously indicated, this user's position can be used to generate a motion study that can be displayed via a display device such as display device 106, used to generate dwell times and other statistics, generate geo-fenced promotions when the user is in proximity to selected locations such as the salad bar, facilitate mobile checkout at the checkout location, and for other purposes, etc.

FIG. 16C presents a tabular representation of an example system of position data generated based on client device position tracking over time. FIG. 16D presents a pictorial diagram representation of an example of client device tracking at a drive-thru location having one or more beacon transmitters 102 that can be used to generate statistics such as dwell times—at order, payment and/or pickup location, the time in line, the number of cars in line as a function of time and/or date, etc.

FIG. 16E presents a pictorial diagram representation of an example of client device tracking at a gas pump having one or more beacon transmitters 102 that can be used to generate statistics such as dwell time at a pump, payment times, time inside the venue and/or otherwise away from the pump based on data indicating a refill has commenced, but the user position is inside the venue or located somewhere other than in proximity to the pump, the number of cars in line for a pump as a function of time and/or date, etc. As previously discussed, proximity to a pump can trigger push promotions, loyalty reward participations, etc.

FIG. 16F presents a pictorial diagram representation of an example of a mobile checkout location 1608 having one or more beacon transmitters. Not only can check-out statistics such as dwell time be determined, user proximity to such a mobile check-out location 1608 can be used to trigger and facilitate payment for venue transactions.

FIGS. 16G-16I present pictorial diagram representations of example screen displays of a client device, such as client device 300. In screen display 1610-1 a user has completed a transaction at a mobile check-out location. In screen display 1610-2 a user in proximity to the salad bar has received proximity-based promotional data pushing the sale of a drink to complement the salad. In screen display 1610-3 a user in proximity to the mobile checkout location has received proximity-based promotional data pushing the sale of mints that are located nearby.

FIG. 16J presents a flowchart representation 1620 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16I.

Step 1620-1 includes transmitting, via a plurality of beacon transmitters of a venue, a plurality of wireless beacons. Step 1620-2 includes receiving beacon data from a client device associated with a user in response to the wireless beacons. Step 1620-3 includes generating, in response to the beacon data, location data that indicates a position of the user in association with the venue. Step 1620-4 includes generating mapping data that tracks the position of the user in association with the venue over time.

FIG. 16K presents a flowchart representation of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16J.

Step 1630-1 includes transmitting, via a plurality of beacon transmitters of a venue, a plurality of wireless beacon. Step 1630-2 includes receiving beacon data from a plurality of client devices associated with a corresponding plurality of users in response to the wireless beacons. Step 1630-3 includes generating, in response to the beacon data, location data that indicates a position of the plurality of users in association with the venue. Step 1630-4 includes generating dwell time data that indicates an average of user dwell times associated with one or more locations associated with the venue.

FIG. 16L presents a flowchart representation 1640 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16K.

Step 1640-1 includes transmitting, via a plurality of beacon transmitters of a venue, a plurality of wireless beacons. Step 1640-2 includes receiving beacon data from a client device associated with a user in response to the wireless beacons. Step 1640-3 includes generating, in response to the beacon data, location data that indicates a position of the user. Step 1640-4 includes sending proximity-based promotional data for display by the client device, wherein the proximity-based promotional data is selected based on the position of the user corresponding to a proximity to a location associated with the venue.

FIG. 16M presents a flowchart representation 1650 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16L.

Step 1650-1 includes transmitting a wireless beacon associated with a service location of a venue configured for mobile checkout. Step 1650-2 includes detecting a client device at the service location, wherein the client device is detected in response to an automated reply signal generated by the client device in response to the wireless beacon. Step 1650-3 includes establishing an association between the client device with a transaction at the venue; wherein once the association is established, the client device emits feedback to the user of the client device indicating the association. Step 1650-4 includes communicating with the client device to facilitate payment of the transaction placed at the service location based on payment information stored via the client device.

FIG. 16N presents a flowchart representation 1660 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16M.

Step 1660-1 includes transmitting, via a plurality of beacon transmitters of a venue, a plurality of wireless beacons. Step 1660-2 includes receiving beacon data from a plurality of client devices associated with a corresponding plurality of delivery vendors in response to the wireless beacons. Step 1660-3 includes generating, in response to the beacon data, location data that indicates a position of the plurality of delivery vendors in association with the venue. Step 1660-4 includes generating dwell time data that indicates an average of delivery user dwell times associated with one or more locations associated with the venue.

In addition or in the alternative to any of the foregoing, the one or more locations include a pick-up location.

FIG. 16O presents a pictorial/block diagram representation 1665 of an example electronic shelf label. Electronic Shelf Labels (ESL) are digital price tags that are used in retail stores to display product information such as prices, promotions, and product details. These labels use electronic ink or e-paper technology, allowing for easy updates and customization of pricing and product information.

ESL enable retailers to update prices in real-time, eliminating the need for manual price changes and reducing pricing errors. With ESL, retailers can easily change prices, update promotions, and display product information across multiple stores simultaneously, saving time and effort. ESL provide accurate and up-to-date product information, allowing customers to make informed decisions. They also enable retailers to display personalized promotions and offers based on customer preferences. By eliminating paper tags and reducing the labor required for price changes, retailers can achieve significant cost savings in the long run.

In the example shown the ESL incorporates a beacon transmitter 102 that can be registered to the shelf location of the ESL (which can include, for example, an aisle identifier, shelf identifier and/or bin identifier), the product(s) being offered at the shelf location and/or associated with proximity-based promotional data that corresponds to the product(s) being offered at the shelf location. In carious examples, the beacon transmitter can not only be incorporated within the housing of the ESL, but also share one or more components, such as a memory, a processing circuit, a wireless transceiver and/or a power source.

FIG. 16P presents a pictorial diagram representation of an example screen display. In particular, an example screen display 1610-4 of a client device 300 is shown after the client device receives a wireless beacon from the ESL 1665 shown in FIG. 160. In this case, a customer looking at the donuts in this shelf location is presented with proximity-based promotional data that offers a discount on hot coffee to complement the sale of the donuts that are displayed at this location.

FIG. 16Q presents a flowchart representation 1670 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16P.

Step 1670-1 includes transmitting, via a plurality of beacon transmitters of a venue, a plurality of wireless beacons, wherein one or more beacon transmitters of the plurality of beacon transmitters are integral to a corresponding electronic shelf label corresponding to a shelf position within the venue. Step 1670-2 includes receiving beacon data from a client device associated with a user in response to the wireless beacons. Step 1670-3 includes generating, in response to the beacon data, location data that indicates a position of the user corresponding to the shelf position within the venue. Step 1670-4 includes sending proximity-based promotional data for display by the client device, wherein the proximity-based promotional data is selected based on the position of the user corresponding to the shelf position within the venue.

In addition or in the alternative to any of the foregoing, the shelf position corresponds to a product display.

In addition or in the alternative to any of the foregoing, the proximity-based promotional data is based on the products associated with the product display.

In various examples, the intelligent venue system is a spatial information system that provides data and insights about the location, arrangement, and relationships of objects or entities in each space. In the context of geolocation, this system is an outdoor and indoor high precision location information service within a radius of 8-10 inches. In various examples, the venue can be a quick serve restaurant, traditional restaurant that takes reservations and/or processes orders for pick-up or to-go, a big box retailer, convenience store, gas station and/or other hospitality location or venue.

The venue can be characterized by physical locations outside and/or inside. These locations can be identified as zones of which guests enter and exit these zones. Zones can be defined based on different modes of use such as venue, parking lots, curbside pickup parking space, drive-through, front entrance, reception, lobby or waiting area, bar, patio, table, seat, counter pickup area, kiosk, check-out location, shelf position, aisle, bin position, and/or poolside and beach table or chair location, etc. Each of these zones can have their individual functions and operational requirements within their perspective market segment. In various examples, the intelligent venue system is implemented via an app that is downloadable to a client device with a modular design having an API library that can accommodate different use cases (e.g., any of the functions and features facilitated by a client device 300 and/or processing system 100 previously described herein) within each of these individual zones or a combined experience across the zones of a venue. Examples of such APIs are listed below:
Venue provides details of the venue and the location of a device with the having the App and its position in relation to other objects within the established spatial range.
Table provides details of the table and the location of a device having the app and its position in relation to other objects within the established spatial range.
Table seat and Bar seat provides details of the seat and the location of a device having the app and its position in relation to other objects within the established spatial range.
Lobby/Host provides details of the lobby or host stand and the location of a device having the app and its position in relation to other objects within the established spatial range.
Drive-Through provides details of the drive-through and the location of a device having the app and its position in relation to other objects within the established spatial range.
Curbside Pickup provides details of the curbside parking space and the location of a device having the app and its position in relation to other objects within the established spatial range.
Order and Pickup Counter provides details of the counter and the locations of a device containing the app and its position in relation to other objects within the established spatial range.
Guest Room provides details of the guest room and the location of a device having the app its position in relation to other objects within the established spatial range.
Mobile SDK/API provides the required Software Development Kit (SDK) and API library for integration with mobile application. This API provides triggers and responses to mobile application at specific times based on spatial position in relation to other objects within the established spatial range.
Dynamic Table Mapping provides location details of the table placement within a venue. This feature can include a real-time table floor map based on telemetry readings from a venue tablet implementation of a client device 300 placed on each table or scanners placed in strategic locations within the venue.
Order Sequence provides the ability to receive menu orders, hold the order in queue until the guest is within the travel time period required to preparing the meal. When a guest is within the required travel time to prepare the meal, the order can be processed. This allows the restaurant to only start preparing the meal when the guest/delivery driver in on their way to the restaurant so they can provide the freshest meal possible and priorities orders places at the count.
Foot Traffic Analytics, provide the foot traffic information like dwell time, most used areas of a venue, queue times based on entering and exiting a given zone of a sensor.
Go is a mobile application used to register, program, configure, calibrate, and validate the operation of beacon transmitters, venue tablets and other devices (when included) and to other report, monitor and maintain the system.

The processing system 100 can be implemented in a cloud computing environment. In various examples, the cloud can contain information about digital sensors, their location, configuration, mode of use, etc., in a SQL database. Devices can communicate through an API gateway to request data about the sensors and report on these sensors. The cloud components can process all incoming data to determine positions of people and things in each venue under management. The raw data can also be processed to determine trends and other interesting data points such as time to complete a process. In addition to raw data processing, the cloud components can also include a support portal used to manage the various venues, monitor their sensor health, determine battery lifetime and identify when sensors are lost, etc.

The set-up of the intelligent venue can begin by placing and configuring the various sensors (e.g., the beacon transmitters 102). This can be accomplished using an application (app) downloaded to a client device 300 (such as a tablet or phone) through an app store. This application can walk managers/venue workers through the process of installing and configuring the intelligent venue.

In various embodiments, the client device 300 includes: a touch screen; a first wireless interface (e.g., a Bluetooth or UWB transceiver) for communicating with a plurality of beacon transmitters of the intelligent venue, wherein the plurality of beacon transmitters transmit a plurality of wireless beacons; a second wireless interface (e.g., a WiFi or 5G transceiver) configured to communicate with a processing system of the intelligent venue; a memory configured to store a configuration application that includes operational instructions; and at least one processing circuit configured to execute the operational instructions. In various examples, the operational instructions cause the processing circuit to perform operations that include:
generating, via the touch screen, a graphical user interface that presents display screens and generates commands in response to user interactions;
receiving, via the graphical user interface, beacon transmitter registration data that indicates modes of use for each of the plurality of beacon transmitters;
sending, via the first wireless interface and based on the beacon transmitter registration data, an initial configuration of wireless settings for each of the plurality of beacon transmitters;
performing, utilizing the first wireless interface and via the graphical user interface, a calibration of the wireless settings of each of the of the plurality of beacon transmitters;
performing, utilizing the first wireless interface and via the graphical user interface, an operational validation of each of the of the plurality of beacon transmitters; and
based on the operational validation of each of the of the plurality of beacon transmitters, transmitting via the second wireless interface, the wireless settings and the beacon transmitter registration data to the processing system.

In addition or in the alternative to any of the foregoing, the client device includes a camera configured to capture optical data corresponding to each of the plurality of beacon transmitters, wherein the optical data includes beacon identification data that uniquely identifies each one of the plurality of beacon transmitters; and wherein the operations further include: generating a mapping of the beacon identification for each of the plurality of beacon transmitters to the beacon transmitter registration data for each of the plurality of beacon transmitters; and transmitting the mapping to the processing system.

In addition or in the alternative to any of the foregoing, the beacon transmitter registration data corresponding to one of the plurality beacon transmitters indicates one of the modes of use corresponding to an installation under a table of the venue, and wherein the table can be repositioned.

In addition or in the alternative to any of the foregoing, the beacon transmitter registration data corresponding to one of the plurality beacon transmitters indicates that the one of the plurality beacon transmitters corresponds to a table position at the table.

In addition or in the alternative to any of the foregoing, the beacon transmitter registration data corresponding to one of the plurality beacon transmitters indicates that a composition of the table.

In addition or in the alternative to any of the foregoing, the beacon transmitter registration data corresponding to one of the plurality beacon transmitters indicates that a shape of the table.

In addition or in the alternative to any of the foregoing, the beacon transmitter registration data corresponding to one of the plurality beacon transmitters indicates that a size of the table.

In addition or in the alternative to any of the foregoing, the beacon transmitter registration data corresponding to one of the plurality beacon transmitters indicates one of the modes of use corresponding to an installation at a fixed location.

In addition to of in the alternative to any of the foregoing, a system, such as the system of FIG. 16A, operates in accordance any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16Q. In various examples, such a system includes a plurality of beacon transmitters of a venue (inside and/or outside) configured to transmit a plurality of wireless beacons and a processing system that includes a memory that stores operational instructions corresponding to an intelligent venue application and a processing circuit configured to execute the operational instructions, wherein the operational instructions cause the processing circuit to perform operation that include:
receiving beacon data from client devices associated with a corresponding plurality of users in response to the wireless beacons;
generating, in response to the beacon data, location data that indicates positions of the plurality of users in association with the venue; and
generating mapping data that tracks the positions of the plurality of users in association with the venue over time.

In addition or in the alternative to any of the foregoing, the mapping data is accumulated for the plurality of users and indicates at least one of: a traffic pattern of the users within the venue; a traffic pattern of the users outside the venue or a traffic patterns of the users within the venue and outside the venue.

In addition or in the alternative to any of the foregoing, the operations further include: generating dwell time data that indicates an average of the users dwell times associated with one or more locations associated with the venue.

In addition or in the alternative to any of the foregoing, the one or more locations include at least one of a pick-up location; an order location; a table position; a bar position; a gas pump; or a vehicle recharging station.

In addition or in the alternative to any of the foregoing, the operations further include:
receiving, from client devices associated with a second plurality of users, a plurality of orders corresponding to a venue; receiving an indication of a travel route of the second plurality of users to the venue; and fulfilling the orders in accordance with a schedule that is based on estimated times of arrival corresponding to the second plurality of users.

In addition or in the alternative to any of the foregoing, the operations further include:
determining the estimated times of arrival based on the position of the second plurality of users along their corresponding travel routes; and wherein the schedule is further based on estimated preparation times of items included in second plurality of users' orders.

In addition or in the alternative to any of the foregoing, the schedule is further based on one or more of food quality at the time of fulfillment, a dwell time for pick-up or delivery, and/or kitchen staff operations.

In addition or in the alternative to any of the foregoing, the operations further include:
sending proximity-based promotional data for display by the client devices, wherein the proximity-based promotional data is selected based on the position of the user corresponding to a proximity to one or more locations associated with the venue; and wherein the one or more locations include a kiosk; a product display or a mobile check-out location.

In addition or in the alternative to any of the foregoing, at least one beacon transmitter of the plurality of beacon transmitters is configured to transmit a wireless beacon associated with a service location of a venue configured for mobile checkout; and wherein the operations further include: detecting one of the client devices at the service location, wherein the one of the client devices is detected in response to an automated reply signal generated by the one of the client devices in response to the wireless beacon; establishing an association between the one of the client devices with a transaction at the venue; wherein once the association is established, the one of the client devices emits feedback indicating the association; and communicating with the one of the client devices to facilitate payment of the transaction placed at the service location based on payment information stored via the one of the client devices.

In addition or in the alternative to any of the foregoing, the payment information is stored via an electronic wallet of the one of the client devices; wherein the payment of the transaction is facilitated automatically without requiring interaction with a user of the one of the client devices and wherein the feedback includes an audible alert.

In addition or in the alternative to any of the foregoing, the operations further include: generating dwell time data that indicates an average of delivery vendor dwell times associated with one or more locations associated with the venue; wherein the one or more locations include a pick-up location.

In addition or in the alternative to any of the foregoing, the operations further include: receiving a plurality of orders corresponding to the venue for delivery by a plurality of delivery vendors, each delivery vendor corresponding to one of more of the plurality of orders; receiving, for each of the plurality of delivery vendors, an indication of a travel time to the venue; and fulfilling the plurality of orders in accordance with a schedule that is generated based on travel time to the venue corresponding to the plurality of delivery vendors.

In addition or in the alternative to any of the foregoing, the operations further include: determining estimated times of arrival based on the position of the plurality of delivery vendors along their corresponding travel routes to the venue; wherein fulfilling the plurality of orders is further based on estimated preparation times of items included in the plurality of orders; wherein an order queue is generated based on the schedule and updated as orders are prepared and fulfilled; and wherein the schedule is further based on additional orders received from guests at the venue.

In addition or in the alternative to any of the foregoing, the plurality of orders are received from one or more order delivery platforms; and wherein the indication of the travel time to the venue corresponding to the plurality of delivery vendors is received from the one or more order delivery platforms.

In addition or in the alternative to any of the foregoing, the operations further include: receiving a plurality of orders corresponding to the venue for delivery by a plurality of delivery vendors, each delivery vendor corresponding to one of more of the plurality of orders; generating a schedule of order completion for the plurality of orders; and communicating, based on the schedule of order completion, an estimated order completion time to each delivery vendor corresponding to the one of more of the plurality of orders.

In addition or in the alternative to any of the foregoing, the location data indicates the position of the user corresponding to a shelf position within the venue; and wherein the operations further include sending proximity-based promotional data for display by the client device, wherein the proximity-based promotional data is selected based on the position of the user corresponding to the shelf position within the venue.

In addition or in the alternative to any of the foregoing, the shelf position corresponds to a product display and wherein the proximity-based promotional data is based on the products associated with the product display.

In addition or in the alternative to any of the foregoing, another client devices includes a processor configured to perform client device operations that include: generating, via a touch screen, a graphical user interface that presents display screens and generates commands in response to user interactions; receiving, via the graphical user interface, beacon transmitter registration data that indicates modes of use for each of the plurality of beacon transmitters; sending, via a first wireless interface and based on the beacon transmitter registration data, an initial configuration of wireless settings for each of the plurality of beacon transmitters; performing, utilizing the first wireless interface and via the graphical user interface, a calibration of the wireless settings of each of the of the plurality of beacon transmitters; performing, utilizing the first wireless interface and via the graphical user interface, an operational validation of each of the of the plurality of beacon transmitters; and based on the operational validation of each of the plurality of beacon transmitters, transmitting via a second wireless interface, the wireless settings and the beacon transmitter registration data to the processing system.

In addition or in the alternative to any of the foregoing, the client device operations further include: capturing optical data corresponding to each of the plurality of beacon transmitters, wherein the optical data includes beacon identification data that uniquely identifies each of the plurality of beacon transmitters; generating a mapping of the beacon identification for each of the plurality of beacon transmitters to the beacon transmitter registration data for each of the plurality of beacon transmitters; and transmitting the mapping to the processing system.

In addition or in the alternative to any of the foregoing, the beacon transmitter registration data corresponding to one of the plurality beacon transmitters indicates one of the modes of use corresponding to an installation under a table of the venue and further indicates at least one of: a positioning of the table; a table position at the table; a composition of the table; a shape of the table; or a size of the table.

FIG. 16R presents a flowchart representation 1680 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K and 16A-16Q.

Step 1680-1 includes transmitting, via a plurality of beacon transmitters of a venue, a plurality of wireless beacon. Step 1680-2 includes receiving beacon data from a plurality of client devices associated with a corresponding plurality of users in response to the wireless beacons. Step 1680-3 includes generating, in response to the beacon data, location data that indicates a position of the plurality of users in association with the venue. Step 1680-4 includes generating mapping data that tracks the positions of the plurality of users in association with the venue over time.

In addition or in the alternative to any of the foregoing, the mapping data is accumulated for the plurality of users and indicates at least one of: a traffic pattern of the users within the venue; a traffic pattern of the users outside the venue or a traffic patterns of the users within the venue and outside the venue.

In addition or in the alternative to any of the foregoing, the method further includes: generating dwell time data that indicates an average of the users dwell times associated with one or more locations associated with the venue.

In addition or in the alternative to any of the foregoing, the one or more locations include at least one of a pick-up location; an order location; a table position; a bar position; a gas pump; or a vehicle recharging station.

In addition or in the alternative to any of the foregoing, the method further includes: receiving, from client devices associated with a second plurality of users, a plurality of orders corresponding to a venue; receiving an indication of a travel route of the second plurality of users to the venue; and fulfilling the orders in accordance with a schedule that is based on estimated times of arrival corresponding to the second plurality of users.

In addition or in the alternative to any of the foregoing, the method further includes: determining the estimated times of arrival based on the position of the second plurality of users along their corresponding travel routes; and wherein the schedule is further based on estimated preparation times of items included in second plurality of users' orders.

In addition or in the alternative to any of the foregoing, the schedule is further based on one or more of food quality at the time of fulfillment, a dwell time for pick-up or delivery, and/or kitchen staff operations.

In addition or in the alternative to any of the foregoing, the method further includes: sending proximity-based promotional data for display by the client devices, wherein the proximity-based promotional data is selected based on the position of the user corresponding to a proximity to one or more locations associated with the venue; and wherein the one or more locations include a kiosk; a product display or a mobile check-out location.

In addition or in the alternative to any of the foregoing, at least one beacon transmitter of the plurality of beacon transmitters is configured to transmit a wireless beacon associated with a service location of a venue configured for mobile checkout; and wherein the method further includes: detecting one of the client devices at the service location, wherein the one of the client devices is detected in response to an automated reply signal generated by the one of the client devices in response to the wireless beacon; establishing an association between the one of the client devices with a transaction at the venue; wherein once the association is established, the one of the client devices emits feedback indicating the association; and communicating with the one of the client devices to facilitate payment of the transaction placed at the service location based on payment information stored via the one of the client devices.

In addition or in the alternative to any of the foregoing, the payment information is stored via an electronic wallet of the one of the client devices; wherein the payment of the transaction is facilitated automatically without requiring interaction with a user of the one of the client devices and wherein the feedback includes an audible alert.

In addition or in the alternative to any of the foregoing, the method further includes: generating dwell time data that indicates an average of delivery vendor dwell times associated with one or more locations associated with the venue; wherein the one or more locations include a pick-up location.

In addition or in the alternative to any of the foregoing, the method further includes: receiving a plurality of orders corresponding to the venue for delivery by a plurality of delivery vendors, each delivery vendor corresponding to one of more of the plurality of orders; receiving, for each of the plurality of delivery vendors, an indication of a travel time to the venue; and fulfilling the plurality of orders in accordance with a schedule that is generated based on travel time to the venue corresponding to the plurality of delivery vendors.

In addition or in the alternative to any of the foregoing, the method further includes: determining estimated times of arrival based on the position of the plurality of delivery vendors along their corresponding travel routes to the venue; wherein fulfilling the plurality of orders is further based on estimated preparation times of items included in the plurality of orders; wherein an order queue is generated based on the schedule and updated as orders are prepared and fulfilled; and wherein the schedule is further based on additional orders received from guests at the venue.

In addition or in the alternative to any of the foregoing, the plurality of orders are received from one or more order delivery platforms; and wherein the indication of the travel time to the venue corresponding to the plurality of delivery vendors is received from the one or more order delivery platforms.

In addition or in the alternative to any of the foregoing, the method further includes: receiving a plurality of orders corresponding to the venue for delivery by a plurality of delivery vendors, each delivery vendor corresponding to one of more of the plurality of orders; generating a schedule of order completion for the plurality of orders; and communicating, based on the schedule of order completion, an estimated order completion time to each delivery vendor corresponding to the one of more of the plurality of orders.

In addition or in the alternative to any of the foregoing, the location data indicates the position of the user corresponding to a shelf position within the venue; and wherein the operations further include sending proximity-based promotional data for display by the client device, wherein the proximity-based promotional data is selected based on the position of the user corresponding to the shelf position within the venue.

In addition or in the alternative to any of the foregoing, the shelf position corresponds to a product display and wherein the proximity-based promotional data is based on the products associated with the product display.

In addition or in the alternative to any of the foregoing, another client devices includes a processor configured to perform client device operations that include: generating, via a touch screen, a graphical user interface that presents display screens and generates commands in response to user interactions; receiving, via the graphical user interface, beacon transmitter registration data that indicates modes of use for each of the plurality of beacon transmitters; sending, via a first wireless interface and based on the beacon transmitter registration data, an initial configuration of wireless settings for each of the plurality of beacon transmitters; performing, utilizing the first wireless interface and via the graphical user interface, a calibration of the wireless settings of each of the of the plurality of beacon transmitters; performing, utilizing the first wireless interface and via the graphical user interface, an operational validation of each of the of the plurality of beacon transmitters; and based on the operational validation of each of the plurality of beacon transmitters, transmitting via a second wireless interface, the wireless settings and the beacon transmitter registration data to the processing system.

In addition or in the alternative to any of the foregoing, the client device operations further include: capturing optical data corresponding to each of the plurality of beacon transmitters, wherein the optical data includes beacon identification data that uniquely identifies each of the plurality of beacon transmitters; generating a mapping of the beacon identification for each of the plurality of beacon transmitters to the beacon transmitter registration data for each of the plurality of beacon transmitters; and transmitting the mapping to the processing system.

In addition or in the alternative to any of the foregoing, the beacon transmitter registration data corresponding to one of the plurality beacon transmitters indicates one of the modes of use corresponding to an installation under a table of the venue and further indicates at least one of: a positioning of the table; a table position at the table; a composition of the table; a shape of the table; or a size of the table.

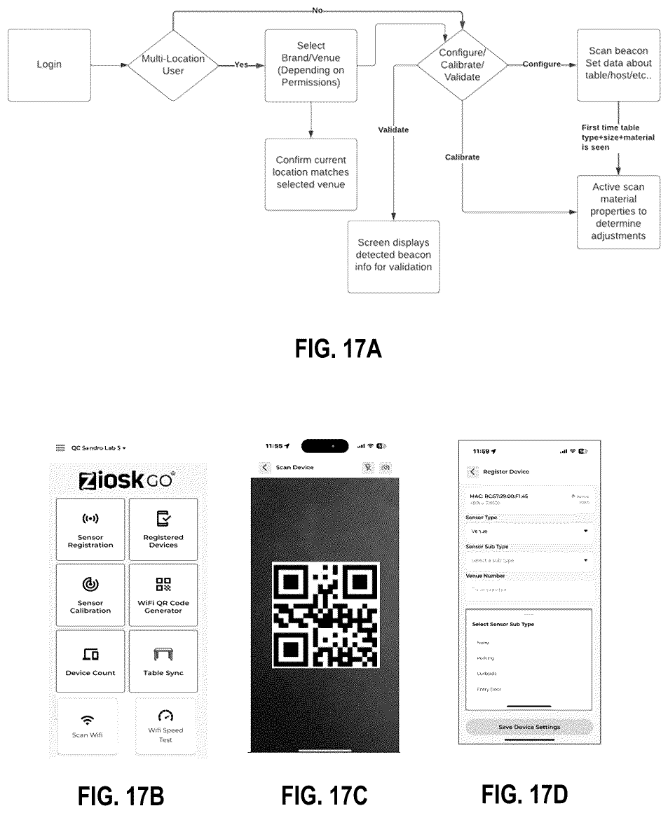

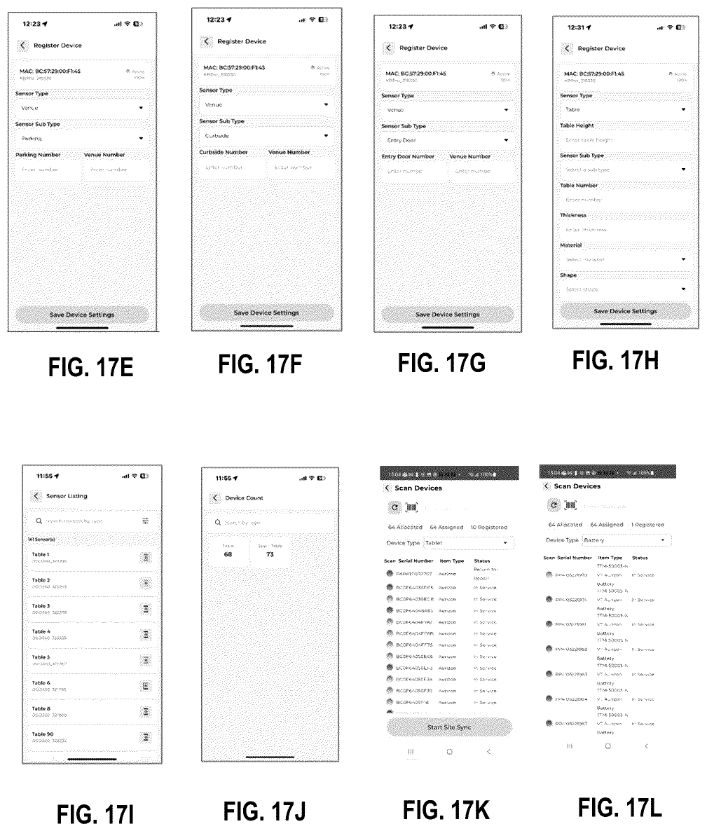

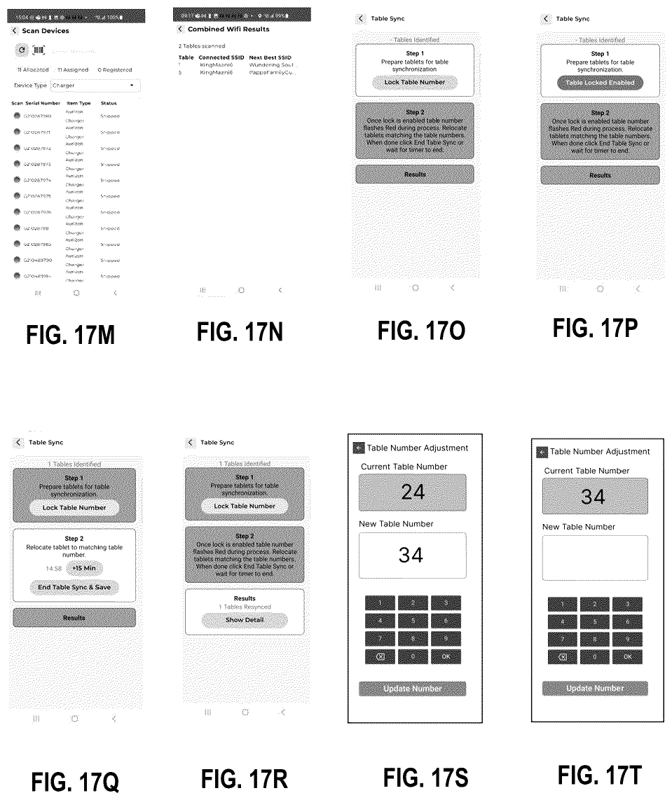

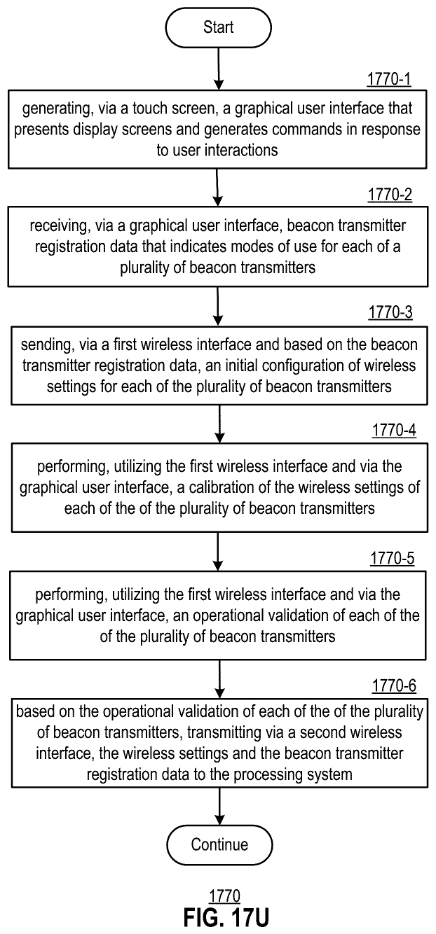

FIG. 17A presents a flow diagram of an example method. An example is presented for use with a configuration app. After login and determining the location, the app has three major functions. It allows registering beacon transmitters, it can perform calibration to adjust for different materials (e.g. of counters, chairs and tables within a venue), and it provides a test/validation screen to let the user confirm that the beacons can be properly detected.

FIGS. 17B-17T present examples of screen displays presented by a configuration app. In FIG. 17B, a menu of functions is presented that facilitate sensor registration and calibration and scans of registered devices to validate their operability. Other functions include a device count, table synchronization, WiFi scanning, speed testing and QR code generation. In FIG. 17C, the user is registering a new sensor (e.g., a beacon transmitter 102) and is using the client device's camera to scan the sensors QR code (e.g., on the sensor itself and/or on the device's packaging) to obtain corresponding beacon identification data that uniquely identifies the beacon transmitter. In FIG. 17D, the user begins to configure the device for its intended mode of use outside a venue, such as at a parking location as further shown in FIG. 17E, curbside location as shown further in FIG. 17F or near an entry door as further shown in FIG. 17G.

In FIG. 17H, the user is setting up a sensor with a table mode of use. The user can configure (register) the sensor as to the type of table, e.g. fixed booth or bar location, moveable table, as well as the table thickness, material, shape and table number. This information can be compared to a look-up table or other database to set initial device settings including frequency and/or power level. After setup, a calibration process can be run by placing the client device 300 in an operational position. For a table sensor mounted beneath a table, this could be on the surface of the table in proximity to the sensor. The wireless beacon generated by the device can be received by the client device 300, measured and compared to one or more ranges of expected nominal settings corresponding to desired operation. Variations from these nominal ranges can be corrected during this calibration to control the operation of the sensor(s) to be within acceptable range(s).

FIG. 171 shows a sensor listing corresponding to a number of tables that have been configured. FIG. 17J presents a device count that includes 68 tables and 73 seats. In addition to beacon transmitters, a venue can employ venue specific client devices such as dedicated tablets that are configured to perform the features client device 300 while within the venue. FIG. 17K presents a scan of such devices. FIG. 17L presents a scan of only battery-power devices. FIG. 17M of only devices that are connected to a charger.

FIG. 17N presents the results of a WiFi scan that can also include a speed test and a check of firewall settings to ensure that the processing system 100 can be accessed during client device operation. This WiFi scan can be repeated for each venue location, (e.g., hostess stand, table location, pick-up location, etc.), so that the best WiFi access point can be selected and correlated for use with each separate location.

After the venue staff have completed the sensor registration process and assigned a table sensor or sensors with the physical table number corresponding to the location on the floor, such synchronization can be lost. This is commonly due to tables being moved to another location and not returned to their original position when cleaning the floors, merging tables, or swapping, etc. As a result, the table number position that was established during the initial installation and registration of sensors (e.g., the beacon transmitters 102) no longer matches the actual table position on the floor.

FIGS. 17O-17R present an automatic process for using venue tablets to automatically resynchronize the table numbers. During this process, tablets corresponding to the different table numbers are relocated to the tables at the correct locations. At the end of the process, the table sensors for each table that was moved are reconfigured to the actual floor position indicated by the tablet.

FIGS. 17S and 17T present a process of manual table number reassignment. In the example shown, prior table #24 has been moved and is renumbered as table #34 corresponding to its new floor location. In this case, the beacon transmitters previously associated with table #24 in a mapping/database of the venue are now indicated to correspond to table #34.

FIG. 17U presents a flowchart representation 1670 of an example method. In particular, this method can be used in addition or in the alternative to any of the foregoing examples, including the examples provided in conjunction with FIGS. 1A-1L, 2A-2J, 3A-3F, 4A-4F, 5A-5F, 6A-6E, 7A-7F, 8A-8F, 9A-9L, 10A-10F, 11A-11E, 12A-12U, 13A-13J, 14A-14E, 15A-15K, 16A-16Q and 17A-17T.

Step 1770-1 includes generating, via a touch screen, a graphical user interface that presents display screens and generates commands in response to user interactions. Step 1770-2 includes receiving, via a graphical user interface, beacon transmitter registration data that indicates modes of use for each of a plurality of beacon transmitters. Step 1770-3 includes sending, via a first wireless interface and based on the beacon transmitter registration data, an initial configuration of wireless settings for each of the plurality of beacon transmitters.

Step 1770-4 includes performing, utilizing the first wireless interface and via the graphical user interface, a calibration of the wireless settings of each of the of the plurality of beacon transmitters. Step 1770-5 includes performing, utilizing the first wireless interface and via the graphical user interface, an operational validation of each of the of the plurality of beacon transmitters. Step 1770-6 includes, based on the operational validation of each of the of the plurality of beacon transmitters, transmitting via a second wireless interface, the wireless settings and the beacon transmitter registration data to the processing system.

In addition or in the alternative to any of the foregoing, the client device includes a camera configured to capture optical data corresponding to each of the plurality of beacon transmitters, wherein the optical data includes beacon identification data that uniquely identifies each of the plurality of beacon transmitters; and wherein the operations further include: generating a mapping of the beacon identification for each of the plurality of beacon transmitters to the beacon transmitter registration data for each of the plurality of beacon transmitters; and transmitting the mapping to the processing system.

In addition or in the alternative to any of the foregoing, the beacon transmitter registration data corresponding to one of the plurality beacon transmitters indicates one of the modes of use corresponding to an installation under a table of the venue, and wherein the table can be repositioned.

In addition or in the alternative to any of the foregoing, the beacon transmitter registration data corresponding to one of the plurality beacon transmitters indicates that the one of the plurality beacon transmitters corresponds to a table position at the table.

In addition or in the alternative to any of the foregoing, the beacon transmitter registration data corresponding to one of the plurality beacon transmitters indicates that a composition of the table.

In addition or in the alternative to any of the foregoing, the beacon transmitter registration data corresponding to one of the plurality beacon transmitters indicates that a shape of the table.

In addition or in the alternative to any of the foregoing, the beacon transmitter registration data corresponding to one of the plurality beacon transmitters indicates that a size of the table.

In addition or in the alternative to any of the foregoing, the beacon transmitter registration data corresponding to one of the plurality beacon transmitters indicates one of the modes of use corresponding to an installation at a fixed location.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance ofless than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A system comprising:
a plurality of beacon transmitters associated with a structure configured to transmit a plurality of wireless beacons; and
a processing system that includes a memory that stores operational instructions corresponding to an intelligent structure application and a processing circuit configured to execute the operational instructions, wherein the operational instructions cause the processing circuit to perform operation that include:
receiving beacon data from client devices associated with a corresponding plurality of users in response to the wireless beacons;
generating, in response to the beacon data, location data that indicates positions of the plurality of users in association with the structure; and
generating mapping data that tracks the positions of the plurality of users in association with the structure over time.

2. The system of claim 1, wherein the mapping data is accumulated for the plurality of users and indicates at least one of a traffic pattern of the users within the structure; a traffic pattern of the users outside the structure or a traffic patterns of the users within the structure and outside the structure.

3. The system of claim 1, wherein the operations further include:
generating dwell time data that indicates an average of the users dwell times associated with one or more locations associated with the structure.

4. The system of claim 3, wherein the one or more locations include at least one of a pick-up location; an order location;
a table position; a bar position; a gas pump; or a vehicle recharging station.

5. The system of claim 1, wherein the operations further include:
receiving, from client devices associated with a second plurality of users, a plurality of orders corresponding to a structure;
receiving an indication of a travel route of the second plurality of users to the structure; and
fulfilling the orders in accordance with a schedule that is based on estimated times of arrival corresponding to the second plurality of users.

6. The system of claim 5, wherein the operations further include:
determining the estimated times of arrival based on the position of the second plurality of users along their corresponding travel routes; and
wherein the schedule is further based on estimated preparation times of items included in second plurality of users' orders.

7. The system of claim 6, wherein the schedule is further based on one or more of food quality at the time of fulfillment, a dwell time for pick-up or delivery, and/or kitchen staff operations.

8. The system of claim 1, wherein the operations further include:
sending proximity-based promotional data for display by the client devices, wherein the proximity-based promotional data is selected based on the position of the user corresponding to a proximity to one or more locations associated with the structure; and
wherein the one or more locations include a kiosk; a product display or a mobile check-out location.

9. The system of claim 1, wherein at least one beacon transmitter of the plurality of beacon transmitters is configured to transmit a wireless beacon associated with a service location of a structure configured for mobile checkout; and
wherein the operations further include:
detecting one of the client devices at the service location, wherein the one of the client devices is detected in response to an automated reply signal generated by the one of the client devices in response to the wireless beacon;
establishing an association between the one of the client devices with a transaction at the structure; wherein once the association is established, the one of the client devices emits feedback indicating the association; and
communicating with the one of the client devices to facilitate payment of the transaction placed at the service location based on payment information stored via the one of the client devices.

10. The system of claim 9, wherein the payment information is stored via an electronic wallet of the one of the client devices;
wherein the payment of the transaction is facilitated automatically without requiring interaction with a user of the one of the client devices and wherein the feedback includes an audible alert.

11. The system of claim 1, wherein the operations further include:
generating dwell time data that indicates an average of delivery vendor dwell times associated with one or more locations associated with the structure;
wherein the one or more locations include a pick-up location.

12. The system of claim 1, wherein the operations further include:
receiving a plurality of orders corresponding to the structure for delivery by a plurality of delivery vendors, each delivery vendor corresponding to one of more of the plurality of orders;
receiving, for each of the plurality of delivery vendors, an indication of a travel time to the structure; and
fulfilling the plurality of orders in accordance with a schedule that is generated based on travel time to the structure corresponding to the plurality of delivery vendors.

13. The system of claim 12, wherein the operations further include:
determining estimated times of arrival based on the position of the plurality of delivery vendors along their corresponding travel routes to the structure;
wherein fulfilling the plurality of orders is further based on estimated preparation times of items included in the plurality of orders;
wherein an order queue is generated based on the schedule and updated as orders are prepared and fulfilled; and
wherein the schedule is further based on additional orders received from guests at the structure.

14. The system of claim 13, wherein the plurality of orders are received from one or more order delivery platforms; and
wherein the indication of the travel time to the structure corresponding to the plurality of delivery vendors is received from the one or more order delivery platforms.

15. The system of claim 1, wherein the operations further include:
receiving a plurality of orders corresponding to the structure for delivery by a plurality of delivery vendors, each delivery vendor corresponding to one of more of the plurality of orders;
generating a schedule of order completion for the plurality of orders; and
communicating, based on the schedule of order completion, an estimated order completion time to each delivery vendor corresponding to the one of more of the plurality of orders.

16. The system of claim 1, wherein the location data indicates the position of the user corresponding to a shelf position within the structure; and
wherein the operations further include sending proximity-based promotional data for display by the client device, wherein the proximity-based promotional data is selected based on the position of the user corresponding to the shelf position within the structure.

17. The system of claim 16, wherein the shelf position corresponds to a product display and wherein the proximity-based promotional data is based on the products associated with the product display.

18. The system of claim 1, wherein another client device includes a processor configured to perform client device operations that include:
generating, via a touch screen, a graphical user interface that presents display screens and generates commands in response to user interactions;
receiving, via the graphical user interface, beacon transmitter registration data that indicates modes of use for each of the plurality of beacon transmitters;
sending, via a first wireless interface and based on the beacon transmitter registration data, an initial configuration of wireless settings for each of the plurality of beacon transmitters;
performing, utilizing the first wireless interface and via the graphical user interface, a calibration of the wireless settings of each of the of the plurality of beacon transmitters;
performing, utilizing the first wireless interface and via the graphical user interface, an operational validation of each of the of the plurality of beacon transmitters; and
based on the operational validation of each of the plurality of beacon transmitters, transmitting via a second wireless interface, the wireless settings and the beacon transmitter registration data to the processing system.

19. The system of claim 18, wherein the client device operations further include:
capturing optical data corresponding to each of the plurality of beacon transmitters, wherein the optical data includes beacon identification data that uniquely identifies each of the plurality of beacon transmitters;
generating a mapping of the beacon identification for each of the plurality of beacon transmitters to the beacon transmitter registration data for each of the plurality of beacon transmitters; and
transmitting the mapping to the processing system.

20. The system of claim 19, wherein the beacon transmitter registration data corresponding to one of the plurality beacon transmitters indicates one of the modes of use corresponding to an installation under a table of the structure and further indicates at least one of a positioning of the table;
a table position at the table;
a composition of the table; a shape of the table; or
a size of the table.
